(19) United States
(12) Patent Application Publication
(10) Pub. No.: US 2025/0371325 A1
(43) Pub. Date: Dec. 4, 2025

(54) ARTIFICIAL INTELLIGENCE-POWERED LARGE-SCALE CONTENT GENERATOR

(71) Applicant: QOMPLX LLC, Reston, VA (US)

(72) Inventors: Jason Crabtree, Vienna, VA (US); Richard Kelley, Woodbridge, VA (US); Jason Hopper, Halifax (CA); David Park, Fairfax, VA (US)

(21) Appl. No.: 18/780,457

(22) Filed: Jul. 22, 2024

Related U.S. Application Data
(63) Continuation-in-part of application No. 18/679,404, filed on May 30, 2024.

(51) Int. Cl. G06N 3/0475; G06N 3/0442; G06N 3/045; G06N 3/0464; G06N 3/094

(52) U.S. Cl. CPC G06N 3/0475; G06N 3/0442; G06N 3/045; G06N 3/0464; G06N 3/094

(57) ABSTRACT

An AI-powered content generation system that creates consistent, coherent, and engaging multi-modal content by integrating multiple specialized AI components. The system analyzes user input, identifies key elements, and maintains continuity throughout the generation process. It incorporates a feedback loop to learn and adapt based on user preferences, enabling personalized content experiences. The modular architecture allows for seamless integration of AI components focusing on text, images, audio, and interactive elements. The system ensures consistency across modalities and over extended periods, while managing rights, licenses, and royalties using blockchain technology. This advanced platform revolutionizes content creation, consumption, and management in the digital age.

### CROSS-REFERENCE TO RELATED APPLICATIONS

Priority is claimed in the application data sheet to the following patents or patent applications, each of which is expressly incorporated herein by reference in its entirety:
Ser. No. 18/679,404

### BACKGROUND OF THE INVENTION

### Field of the Art

The present invention relates to the field of artificial intelligence (AI) and machine learning (ML) based content generation systems that create consistent, coherent, and engaging multi-modal content while continuously learning and adapting based on user feedback and preferences.

### Discussion of the State of the Art

The rapid advancements in artificial intelligence (AI) and machine learning (ML) technologies have revolutionized the way content is created, consumed, and experienced across various domains, including entertainment, education, and interactive media. Traditional methods of content creation often involve manual, time-consuming processes that heavily rely on human expertise and creativity. However, the increasing demand for personalized, immersive, and engaging content has highlighted the need for more efficient, scalable, and automated content generation solutions.

Existing AI-based content generation systems have made significant strides in producing text, images, and audio using techniques such as natural language processing (NLP), computer vision, and generative models. These systems can generate coherent and contextually relevant content based on user input or predefined parameters. However, they often operate in isolation, focusing on a single modality or domain, and lack the ability to create comprehensive, multi-modal experiences that seamlessly integrate various forms of content.

Moreover, current content generation systems often struggle with maintaining consistency and continuity across the generated content, particularly in terms of characters, world-building, and overarching narratives. Inconsistencies and contradictions can arise when generating large-scale, complex content, leading to a fragmented and unsatisfying user experience. Ensuring coherence and consistency across different modalities and over extended periods of content generation remains a significant challenge.

Another limitation of existing systems is their inability to effectively incorporate user feedback and preferences into the content generation process. User engagement and satisfaction are crucial factors in the success of generated content, but current systems often operate in a one-shot, black box manner, without the ability to dynamically adapt and evolve based on user input and interactions. Without this capability, creating believable and consistent content using high level concepts is impossible.

What is needed is an AI-powered content generation system that addresses the limitations of existing solutions and provides a comprehensive, consistent, and engaging multi-modal content creation platform. The proposed system aims to revolutionize the way content is generated, consumed, and managed, opening up new possibilities for creative expression, personalized experiences, and intellectual property protection in the digital age.

### SUMMARY OF THE INVENTION

Accordingly, the inventor has conceived and reduced to practice, an artificial intelligence-powered large-scale content generator. The system analyzes user input, identifies key elements, and maintains continuity throughout the generation process using a Characteristic Tracker and a Central AI Coordinator. The Adaptive Content Generator, a component of the system, comprises a plurality of Generative AI modules including, but not limited to Text, Image, Video, Olfactory, Haptic, Neurological, and Sound modules that create content in their respective modalities. Consistency AI components, World Building, and Story Generation AI ensure the overall consistency and continuity of the generated content. The system incorporates a feedback loop through the User Interface and Generative AI Training System, allowing it to continuously learn and adapt based on user preferences and feedback in an iterative process. This process enables the generation of personalized and high-quality content that aligns with user expectations. The invention revolutionizes content creation, consumption, and management across various domains, including entertainment, education, and interactive media, while optionally ensuring proper rights management and attribution using a registry or ledger such as blockchain technology.

According to a preferred embodiment, a computing system for an artificial intelligence-powered large-scale content generator, the computing system comprising: one or more hardware processors configured for: receiving a user input from a user interface; segmenting the user input into a plurality of elements, wherein the elements include plot, setting, descriptors, and characters; flagging a plurality key elements from the plurality of elements which should remain constant unless the user input indicates otherwise; processing the plurality of elements and the plurality of key elements through a plurality of generative AI subsystems where each generative AI subsystem is configured to process a certain type of element; generating a cohesive experience from the plurality of generative AI subsystems where the experience is based on the user input; displaying the experience to a user device; and receiving user feedback to which is processed by the plurality of generative AI subsystems to create an updated experience, is disclosed.

According to another preferred embodiment, a computer-implemented method executed on an artificial intelligence-powered large-scale content generator, the computer-implemented method comprising: receiving a user input from a user interface; segmenting the user input into a plurality of elements, wherein the elements include plot, setting, descriptors, and characters; flagging a plurality key elements from the plurality of elements which should remain constant unless the user input indicates otherwise; processing the plurality of elements and the plurality of key elements through a plurality of generative AI subsystems where each generative AI subsystem is configured to process a certain type of element; generating an experience from the plurality of generative AI subsystems where the experience is based on the user input; displaying the experience to a user device; and receiving user feedback to which is processed by the plurality of generative AI subsystems to create an updated experience, is disclosed.

According to another preferred embodiment, a system for an artificial intelligence-powered large-scale content generator, comprising one or more computers with executable instruction that, when executed, cause the system to: receive a user input from a user interface; segment the user input into a plurality of elements, wherein the elements include plot, setting, descriptors, and characters; flag a plurality key elements from the plurality of elements which should remain constant unless the user input indicates otherwise; process the plurality of elements and the plurality of key elements through a plurality of generative AI subsystems where each generative AI subsystem is configured to process a certain type of element; generate an experience from the plurality of generative AI subsystems where the experience is based on the user input; display the experience to a user device; and receive user feedback to which is processed by the plurality of generative AI subsystems to create an updated experience, is disclosed.

According to another preferred embodiment, non-transitory, computer-readable storage media having computer executable instruction embodied thereon that, when executed by one or more processors of a computing system employing an artificial intelligence-powered large-scale content generator, cause the computing system to: receive a user input from a user interface; segment the user input into a plurality of elements, wherein the elements include plot, setting, descriptors, and characters; flag a plurality key elements from the plurality of elements which should remain constant unless the user input indicates otherwise; process the plurality of elements and the plurality of key elements through a plurality of generative AI subsystems where each generative AI subsystem is configured to process a certain type of element; generate an experience from the plurality of generative AI subsystems where the experience is based on the user input; display the experience to a user device; and receive user feedback to which is processed by the plurality of generative AI subsystems to create an updated experience, is disclosed.

According to an aspect of an embodiment, the plurality of generative AI subsystems are configured to process and generate text, images, videos, sounds, and environments.

According to an aspect of an embodiment, the outputs from the plurality of generative AI subsystems are checked to ensure that the plurality of key elements are consistent across time and modalities.

According to an aspect of an embodiment, the system and method further comprise a generative AI training system which trains each generative AI subsystem on user feedback and a plurality of user inputs to enhance the system's performance.

According to an aspect of an embodiment, the plurality of generative AI subsystems may be configured to generate a portion of an experience, such as chapters of a novel, single scenes in a movie, or song segments, or specific elements such as bass guitar, human motion, or a table.

### BRIEF DESCRIPTION OF THE DRAWING FIGURES

FIG. 1 is a block diagram illustrating an exemplary system architecture for artificial intelligence-powered music registry, collaboration, and workflow management system, according to an embodiment.

FIG. 2 is a block diagram illustrating an aspect of an artificial intelligence-powered music registry, collaboration, and workflow management system, a segmentation and hashing subsystem.

FIG. 3 is a block diagram illustrating an aspect of an artificial intelligence-powered music registry, collaboration, and workflow management system, an AI and ML subsystem.

FIG. 4 is a block diagram illustrating an aspect of an artificial intelligence-powered music registry, collaboration, and workflow management system, a characterization subsystem.

FIG. 5 is a block diagram illustrating an aspect of an artificial intelligence-powered music registry, collaboration, and workflow management system, an integration subsystem.

FIG. 6 is a block diagram illustrating an aspect of an artificial intelligence-powered music registry, collaboration, and workflow management system, an interactive process subsystem.

FIG. 7 is a block diagram illustrating an aspect of an artificial intelligence-powered music registry, collaboration, and workflow management system, a text-to-music subsystem.

FIG. 8 is a block diagram illustrating an aspect of an artificial intelligence-powered music registry, collaboration, and workflow management system, a planning and simulation subsystem.

FIG. 9 is a block diagram illustrating an aspect of an artificial intelligence-powered music registry, collaboration, and workflow management system, a marketplace subsystem.

FIG. 10 is a block diagram illustrating an exemplary aspect of an embodiment of a distributed computational graph computing system utilizing an advanced cyber decision platform (ACDP) for external network reconnaissance and contextual data collection.

FIG. 11 is a block diagram illustrating another exemplary aspect of an embodiment of a distributed computational graph computing systems utilizing an advanced cyber decision platform.

FIG. 12 is a flow diagram illustrating an exemplary workflow when a user uploads a musical piece to the music registry and collaboration system, according to an embodiment.

FIG. 13 is a flow diagram illustrating another exemplary workflow when a user uploads a musical piece to the music registry and collaboration system, according to an embodiment.

FIG. 14 is a flow diagram illustrating an exemplary method for segmenting and hashing instruments, vocals, and other elements of a music composition to enhance crediting and royalty distribution, according to an embodiment.

FIG. 15 is a flow diagram illustrating an exemplary method for tracking musical component usage and distributing royalties based on licensing and/or usage agreements, according to an embodiment.

FIG. 16 is a block diagram illustrating an exemplary system architecture for an artificial intelligence-powered large-scale content generator.

FIG. 17 is a block diagram illustrating an aspect of an artificial intelligence-powered large-scale content generator, an adaptive content generator.

FIG. 18 is a block diagram illustrating an exemplary aspect of an embodiment of an artificial intelligence-powered large-scale content generator, where the adaptive content generator is trained by a generative AI training system.

FIG. 19 is a block diagram illustrating an aspect of an artificial intelligence-powered large-scale content generator, a generative AI training system.

FIG. 20 is a block diagram illustrating how an adaptive content generator may be used to create entire experiences, or portions of an experience based on a user input.

FIG. 21 is a flow diagram illustrating an exemplary method for adaptive content generation using an artificial intelligence-powered large-scale content generator.

FIG. 22 is a flow diagram illustrating an exemplary method for generating a novel or a subset of a novel using an artificial intelligence-powered large-scale content generator.

FIG. 23 is a flow diagram illustrating an exemplary method for generating a movie or a plurality of scenes within a movie using an artificial intelligence-powered large-scale content generator.

FIG. 24 is a block diagram illustrating an exemplary aspect of an embodiment of an artificial intelligence-powered large-scale content generator, where the adaptive content generator incorporates a Knowledge-Augmented Network (KAN).

FIG. 25 is a block diagram illustrating an aspect of an artificial intelligence-powered large-scale content generator, a Knowledge-Augmented Network (KAN).

FIG. 26 is a block diagram illustrating an exemplary aspect of an embodiment of an artificial intelligence-powered large-scale content generator with spatiotemporal indexing.

FIG. 27 is a block diagram illustrating an exemplary aspect of an embodiment of an artificial intelligence-powered large-scale content generator with energy optimization.

FIG. 28 is a block diagram illustrating an aspect of an artificial intelligence-powered large-scale content generator, an energy optimizer.

FIG. 29 is a block diagram illustrating an exemplary aspect of an embodiment of an artificial intelligence-powered large-scale content generator with AI generated content detection.

FIG. 30 is a block diagram illustrating an aspect of an artificial intelligence-powered large-scale content generator, an AI generated content detector.

FIG. 31 is a block diagram illustrating an exemplary aspect of an embodiment of an artificial intelligence-powered large-scale content generator with a content upscaling and remastering subsystem.

FIG. 32 is a block diagram illustrating an aspect of an artificial intelligence-powered large-scale content generator, a content upscaling and remastering subsystem.

FIG. 33 is a flow diagram illustrating an exemplary method for indexing inputs and

outputs of an AI-powered large scale content generator using spatiotemporal indexing.

FIG. 34 is a flow diagram illustrating an exemplary method for optimizing the energy usage of an AI-powered large scale content generator.

FIG. 35 is a flow diagram illustrating an exemplary method identifying generated or fake content using an AI-powered large scale content generator.

FIG. 36 is a flow diagram illustrating an exemplary method for remastering or upsampling generated content from an AI-powered large scale content generator.

FIG. 37 illustrates an exemplary computing environment on which an embodiment described herein may be implemented.

### DETAILED DESCRIPTION OF THE INVENTION

The inventor has conceived, and reduced to practice, an artificial intelligence-powered large-scale content generator. The system analyzes user input, identifies key elements, and maintains continuity throughout the generation process using a Characteristic Tracker and a Central AI Coordinator. The Adaptive Content Generator, a key component of the system, comprises Text, Image, video, haptic, olfactory, neurological, and Sound Generative AI modules that create content in their respective modalities. Consistency AI components and a World Building AI ensure the overall consistency and continuity of the generated content. The system incorporates a feedback loop through the User Interface and Generative AI Training System, allowing it to learn and adapt based on user preferences and feedback. This iterative process enables the generation of personalized and high-quality content that aligns with user expectations and vision. The invention revolutionizes content creation, consumption, and management across various domains, including entertainment, education, and interactive media, while ensuring proper rights management and attribution using blockchain technology.

According to some embodiments, the system also includes a characterization subsystem for individual artists and their influences, which is used for AI/ML training and modeling. An integration subsystem may combine biometric and behavioral data to measure user response to content in various contexts and states. These metrics can be used as inputs to the generation system at set iterations, so subsequent iterations of the generated content can maximize these values. A sampling and unique identifier subsystem generates unique identifications for song, artist, actor, athlete, video, image, and distribution path comparisons and distance calculations.

In some embodiments, an interactive process subsystem can be configured to determine distance and similarity metrics between new and existing works, providing adjustments in the objective function/rating for specific components or the entire piece. An iterative optimization loop can generate optimal desired outcomes based on metrics automatically fed back into the music generation system. A text-to-music subsystem can incorporate temporal, spatial, contextual, name-image-likeness (NIL), mix, distribution medium, listening state, or other characteristics in the music generation process.

The system may also include an integration subsystem that incorporates planning, simulation modeling, statistical analysis, ML/AI tools, generative AI, suggestions of partnerships/duets/collaborations, artist similarities, and copyright/other legal risks at the component, song, artist, and genre level into recording, ideation, mixing, and producing workflows. Additionally, the system may feature a licensing marketplace, royalty and residual calculator, and simulation engine to explore predicted virality scores and potential licensing and distribution opportunities, as well as a bid-type marketplace for artist collaborations and remixes. It can also be used for narrative formulation or refinement.

One use case that is imagined for the music or multimedia content registry and collaboration system is to aid artists in prototyping works based on their own vocals or in situations where an injury or disease precludes certain musical elements. By utilizing the vast dataset of musical compositions, along with advanced AI and machine learning techniques, the system can enable artists to create new works that align with their unique style and musical identity, even in the face of physical limitations. In the case of an artist who wants to prototype a new work based on their own vocals, the system can analyze the artist's previous recordings and performances stored in the music registry. By applying techniques such as voice analysis, pitch tracking, and timbre modeling, the system can extract the unique characteristics and stylistic elements of the artist's voice. This data can then be used to train a generative AI model specifically tailored to the artist's vocal style. When the artist provides a new musical idea or a partially completed composition, the system can use the trained generative model to create vocal lines, harmonies, or ad-libs that match the artist's distinct vocal style. The generated vocal elements can be seamlessly integrated into the prototype, allowing the artist to hear how their voice would sound in the new work without actually having to record the vocals themselves. This can greatly speed up the creative process and enable the artist to experiment with different ideas and arrangements before committing to a final recording.

In situations where an injury or disease prevents an artist from performing certain musical elements, the system can be used to fill in those gaps using the artist's own “likeness” from prior recordings and data. For example, if a drummer is paralyzed but can still move their fingers, the system can analyze the drummer's previous performances and extract the unique patterns, grooves, and techniques that define their drumming style. Using this data, the system can generate drum tracks that closely mimic the drummer's personal style, as if they were playing the parts themselves. The drummer can then use finger movements or other accessible input methods to control and manipulate the generated drum tracks, allowing them to still actively participate in the creative process and maintain their musical identity. The system can also adapt to the specific constraints and capabilities of the artist. For instance, if the drummer has limited finger mobility, the system can generate drum patterns that are optimized for the available input methods, ensuring that the artist can still create expressive and dynamic performances within their physical limitations.

Furthermore, the music registry and collaboration system can provide a platform for artists facing similar challenges to connect, collaborate, and share their experiences. Artists can explore the works of others who have used the system to overcome physical limitations, learning from their approaches and techniques. This can foster a supportive community that encourages innovation, adaptability, and the continued pursuit of artistic expression despite adversity. By leveraging the power of AI, machine learning, and the extensive music dataset, the music registry and collaboration system can empower artists to prototype works based on their own vocals, musical likeness, or vocals they have right to use in this way, even when faced with physical limitations. This technology can help artists maintain their creative voice, overcome obstacles, and continue to make meaningful contributions to the world of music.

The AI system includes a sound generative component that can create original music compositions, soundtracks, and sound effects tailored to specific contexts or user inputs. This could be utilized to generate the music and audio elements discussed in the first patent. For example, if a user is creating a movie scene set in a haunted house, they could input a description like “eerie ambient music with creepy sound effects.” The AI music generator would then compose a bespoke soundtrack featuring unsettling drones, dissonant tones, and occasional startling noises that perfectly match the scene's intended atmosphere. This custom audio would seamlessly integrate with the visual elements generated by the system's other components.

The AI's music generation capabilities extend to creating music that reflects different emotions, genres, and cultural influences based on user guidance. For instance, a user could request a series of scenes showing a character's journey across various countries, with music that evolves to represent each location. The system might generate a lilting Celtic-inspired melody for a scene in Ireland, transitioning to upbeat samba rhythms for a sequence in Brazil. This adaptive music generation can greatly enhance the immersive quality and narrative continuity of the resulting multimedia content.

Furthermore, the AI system can generate variations of musical themes and leitmotifs that recur throughout a piece of media, helping to establish a consistent audio identity and provide continuity cues. Character themes or musical phrases associated with certain story elements can subtly evolve based on the narrative context. For example, a hero's triumphant brass fanfare might be reintroduced in a minor key during a moment of defeat, reinforcing the scene's emotional tone while maintaining musical continuity.

The AI's ability to generate music that aligns with the timing and pacing of visual content can help ensure synchronization and flow between audio and video elements. It can create smooth musical transitions between scenes and adjust the tempo and intensity of the music to match the action on screen. By leveraging the music and audio generation capabilities of the AI system, creators can enhance the overall coherence and impact of the scene continuity aware media produced using the first patent's techniques. The AI-generated music can adapt to the visual narrative in real-time, strengthening the emotional resonance and stylistic consistency of the media experience.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical. Processes in the system may be defined as Definite Clause Grammars (DCGs) that execute different graphs or subgraphs or transformation steps (including access to different content elements and components) across different devices with either continuous or intermittent communication. Defining loops across specialist models for content generation (e.g., elements vs scenes vs. locations vs. sequences of audio vs. voice vs. music or even subordinate tiers of specialist elements like a model for chairs vs faces vs vehicles etc. . . . ) and ongoing continuity/or audit functions.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “graph” is a representation of information and relationships, where each primary unit of information makes up a “node” or “vertex” of the graph and the relationship between two nodes makes up an edge of the graph. Nodes can be further qualified by the connection of one or more descriptors or “properties” to that node. For example, given the node “James R,” name information for a person, qualifying properties might be “183 cm tall,” “DOB Aug. 13, 1965” and “speaks English”. Similar to the use of properties to further describe the information in a node, a relationship between two nodes that forms an edge can be qualified using a “label”. Thus, given a second node “Thomas G,” an edge between “James R” and “Thomas G” that indicates that the two people know each other might be labeled “knows.” When graph theory notation (Graph=(Vertices, Edges)) is applied this situation, the set of nodes are used as one parameter of the ordered pair, V and the set of 2 element edge endpoints are used as the second parameter of the ordered pair, E. When the order of the edge endpoints within the pairs of E is not significant, for example, the edge James R, Thomas G is equivalent to Thomas G, James R, the graph is designated as “undirected.” Under circumstances when a relationship flows from one node to another in one direction, for example James R is “taller” than Thomas G, the order of the endpoints is significant. Graphs with such edges are designated as “directed.” In the distributed computational graph system, transformations within transformation pipeline are represented as directed graph with each transformation comprising a node and the output messages between transformations comprising edges. Distributed computational graph stipulates the potential use of non-linear transformation pipelines which are programmatically linearized. Such linearization can result in exponential growth of resource consumption. The most sensible approach to overcome possibility is to introduce new transformation pipelines just as they are needed, creating only those that are ready to compute. Such method results in transformation graphs which are highly variable in size and node, edge composition as the system processes data streams. Those familiar with the art will realize that transformation graph may assume many shapes and sizes with a vast topography of edge relationships and node types. It is also important to note that the resource topologies available at a given execution time for a given pipeline may be highly dynamic due to changes in available node or edge types or topologies (e.g. different servers, data centers, devices, network links, etc.) being available, and this is even more so when legal, regulatory, privacy and security considerations are included in a DCG pipeline specification or recipe in the DSL. Since the system can have a range of parameters (e.g. authorized to do transformation x at compute locations of a, b, or c) the JIT, JIC, JIP elements can leverage system state information (about both the processing system and the observed system of interest) and planning or modeling modules to compute at least one parameter set (e.g. execution of pipeline may say based on current conditions use compute location b) at execution time. This may also be done at the highest level or delegated to lower level resources when considering the spectrum from centralized cloud clusters (i.e. higher) to extreme edge (e.g. a wearable, or phone or laptop). The examples given were chosen for illustrative purposes only and represent a small number of the simplest of possibilities. These examples should not be taken to define the possible graphs expected as part of operation of the invention

As used herein, “transformation” is a function performed on zero or more streams of input data which results in a single stream of output which may or may not then be used as input for another transformation. Transformations may comprise any combination of machine, human or machine-human interactions Transformations need not change data that enters them, one example of this type of transformation would be a storage transformation which would receive input and then act as a queue for that data for subsequent transformations. As implied above, a specific transformation may generate output data in the absence of input data. A time stamp serves as an example. In the invention, transformations are placed into pipelines such that the output of one transformation may serve as an input for another. These pipelines can consist of two or more transformations with the number of transformations limited only by the resources of the system. Historically, transformation pipelines have been linear with each transformation in the pipeline receiving input from one antecedent and providing output to one subsequent with no branching or iteration. Other pipeline configurations are possible. The invention is designed to permit several of these configurations including, but not limited to: linear, afferent branch, efferent branch and cyclical.

A “pipeline,” as used herein and interchangeably referred to as a “data pipeline” or a “processing pipeline,” refers to a set of data streaming activities and batch activities. Streaming and batch activities can be connected indiscriminately within a pipeline and compute, transport or storage (including temporary in-memory persistence such as Kafka topics) may be optionally inferred/suggested by the system or may be expressly defined in the pipeline domain specific language. Events will flow through the streaming activity actors in a reactive way. At the junction of a streaming activity to batch activity, there will exist a StreamBatchProtocol data object. This object is responsible for determining when and if the batch process is run. One or more of three possibilities can be used for processing triggers: regular timing interval, every N events, a certain data size or chunk, or optionally an internal (e.g. APM or trace or resource based trigger) or external trigger (e.g. from another user, pipeline, or exogenous service). The events are held in a queue (e.g. Kafka) or similar until processing. Each batch activity may contain a “source” data context (this may be a streaming context if the upstream activities are streaming), and a “destination” data context (which is passed to the next activity). Streaming activities may sometimes have an optional “destination” streaming data context (optional meaning: caching/persistence of events vs. ephemeral). System also contains a database containing all data pipelines as templates, recipes, or as run at execution time to enable post-hoc reconstruction or re-evaluation with a modified topology of the resources (e.g. compute, transport or storage), transformations, or data involved.

### Conceptual Architecture

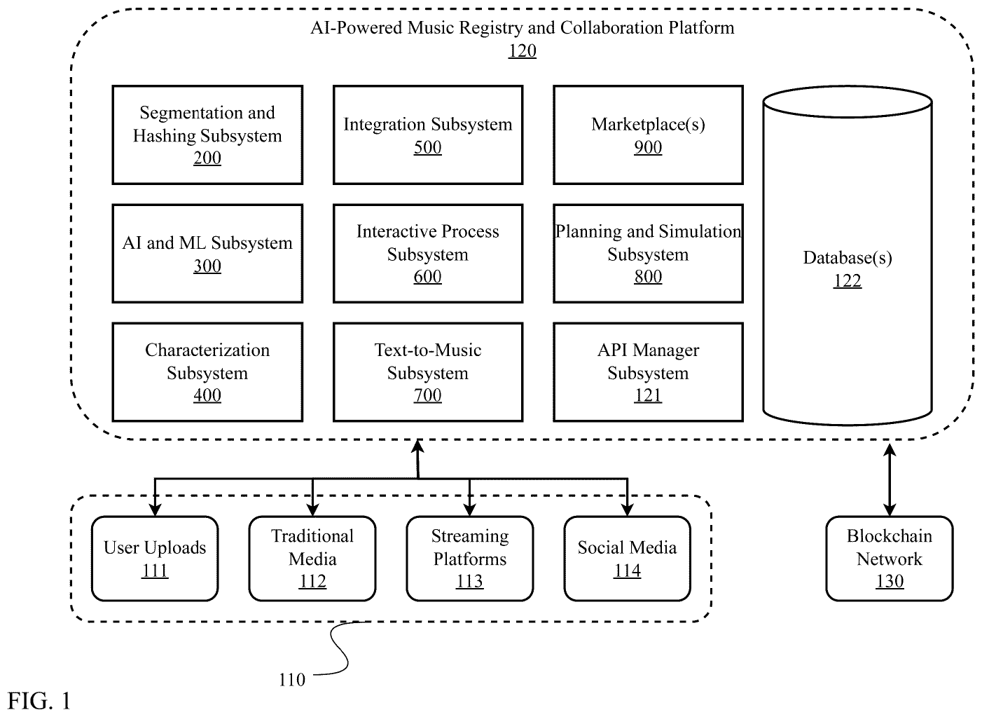

FIG. 1 is a block diagram illustrating an exemplary system architecture for artificial intelligence-powered music registry, collaboration, and workflow management system 120, according to an embodiment. According to the embodiment, system 120 is configured as a cloud-based computing platform comprising various system or sub-system components configured to provide functionality directed to the execution of managing music composition, recording, production, creative rights, approvals, and royalty management using artificial intelligence and machine learning techniques. Exemplary platform systems can include a segmentation and hashing subsystem 200, an artificial intelligence and machine learning (AI/ML) subsystem 300, a characterization subsystem 400, an integration subsystem 500, an interactive process subsystem 600, a text-to-music subsystem 700, a planning and simulation subsystem 800, a marketplace subsystem 900, an application programming interface (API) subsystem 121, and various databases 122. In some embodiments, subsystems 200-900 may each be implemented as standalone software applications or as a services/microservices architecture which can be deployed (via platform 120) to perform a specific task or functionality. In such an arrangement, services can communicate with each other over an appropriate network using lightweight protocols such as HTTP, gRPC, or message queues. This allows for asynchronous and decoupled communication between services. Services may be scaled independently based on demand, which allows for better resource utilization and improved performance. Services may be deployed using containerization technologies such as Docker and orchestrated using container orchestration platforms like Kubernetes. This allows for easier deployment and management of services.

The system 120 employs advanced AI/ML techniques, such as neural networks and specially-tuned models, to analyze musical pieces and isolate individual instruments, vocals, and performer contributions. For example, the system can separate the guitar, bass, drums, and vocals from a recorded song, allowing for a more granular analysis of each component and the ability to attribute credits and royalties to the respective contributors.

By isolating and tracking individual components of a musical piece, the system 120 enables more accurate and fair distribution of credits and royalties. This is particularly relevant in cases where a specific instrument or vocal performance is sampled or used in a new work. The system can identify the original contributor and ensure they are properly compensated for their contribution.

Component-level tracking is provided by the AI-powered music registry and collaboration system 120, as it enables more accurate and fair attribution of credits and royalties to the various contributors involved in creating a musical work. By isolating and tracking individual components, such as instruments, vocals, or samples, the system can ensure that each contributor is properly recognized and compensated for their work.

According to the embodiment, the system employs advanced metadata tagging techniques to label and categorize individual musical components. Each component is associated with relevant information, such as the contributor's name, their role (e.g., composer, lyricist, performer), the time stamp within the overall composition, and the specific instrument or vocal part. This granular tagging allows for a detailed breakdown of the musical work and facilitates the accurate tracking of each component. In a collaboratively produced hip-hop track, for example, the system can tag the individual components, such as the drum beat (produced by Artist A), the bass line (performed by Artist B), the piano riff (composed by Artist C), and the vocal verses (written and performed by Artist D). This detailed tagging ensures that each contributor is properly credited and compensated for their specific contribution.

In some implementations, the system can integrate with blockchain technology 130 and smart contracts to automate the distribution of credits and royalties based on the component-level tracking. Smart contracts are self-executing contracts with the terms of the agreement directly written into code. They can be programmed to automatically allocate royalties to the respective contributors based on predefined split percentages or other criteria. For example, using a smart contract, the system can automatically distribute royalties from the streaming revenue of a song to the various contributors based on their component-level contributions. For instance, if the drum beat producer is entitled to 5% of the royalties, the smart contract will ensure that they receive their share whenever the song generates revenue.

The system may be configured to provide real-time reporting and analytics on the usage and performance of individual musical components. This allows contributors to track how their work is being utilized and monetized across different platforms and media. The system can generate detailed breakdowns of royalty distributions, usage metrics, and audience engagement data, empowering contributors to make informed decisions about their creative work and collaborations. For instance, a vocalist featured in a popular electronic dance music (EDM) track can access real-time data on how often their vocal component is being streamed, remixed, or sampled across various platforms. They can also see their share of the royalties generated by the track and compare their performance to other collaborators or similar works in the genre.

Component-level tracking can help resolve disputes over ownership and attribution by providing a clear and verifiable record of each contributor's involvement in a musical work. The system can maintain a tamper-proof ledger of all contributions, modifications, and ownership transfers, ensuring transparency and accountability in the creative process. If, for example, a dispute arises between two artists claiming ownership of a specific guitar riff in a rock song, the system can refer to the component-level tracking data to determine who originally contributed the riff and when it was incorporated into the composition. This information can be used to resolve the dispute and ensure proper attribution and compensation.

The system can integrate with music licensing platforms 113 to facilitate the licensing of individual musical components for use in various projects, such as films, advertisements, or remixes. The component-level tracking allows for the granular licensing of specific elements, enabling creators to monetize their work in new and innovative ways. For example, a film producer can use the system to license only the orchestral arrangement of a popular song for use in their movie soundtrack, without having to license the entire original recording. The component-level tracking ensures that the composer and performers of the orchestral arrangement are properly credited and compensated for the usage of their work.

According to some embodiments, the system analyzes the unique styles, techniques, and influences of individual artists to create detailed profiles that can be used for AI/ML training and modeling. This allows for the generation of new content that accurately mimics the style of a particular artist or combines elements from multiple artists to create novel and innovative works.

By integrating biometric and behavioral data, such as heart rate, pupil dilation, and facial expressions, the system 120 can analyze the emotional and physiological responses of listeners to specific musical pieces or components. This information can be used to optimize the creation and selection of music for various contexts, such as advertising, film, or therapeutic applications.

The system 120 can be configured to generate unique hashes for each musical component, allowing for quick and accurate comparisons between songs, albums, artists, genres, and distribution paths. This enables the identification of similarities, influences, and potential copyright infringement issues, as well as the tracking of how musical elements are used and shared across different platforms and media.

The system 120 provides interactive tools for comparing new musical works to existing ones, calculating distance and similarity metrics based on various factors such as melody, harmony, rhythm, and lyrical content.

By continuously analyzing user engagement, biometric data, and other relevant metrics, the system 120 can provide real-time feedback and suggestions to optimize the creative process. This iterative loop allows artists and producers to refine their work based on audience reception and commercial performance, ultimately leading to more successful outcomes.

The system's text-to-music subsystem 700 allows users to generate musical pieces based on textual input, taking into account various characteristics such as mood, genre, tempo, and instrumentation. This enables the creation of custom music for specific contexts, such as film scenes, video games, or marketing campaigns, while ensuring the generated content aligns with the desired emotional and aesthetic goals.

In some implementations, the system 120 integrates with planning and simulation tools to help artists and producers make informed decisions about collaborations, distribution strategies, and marketing efforts. By analyzing market trends, audience preferences, and competitor performance, the system can provide data-driven recommendations to optimize resource allocation and maximize the success of a musical project.

The system's AI/ML capabilities allow for the suggestion of novel sounds, the generation of backing tracks, and the exploration of innovative sonic combinations. By analyzing vast databases of musical content and user preferences, the system can propose unique instrumentation, arrangement, and production ideas that push the boundaries of creativity and help artists differentiate themselves in a crowded market.

According to the embodiment, the system's architecture combines traditional SQL databases for structured data, knowledge graphs for modeling relationships between musical entities, and vector databases for efficient similarity searches and recommendations. This hybrid approach allows for the seamless integration of various data types and enables powerful querying and analysis capabilities. By leveraging a combination of databases 122, knowledge graphs, and vector databases, the system can support complex queries, discover meaningful relationships, and enable advanced machine learning applications.

Relational databases, such as MySQL or PostgreSQL, form the foundation of the system's data storage. They are used to store structured data related to artists, songs, albums, genres, licenses, collaboration data (e.g., user collaborations, roles and permissions associated with each musical piece), and analytics and reporting data (e.g., aggregated usage metrics, revenue data, and performance statistics), and other metadata. Relational databases may also be used to store user information such as user profiles, authentication credentials, roles, and permissions. The relational model allows for efficient querying, indexing, and enforcing data integrity through ACID (Atomicity, Consistency, Isolation, Durability) properties. The system can use a relational database, for example, to store information about a song, including (but not limited to) its title, artist, album, release date, duration, and genre. This structured data can be easily queried and filtered, enabling users to search for specific songs, artists, or albums based on various criteria. The relational database also ensures data consistency and prevents duplication or inconsistencies in the stored information.

NoSQL databases, such as MongoDB or Cassandra, may be used to store and manage unstructured or semi-structured data. Examples of the types of data that may be stored in such databases can include, but are not limited to, audio files, waveform data, metadata attachments (e.g., lyrics, liner notes, or user-generated tags), user activity logs (e.g., detailed logs of user actions, interactions, and events within the system), and collaborative content (e.g., user comments, feedback, and discussion threads related to musical pieces). These databases provide flexibility and scalability, allowing the system to handle large volumes of diverse data types, such as audio files, MIDI sequences, lyrics, and user-generated content. For example, the system can use a NoSQL database to store and manage audio files and their associated metadata. Each audio file can be stored as a document in the database, along with its ID3 tags, waveform data, and other relevant information. NoSQL databases enable the system to efficiently store and retrieve these files, regardless of their size or format, and allow for flexible querying and indexing based on the associated metadata.

Knowledge graphs may be used to represent and store complex relationships between musical entities, such as artists, songs, genres, and influences. They enable the system to capture and query the rich semantic connections that exist within the musical domain, facilitating advanced analysis and recommendation capabilities. Examples of the types of data that may be stored in such databases can include, but are not limited to, music knowledge graph (e.g., graph representation of the relationships and connections between musical entities, such as artists, songs, albums, genres, and influences), collaboration graph (e.g., graph depicting the collaborative relationships between users, including co-creation, remixing, and derivative work), sampling and reference graph (e.g., graph capturing the sampling, referencing, and inspiration relationships between musical pieces), music genealogy graph (e.g., graph representing the historical lineage and evolution of musical styles, genres, and influences), and artist connection graph (e.g., graph showcasing the connections and collaborations between artists, bands, and music producers). As an example, the system can use a knowledge graph to represent the relationships between artists and their musical influences. Each artist can be represented as a node in the graph, with edges connecting them to other artists who have influenced their work. This graph structure allows the system to traverse and query the relationships, enabling users to discover the musical lineage and connections between different artists. The knowledge graph can also capture other types of relationships, such as collaborations, remixes, and sampled works.

Vector databases, such as, for example, Faiss or Annoy, can be used to store and search high-dimensional vector representations of musical data. These vectors can be generated using machine learning techniques, such as audio embedding or feature extraction, and capture the salient characteristics of musical works in a compact and computationally efficient format. Examples of the types of data that may be stored in such databases can include, but are not limited to, audio embeddings (e.g., high-dimensional vector representations of musical pieces, generated using audio analysis and feature extraction techniques), similarity vectors (e.g., precomputed similarity scores or distances between musical pieces, used for efficient similarity search and recommendation), instrument embeddings (e.g., vector representations of individual instruments or vocal components, enabling similarity matching and retrieval), genre embeddings (e.g., vector representations of musical genres, allowing for genre classification and exploration), and mood embeddings (e.g., vector representations of emotional or mood characteristics of musical pieces). For instance, the system can use a vector database to store the audio embeddings of songs. These embeddings are generated by feeding the audio data through a deep learning model, which learns to capture the important features and patterns in the music. The resulting vectors can be stored in the vector database, enabling fast similarity searches and recommendations. When a user queries for songs similar to a given track, the system can quickly retrieve the most similar vectors from the database, providing accurate and relevant results.

In some embodiments, databases 122 may comprise and/or integrate with a blockchain database such as, for example, Ethereum or Hyperledger. Examples of the types of data that may be stored in such databases can include, but are not limited to, ownership records (e.g., immutable records of music ownership, including copyrights, licenses, and transfers), royalty distribution data (e.g., transparent and auditable records of royalty payments and distributions to rights holders), smart contracts (e.g., executable code that automates the enforcement of licensing terms, royalty calculations, and payments), provenance tracking (e.g., timestamped and immutable records of the creation, modification, and attribution history of musical pieces), and consensus data (e.g., transaction data and network consensus information related to the blockchain operations).

By combining relational databases, NoSQL databases, knowledge graphs, blockchain, and vector databases, the AI-powered music registry and collaboration platform 120 can efficiently store, manage, and analyze vast amounts of musical data. This system architecture enables complex querying, relationship discovery, and advanced machine learning applications, empowering artists, producers, and researchers to unlock new insights and creative possibilities in the world of music.

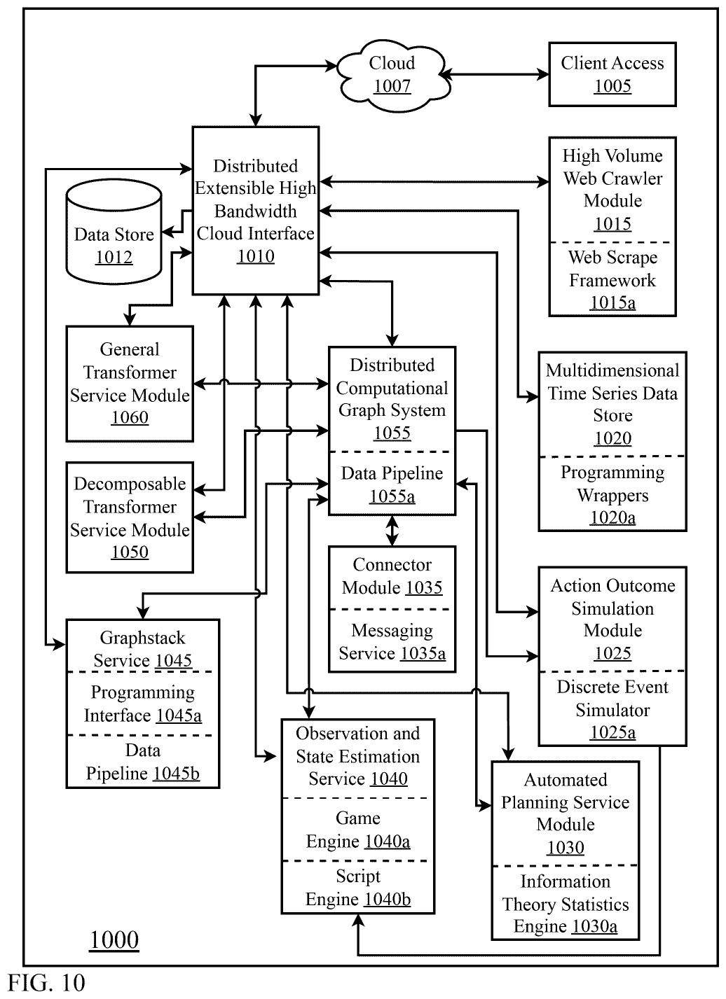

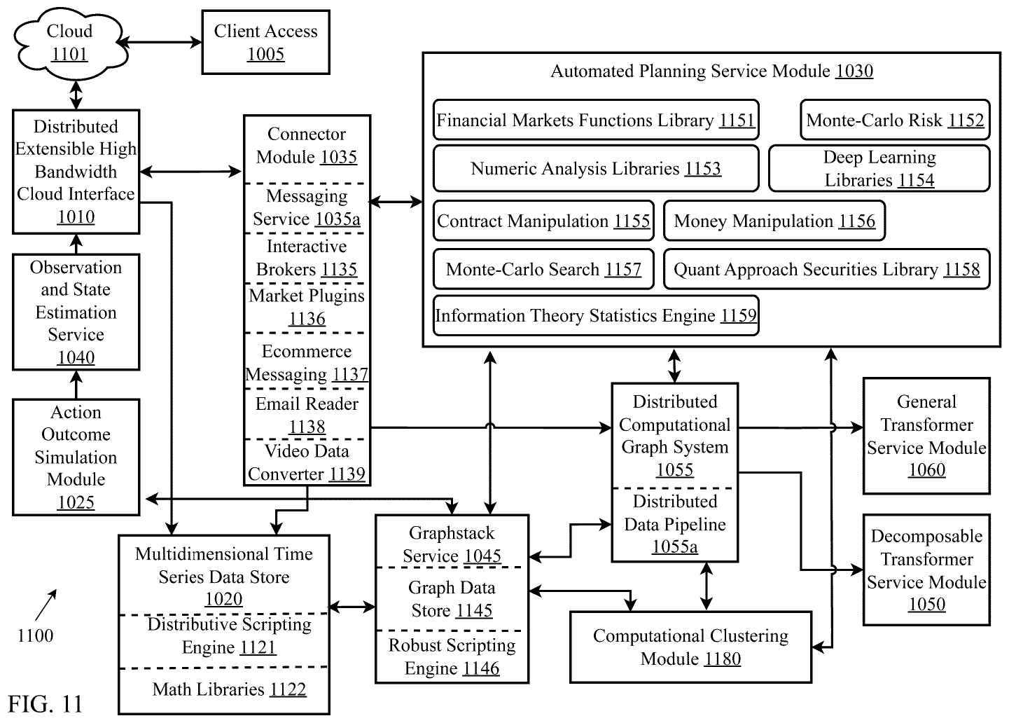

The system architecture may also include data pipelines and ETL (Extract, Transform, Load) processes to ingest, clean, and transform musical data from various sources. In some embodiments, a distributed computational graph (DCG) subsystem (please refer to FIGS. 10-11 for more information about the DCG) may be leveraged to dynamically manage data and compute pipelines. These pipelines ensure data quality, consistency, and compatibility across the different components of the system. The system can have a data pipeline, for instance, that ingests audio files from multiple sources, such as user uploads 111, record label catalogs 112, or music streaming services 113. The pipeline can apply audio preprocessing techniques, such as normalization, trimming, and format conversion, to ensure that the audio data is consistent and ready for further analysis. The transformed audio data can then be loaded into the appropriate databases (e.g., NoSQL for storage, vector database for embeddings) for efficient retrieval and processing.

The system architecture may further include an application programming interface (API) layer 121 that exposes the functionality and data of the music registry and collaboration platform 120 to external applications and services 110. This allows for seamless integration with other tools, platforms, and ecosystems in the music industry. For example, the system can provide a RESTful API that allows third-party applications to access and query the music database, retrieve song metadata, and perform similarity searches. This API can be used by music streaming services 113 to enhance their recommendation engines, by music production software to provide intelligent sample suggestions, social media servers 114 to access comments/likes/shares/etc., or by music analysis tools to access a vast library of musical data for research and experimentation.

The system includes a marketplace 900 where artists can bid on collaboration opportunities or the rights to remix existing works. This platform facilitates creative partnerships and allows emerging artists to gain exposure by working with established names in the industry. The marketplace also provides a transparent and efficient way to manage the legal and financial aspects of collaborations and remixes.

According to some embodiments, the system offers tools for adapting musical works to different formats, durations, and distribution channels. For example, a full-length song can be automatically edited into a shorter version for use in a commercial or social media post, while preserving the key elements that make it recognizable and engaging. This allows artists and rights holders to maximize the value of their content across multiple platforms and contexts.

CNNs are widely used for audio and music processing tasks, such as audio classification, genre recognition, and instrument detection. They are particularly effective at learning local patterns and hierarchical features from raw audio data. The system can use a CNN model to classify songs into different genres based on their audio features. The CNN can learn to identify the characteristic patterns and textures of each genre, such as the distorted guitars in rock music or the syncopated rhythms in funk. By training the CNN on a large dataset of labeled audio samples, the system can accurately predict the genre of new songs based on their audio content.

Recurrent Neural Networks (RNNs) and Long Short-Term Memory (LSTM) Networks may be implemented in some embodiments. RNNs and LSTMs are popular choices for modeling sequential data, such as time-series or musical sequences. They can capture the temporal dependencies and long-term context in music, making them suitable for tasks like melody generation, chord progression prediction, and audio transcription. The system may use an LSTM network to generate new melodies or continue an existing melodic sequence. By training the LSTM on a large corpus of MIDI data, it can learn the patterns, structures, and stylistic elements of different musical genres. Given a seed melody or a user-provided input, the LSTM can generate a coherent and musically plausible continuation, allowing users to explore new melodic ideas and variations.

Generative Adversarial Networks (GANs) are a class of generative models that can learn to create new data samples that are similar to the training data. In the context of music, GANs can be used for tasks such as audio synthesis, style transfer, and music generation. For example, the system may use a GAN to generate realistic-sounding drum patterns or rhythmic sequences. The GAN consists of two networks: a generator that produces new drum patterns and a discriminator that tries to distinguish between real and generated patterns. Through an adversarial training process, the generator learns to create drum patterns that are indistinguishable from real ones, allowing users to explore new rhythmic ideas and variations.

Variational Autoencoders (VAEs) are generative models that learn to encode input data into a lower-dimensional latent space and then decode it back to the original space. They can be used for tasks such as audio compression, denoising, and latent space exploration. The system can use a VAE, for example, to learn a compact representation of musical audio. By training the VAE on a large dataset of songs, it can learn to encode the essential features and characteristics of the audio into a lower-dimensional latent space. This latent representation can be used for similarity search, recommendation, or even interpolation between different songs to create new variations or blends.

Self-attention mechanisms and transformer architectures have revolutionized natural language processing and are increasingly being applied to music and audio tasks. They can capture long-range dependencies and learn complex relationships between different parts of a musical sequence. As an example, the system can use a transformer-based model to transcribe polyphonic music from audio to a symbolic representation, such as MIDI or sheet music. The transformer can learn to attend to different parts of the audio and capture the relationships between simultaneous notes and instruments. By training the model on a large dataset of aligned audio and symbolic data, it can accurately transcribe complex musical pieces, enabling users to analyze, edit, and manipulate the music in a symbolic format.

These are just a few examples of advanced machine learning algorithms that can be used in the AI-powered music registry and collaboration platform 120. The choice of algorithm depends on the specific task, data type, and desired outcome. By combining these algorithms with the system's architecture and data management capabilities, the platform can enable powerful and innovative applications in music analysis, generation, and collaboration.

In one example, the system may take a user-provided script, storyboard, or high-level concept as input to generate video and other multimedia content. The natural language processing component analyzes this input to extract key elements such as characters, settings, actions, and stylistic preferences. The script may be segmented into individual scenes or shots. The visual generative AI components then create the corresponding video frames, incorporating the specified elements and maintaining consistency across scenes. For example, if the input describes a character walking through a futuristic cityscape, the system would generate a series of frames depicting that character navigating a consistently styled sci-fi city environment. The generative models ensure that the character's appearance remains the same and the city's design is coherent throughout the generated video.

To create smooth, natural-looking video, the system may employ frame interpolation and view synthesis techniques. These allow generation of intermediate frames between key scenes to create fluid transitions and enable different camera angles or zooms to be synthetically generated from the initial video content. For instance, if the input specifies a scene transition from a wide shot of the city to a close-up of the character, the system could automatically generate the frames needed for a smooth zoom effect. The audio generative component may create background music, sound effects, and even character voices that fit the style and mood of the video. If the script mentions that ominous music should play as the character enters a dark alley, the system would compose a matching suspenseful soundtrack to accompany those visuals.

For interactive content, the system may generate branching storylines or multiple variations of a scene based on user choices, enabling the creation of interactive movies or video games. The consistency enforcement mechanisms would ensure that the key narrative elements and stylistic choices are maintained across the different possible paths. Throughout the generation process, the AI content generator's self-analyzing components constantly evaluate the multimedia content for coherence and adherence to the input specifications. If an inconsistency is detected, such as a character's clothing changing mid-scene, the system can flag it for correction to maintain continuity.

In another example, in a text-based adventure game, the AI system could generate a branching storyline where the user's choices determine the protagonist's actions, the plot's direction, and the eventual outcome. If the user decides to have their character explore a mysterious cave, the system would generate descriptions of the cave's interior, potential encounters, and resultant consequences based on the user's subsequent decisions. The AI's consistency enforcement mechanisms ensure that the generated text maintains coherence with the established story elements and the user's past choices.

This concept extends to visual and auditory content as well. In an interactive movie, the user's decisions could influence the course of the story, triggering the AI to generate different scenes, character actions, and environments. If the user chooses to have their character confront an antagonist, the system might generate a tense confrontation scene with appropriate visuals, dialogue, and background music. Alternatively, if the user opts for a stealthier approach, the AI would generate content depicting the character sneaking past enemies, with suspenseful ambient sounds and visuals that reflect the chosen path.

The AI's ability to generate cohesive and context-aware content allows for the creation of rich, reactive environments that respond to user input. In a virtual reality exploration game, the user's actions could shape the world around them. If they choose to interact with a mysterious artifact, the AI might generate new areas to explore, complete with unique visual designs, ambient soundscapes, and even haptic feedback sensations that correspond to the user's choices.

Moreover, the AI system can generate content variations that adapt to user preferences and characteristics. For instance, if a user consistently makes choices that align with a stealthy playstyle, the system could generate content tailored to that preference, such as additional sneaking challenges or special abilities that reward that approach. By leveraging the AI's capability to generate diverse, coherent content variations and its ability to incorporate user feedback, creators can craft intricate, personalized “choose your own adventure” experiences across a wide range of media formats.

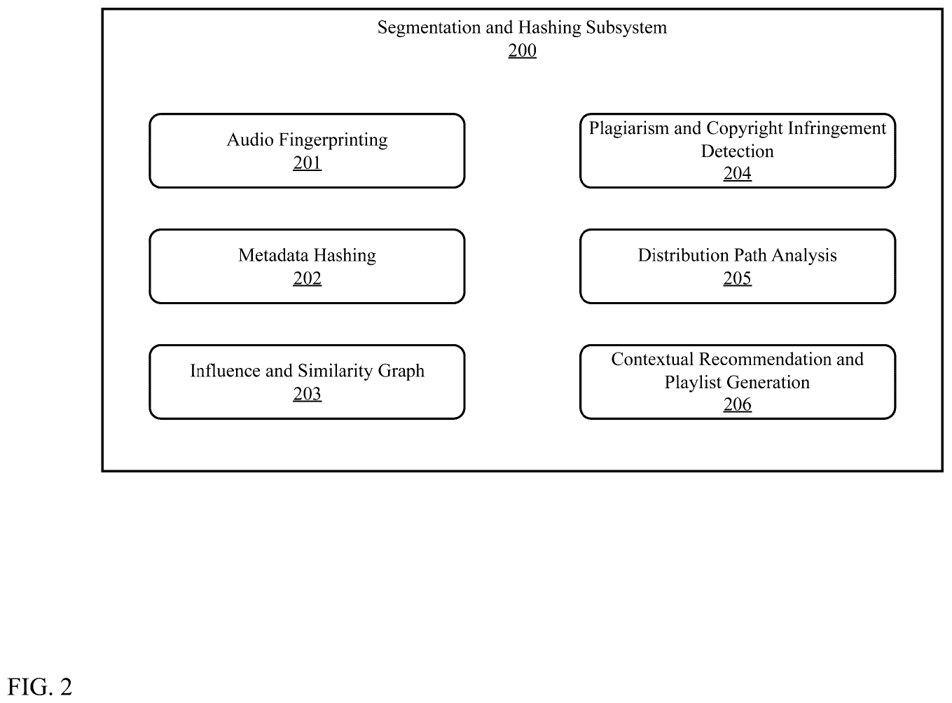

FIG. 2 is a block diagram illustrating an aspect of an artificial intelligence-powered music registry, collaboration, and workflow management system, a segmentation and hashing subsystem 200. According to the aspect, segmentation and hashing subsystem generates unique hashes for each musical component, allowing for quick and accurate comparisons between songs, albums, artists, genres, and distribution paths. This enables the identification of similarities, influences, and potential copyright infringement issues, as well as the tracking of how musical elements are used and shared across different platforms and media. According to the aspect, segmentation and hashing subsystem 200 comprises an audio fingerprinting component 201, a metadata hashing component 202, an influence and similarity graph component 203, a plagiarism and copyright infringement detection component 204, a distribution path analysis component 205, and a contextual recommendation and playlist generation component 206.

According to the aspect, the system employs advanced audio fingerprinting algorithms 201 to create unique hashes for each song, album, or musical component that a user uploads. These algorithms analyze the acoustic properties of the audio, such as spectral, temporal, and rhythmic features, to generate a compact and robust representation of the audio content. Examples of audio fingerprinting techniques that may be implemented include Shazam's algorithm, Philips' Robust Hash (PRH), and Fraunhofer's AudioID. As an example, when a new song is added to the music registry, the system generates a unique audio fingerprint based on its acoustic properties. This fingerprint can then be compared to the fingerprints of other songs in the database to identify potential matches or similarities.

In some embodiments, the system may implement advanced source separation techniques, such as Deep Extractor or Spleeter, to isolate individual instruments and vocals from a mixed audio track. These techniques leverage deep learning models trained on large datasets of isolated instrument and vocal recordings to accurately separate the different elements of a song. The output of the source separation process will be separate audio stems for each instrument (e.g., drums, bass, guitar) and vocals. The system may then apply audio fingerprinting algorithms, such as Shazam's fingerprinting or Chromaprint, to each isolated audio stem. These algorithms analyze the unique spectral and temporal characteristics of the audio and generate a compact and robust fingerprint that represents the essence of the sound. The fingerprints are typically represented as binary or hexadecimal strings, making them efficient for storage and comparison.

In some embodiments, segmentation and hashing subsystem 200 provides hashing and indexing mechanisms. System may hash the audio fingerprints using a secure cryptographic hash function, such as SHA-256 or MD5, or may utilize a neural network to create hash values. The hashing process converts the fingerprint into a fixed-size string of characters that uniquely identifies the audio content. System may store the hashed fingerprints in a database or an index, along with metadata such as the song title, artist name, and timestamp of the audio segment.

In addition to audio fingerprinting, the system can also be configured to create hashes based on the metadata associated with each musical entity, such as artist names, album titles, genre tags, and release dates. This metadata hashing 202 allows for quick and efficient comparisons of musical entities based on their textual attributes. In some implementations, the system can attach relevant metadata tags to each segmented and hashed audio element. The metadata can include information such as the instrument or vocal type, the performer's name, the role (e.g., lead vocals, backing vocals), and the time range within the original composition. This metadata enables precise crediting and attribution of each musical element to the respective contributors. For example, the system can generate a unique hash for each artist based on their name, discography, and biographical information. These hashes can be used to identify collaborations, influences, or similar artists within the music registry.

In some embodiments, the system may integrate the hashed audio fingerprints and metadata into a blockchain network, such as Ethereum or Hyperledger. The blockchain provides an immutable and transparent ledger for storing the ownership and licensing information associated with each musical element. Smart contracts may be used to automate the distribution of royalties based on the usage and licensing terms of each segmented component.

By comparing the audio fingerprints and metadata hashes of musical entities, the system can construct a comprehensive graph 203 that represents the relationships between songs, albums, artists, and genres based on their similarities and influences. This graph can be used to trace the evolution of musical styles, identify key influencers, and discover new connections between artists. For instance, the influence graph can reveal that a particular hip-hop track heavily samples a classic soul song from the 1970s. This connection can be used to attribute proper credit and royalties to the original artist and to understand the creative lineage of the new track.

The sampling and hashing techniques employed by the system can be used to detect potential cases of plagiarism or copyright infringement 204. By comparing the audio fingerprints and metadata hashes of new musical works to those in the registry, the system can identify suspicious similarities and flag them for further investigation. For instance, if a newly released song has an audio fingerprint that closely matches that of an existing song in the registry, the system can alert the copyright holders and initiate a process to determine whether infringement has occurred. This can help protect the rights of artists and ensure fair compensation for their work.

In some embodiments, the system may implement similarity matching algorithms to compare the hashed fingerprints of newly uploaded or streamed content against the existing database of fingerprints. Techniques such as locality-sensitive hashing (LSH) or nearest neighbor search can be used to efficiently find matching or similar audio segments. This enables the identification of sampled, covered, or remixed versions of the original musical elements, facilitating proper crediting and royalty distribution.

The system can also analyze the distribution paths 205 of musical entities by tracking how they spread across different platforms, media, and geographical regions. By comparing the distribution patterns of different songs or artists, the system can identify trends, measure popularity, and detect potential cases of unauthorized distribution or piracy. As an example, the system may compare the distribution paths of two similar songs to determine which one has achieved greater market penetration or to identify regions where one song may be more popular than the other. This information can be used to optimize marketing strategies, detect potential copyright infringement, and measure the overall success of a musical work.

The sampling and hashing techniques can be used to generate contextual recommendations and dynamic playlists 206 based on the similarities and influences between musical entities. By analyzing the relationships in the influence graph, the system can suggest songs, albums, genres, or artists that are likely to appeal to a user's tastes or complement their current listening context. For example, if a user is listening to a particular jazz album, the system can recommend other albums from the same era or style based on their audio fingerprints and metadata hashes. The system can also generate a playlist that explores the influences and descendants of that album, providing a rich and contextually relevant listening experience.

According to an embodiment, the system may generate detailed reports and analytics based on the usage and matching of the segmented and hashed musical elements. In such embodiments, the system can track metrics such as the number of plays, downloads, or streams for each component, as well as the geographical and demographic distribution of the audience. This can provide transparency and insights to musicians, producers, and rights holders regarding the performance and reach of their contributions.

By leveraging sampling and unique hashing techniques, AI-powered music registry and collaboration system 120 can create a robust and interconnected ecosystem that facilitates the discovery, attribution, and protection of musical works. This approach enables a deeper understanding of the complex relationships between musical entities and provides valuable tools for artists, labels, and music enthusiasts alike.

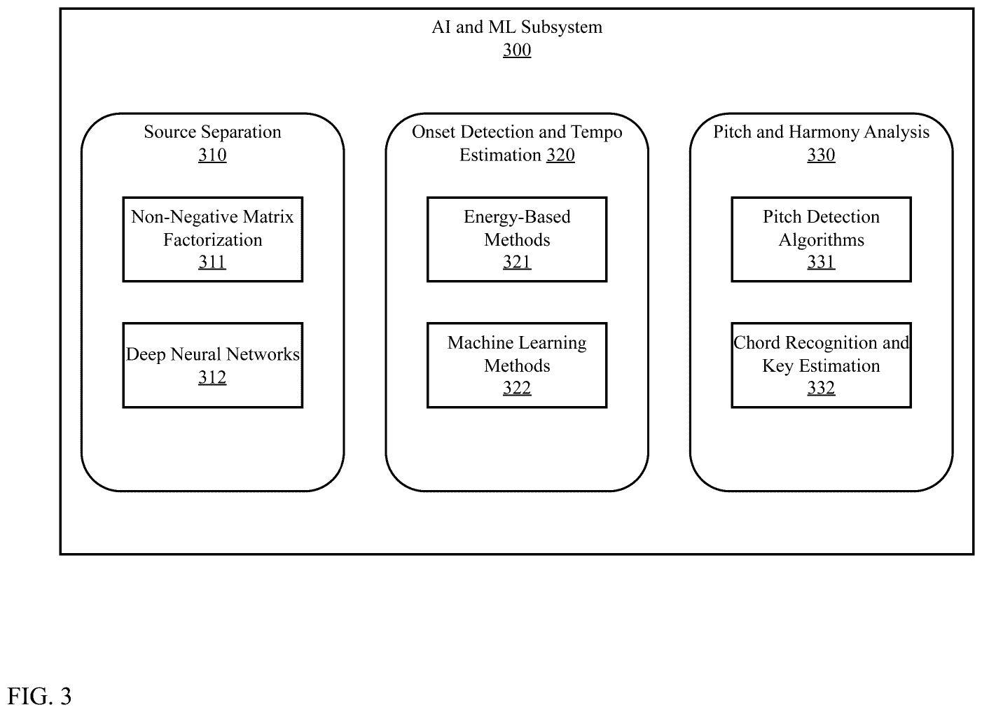

FIG. 3 is a block diagram illustrating an aspect of an artificial intelligence-powered music registry, collaboration, and workflow management system, an AI and ML subsystem 300. According to the aspect, the subsystem 300 employs advanced AI/ML techniques, such as neural networks and specially-tuned models, to analyze musical pieces and isolate individual instruments, vocals, and performer contributions. According to the aspect, AI and ML subsystem 300 may comprises a source separation component 310, an onset detection component 320, and a pitch and harmony analysis component 330.

Source separation is a fundamental technique used to isolate individual instruments, vocals, and other components from a mixed audio signal. It involves using machine learning algorithms to analyze the spectral and temporal characteristics of the audio and identify the unique signatures of each component. According to the aspect, one approach utilizes non-negative matrix factorization (NMF) 311. NMF is a technique that decomposes an audio spectrogram into a set of non-negative basis functions and their corresponding activation coefficients. By training NMF models on isolated instrument recordings, the system can learn to identify and separate the individual components of a mixed audio signal. Another approach that may be implemented uses deep neural networks (DNNs) 312. DNNs, such as Convolutional Neural Networks (CNNs) and Recurrent Neural Networks (RNNs), have shown excellent performance in source separation tasks. These models can learn complex patterns and relationships in the audio data, allowing them to accurately identify and extract individual instruments and vocals. U-Net and Wave-U-Net are popular CNN architectures used for this purpose. As an example, the system can use a trained DNN to separate the vocals, guitar, bass, and drums from a mixed audio recording of a rock song, enabling the manipulation and analysis of each component independently.

Onset detection involves identifying the starting points of musical events, such as notes or percussive hits, within an audio signal. Tempo estimation refers to the process of determining the speed or pace of a musical piece. These techniques are important for accurately segmenting and aligning musical components. According to an aspect, onset detection utilizes energy-based methods 321. These methods rely on detecting sudden changes in the energy or amplitude of the audio signal, which often correspond to the onset of musical events. Techniques like spectral flux, high-frequency content, and phase deviation can be used for this purpose. Additionally, or alternatively, one or more machine learning (ML) methods 322 may be used to facilitate onset detection. ML models, such as DNNs or Support Vector Machines (SVMs), can be trained on labeled onset data to learn the patterns and characteristics of musical events. These models can then be used to detect onsets in new audio signals. For example, by accurately detecting the onsets of individual drum hits and estimating the tempo of a musical piece, the system can isolate and analyze the rhythmic components, enabling tasks such as beat matching, tempo synchronization, and groove analysis.

Pitch and harmony analysis 330 may involve identifying the fundamental frequencies and the relationships between different notes in a musical piece. This information is essential for tasks such as melody extraction, chord recognition, and key estimation. Some common techniques include pitch detection algorithms (PDAs) 331. PDAs, such as the YIN algorithm or the autocorrelation method, can be used to estimate the fundamental frequency of a monophonic audio signal. These algorithms analyze the periodicity of the waveform to determine the pitch of the dominant sound source. Chord recognition and key estimation 332 can also be implemented to support pitch and harmony analysis. ML models, such as Hidden Markov Models (HMMs) or DNNs, can be trained on labeled chord and key data to learn the patterns and relationships between different harmonies. These models can then be used to recognize chords and estimate the key of a musical piece based on the pitch and harmonic information. As an example, by analyzing the pitch and harmony of a vocal recording, the system can extract the melody, identify the underlying chord progressions, and estimate the key of the piece. This information can be used for tasks such as harmony-based similarity search, automatic accompaniment generation, and music transcription.

These are just a few examples of the AI/ML techniques that may be used for extracting and isolating individual music components. The field of Music Information Retrieval (MIR) is rapidly evolving, with researchers and practitioners constantly developing new and improved methods for analyzing and manipulating musical data which can be incorporated in registry and collaboration system 120.

According to an aspect, music registry and collaboration system 120 can leverage its vast corpus of music data and advanced machine learning and AI algorithms to develop a generative AI system 340 capable of creating music that seamlessly fills in blank spaces within a musical composition. By analyzing the musical context surrounding the blank space, including the preceding and succeeding musical segments, the system can generate music that matches and synchronizes with the existing composition.

To achieve this, the system may first preprocess and analyze the large dataset of musical compositions, extracting relevant features such as melodies, harmonies, rhythms, and instrumental patterns. It may then train deep learning models, such as recurrent neural networks (RNNs) or transformer-based models, on this dataset to learn the underlying structures, styles, and patterns present in various musical genres and styles.

When a user provides a musical composition with a blank space, the system can analyze the musical context surrounding the gap, taking into account the melodic, harmonic, and rhythmic elements of the preceding and succeeding sections. It would also consider factors such as the overall style, genre, and mood of the composition to ensure the generated music aligns with the intended artistic direction. Likewise, the system may include things like cinematography or sound track types. This allows the system to generate audio consistent with an associated visual counterpart. For example, classical music may be more appropriate with a drama film, while up-tempo rap style music may be more appropriate during a heist scene in a thriller. By incorporating video elements into audio generation, the generated content may be applied to multiple modalities.

Using the trained generative models, the system may then create multiple candidate musical segments that could potentially fill the blank space. These segments would be generated based on the learned patterns and structures from the training data, while also incorporating the specific musical context of the user's composition. The generated segments aim to seamlessly connect the preceding and succeeding musical sections, maintaining the flow and coherence of the overall composition.

To refine the generated musical segments, the system can employ various techniques such as musical similarity measures, harmonic and rhythmic alignment algorithms, and user feedback. It may assess the compatibility and continuity of the generated segments with the existing music, ensuring that the transitions between the generated and original sections are smooth and musically pleasing. User feedback and preferences could also be incorporated to guide the generation process, allowing for more personalized and tailored musical outputs.

The system can further enhance the generated music by applying post-processing techniques, such as instrumentation and arrangement optimization, to ensure that the added musical segments blend seamlessly with the existing composition. It could also provide users with multiple generated options to choose from, allowing for creative flexibility and artistic control.

By combining the power of machine learning, AI, and the extensive music dataset, the generative AI system within music registry and collaboration platform 120 would enable users to fill in blank spaces within their musical compositions with high-quality, context-aware, and stylistically consistent music. This would greatly enhance the creative workflow, allowing musicians and composers to explore new ideas, overcome creative blocks, and create more cohesive and polished musical works.

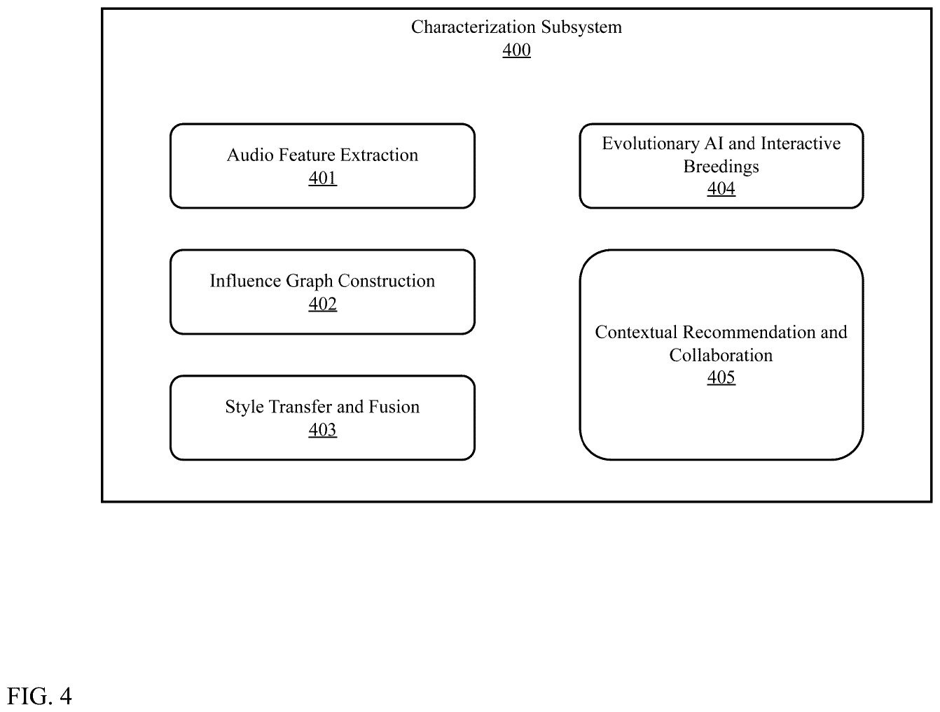

FIG. 4 is a block diagram illustrating an aspect of an artificial intelligence-powered music registry, collaboration, and workflow management system, a characterization subsystem 400. According to the aspect, characterization subsystem 400 analyzes the unique styles, techniques, and influences of individual artists to create detailed profiles that can be used for AI/ML training and modeling. According to the aspect, characterization subsystem 400 comprises an audio feature extraction component 401, an influence graph construction component 402, a style transfer and fusion component 403, an evolutionary AI and interactive breeding component 404, and a contextual recommendation and collaboration component 405.

According to the embodiment, the system employs advanced audio feature extraction techniques 401 to analyze and characterize the musical style of individual artists. This may involve extracting a wide range of features, such as timbre, pitch, rhythm, harmony, and dynamics, from their recordings. These features serve as a unique fingerprint of the artist's sound and can be used to train AI/ML models to recognize and replicate their style. For example, by extracting audio features from a collection of guitar recordings by Jimi Hendrix, the system can learn the unique characteristics of his playing style, such as his use of distortion, feedback, and improvisation. These features can then be used to train an AI/ML model to generate new guitar riffs or solos that sound similar to Hendrix's style.

In some implementations, characterization subsystem 400 may be further configured to perform pattern identification on uploaded music. For example, music and mathematics may be closely related wherein some musical composition follows patterns related to fractal, golden mean, Fibonacci, etc. sequences. The system may identify patterns in a musical piece or component and/or across different pieces. The system may, according to an embodiment, convert the musical compositions into a suitable representation, such as MIDI or symbolic music data, which captures the notes, pitches, durations, and other relevant musical attributes and then normalize and standardize the music data to ensure consistency and comparability across different pieces. The system can define and encode the desirable patterns, structures, recursions, or inversions of interest, such as fractal patterns, golden mean/ratio, or Fibonacci sequences, and represent these patterns mathematically or algorithmically, enabling the system to search for and identify them in the music data.

In some implementations, the system may develop and apply specialized pattern recognition algorithms to analyze the preprocessed music data and identify instances of the defined patterns. It may utilize techniques such as: fractal analysis wherein fractal dimension estimation algorithms (e.g., box-counting method) identify self-similar patterns and structures in the music data; golden ratio detection wherein algorithms search for the presence of the golden ratio (approximately 1.618) in the proportions of musical elements, such as phrase lengths, sectional divisions bar lengths, and counterpoint movements; Fibonacci sequence identification wherein algorithms identify the occurrence of Fibonacci-like sequences in the melodic or rhythmic patterns of the music; and recursive pattern matching wherein recursive algorithms or dynamic programming techniques to identify recurring patterns or motifs within and across musical pieces.

In some implementations, the system can perform cross-piece pattern analysis wherein the system can apply the pattern recognition algorithms to a large dataset of musical compositions stored in the music registry to identify pieces that exhibit the desired patterns, structures, recursions, or inversions. The system can analyze the prevalence, distribution, and significance of these patterns across different musical styles, genres, or time periods. Additionally, the system may measure the similarity between musical pieces based on the presence and characteristics of the identified patterns. For example, the system can utilize clustering algorithms (e.g., k-means, hierarchical clustering) to group musical pieces that share similar pattern features to discover clusters or families of musical compositions that exhibit common desirable patterns or structures. In some embodiments, the system may utilize the identified patterns and clusters to provide pattern-based recommendations and enable the discovery of musical pieces with similar desirable characteristics and allow users to search for and explore musical compositions based on specific pattern criteria, such as pieces that exhibit strong fractal properties or golden ratio proportions.

The system can construct an influence graph 402 that maps the relationships between artists based on their musical similarities and historical influences. This graph can be built using a combination of audio feature analysis, metadata (e.g., artist collaborations, genre tags), and expert human input. The influence graph provides a rich context for understanding an artist's style and how it relates to other artists and genres. As an example, the influence graph can show how the Beatles were influenced by artists like Chuck Berry and Little Richard, and how they, in turn, influenced later generations of rock and pop musicians. This information can be used to trace the evolution of musical styles and identify key influencers in different genres.

According to an embodiment, AI/ML models can be trained to perform style transfer 403, allowing the system to apply the characteristics of one artist's style to another artist's composition or performance. This enables the creation of novel and interesting musical combinations that blend the styles of different artists. Additionally, the system can use generative models to fuse elements from multiple artists, creating new and unique musical styles. For example, the system can use style transfer to apply the vocal characteristics of Freddie Mercury to a new pop song, making it sound as if Mercury himself were singing the track. Alternatively, the system can fuse the drumming style of John Bonham with the bass playing of Flea to create a unique and powerful rhythm section for a new rock composition.

According to the aspect, the system can employ evolutionary AI techniques 404, such as genetic algorithms or neuroevolution, to generate new musical content by combining and mutating the styles of different artists. This approach mimics the process of natural evolution, allowing the system to explore a vast space of potential musical combinations and select the most promising candidates based on fitness criteria, such as similarity to a target style or user preferences. For example, using evolutionary AI, the system can generate a population of new jazz compositions that combine the styles of Miles Davis, John Coltrane, and Herbie Hancock. The user can then interactively “breed” the compositions by selecting their favorite candidates, which are then used to generate the next generation of compositions, gradually evolving towards the user's desired style.

By characterizing individual artists and their influences, the system can provide contextual recommendations 405 for collaborations, remixes, or mashups. It can identify artists with complementary styles or shared influences, suggesting potential collaborations that could lead to innovative and exciting new music. The system can also recommend artists for users to discover based on their listening history and preferences. As an example, if a user frequently listens to both Kanye West and Daft Punk, the system can recommend a collaboration between the two artists, highlighting their shared influences in hip-hop and electronic music. The system can also suggest other artists in the same musical lineage, such as J Dilla or Justice, for the user to explore.

By leveraging AI/ML techniques to characterize individual artists and their influences, music registry and collaboration system 120 can unlock new creative possibilities and inspire innovative musical works. This approach allows for the preservation and celebration of diverse musical styles while also enabling the emergence of new and exciting musical frontiers.

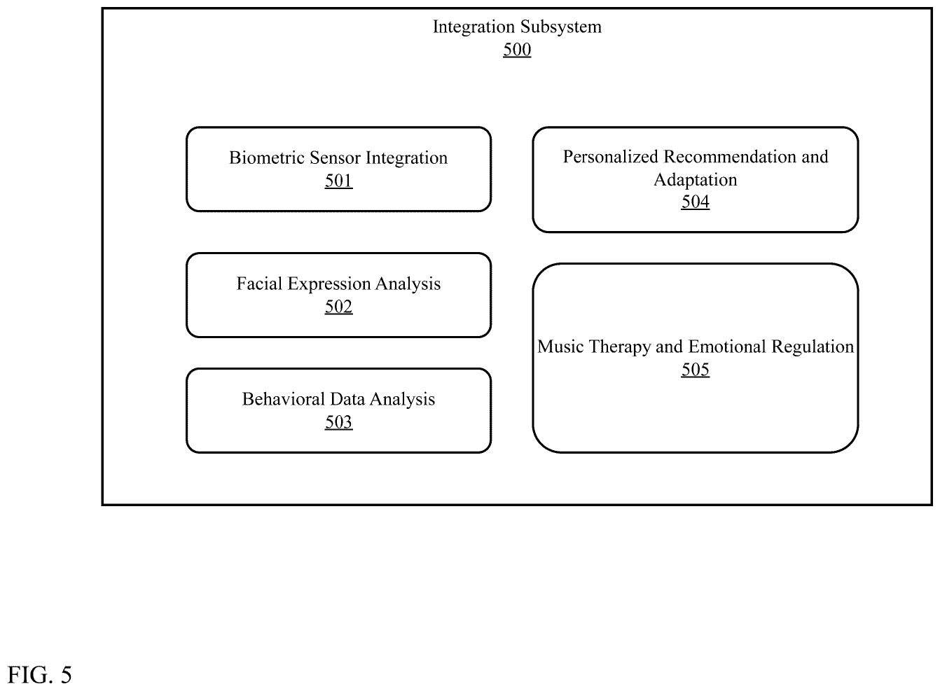

FIG. 5 is a block diagram illustrating an aspect of an artificial intelligence-powered music registry, collaboration, and workflow management system, an integration subsystem 500. According to the aspect, by integrating biometric and behavioral data, such as heart rate, pupil dilation, and facial expressions, the system can analyze the emotional and physiological responses of listeners to specific musical pieces or components. This information can be used to optimize the creation and selection of music for various contexts, such as advertising, film, or therapeutic applications. According to the aspect, integration subsystem 500 comprises a biometric sensor integration component 501, a facial expression analysis component 502, a behavioral data analysis component 503, a personalized recommendation and adaptation component 504, and a music therapy and emotional regulation component 505.

In one embodiment, when generating a video sequence, the AI system may create smooth transitions between scenes by interpolating intermediate frames. This ensures a seamless flow of action and maintains visual coherence. Additionally, the AI can synthesize alternative camera angles and shots from a single input, allowing for more dynamic and varied cinematography in the generated content.

Furthermore, by incorporating 2D to 3D conversion techniques, the AI system can take user-provided 2D images or videos and transform them into 3D representations. This enables the generation of more immersive and interactive content, such as virtual reality experiences or 3D animations, from relatively simple 2D inputs. The AI can also ensure consistency in the generated 3D elements, maintaining the same visual style, lighting, and textures across different scenes or sequences.

Integrating these multimedia generation capabilities, an AI-driven content generation pipeline will result in a more comprehensive and versatile system. Users can provide diverse types of input, ranging from text descriptions to 2D images, and the AI will generate rich, consistent, and engaging multimedia content that seamlessly combines various modalities. This enhanced system will enable creators to develop compelling narratives, interactive experiences, and immersive environments that adapt to user choices and preferences while maintaining a high degree of audiovisual coherence and continuity.

According to the aspect, the system can integrate with various biometric sensors, such as wearable devices (e.g., smartwatches, fitness trackers) or non-invasive monitoring systems (e.g., cameras, microphones) to collect real-time data on listeners' physiological responses to music. This data can include heart rate, skin conductance (a measure of emotional arousal), respiratory rate, and brain activity (through EEG or fMRI). As an example, during a live concert, the system can collect biometric data from a sample of the audience using wearable sensors. This data can be analyzed to determine which songs or specific musical moments elicit the strongest emotional responses, such as increased heart rate or skin conductance spikes during powerful crescendos or solos.

The system can use computer vision techniques to analyze listeners' facial expressions 502 and body language while they engage with music. By detecting emotions such as happiness, sadness, surprise, or excitement, the system can infer the emotional impact of specific musical passages or styles. For example, while a user listens to a playlist on a music streaming service, the system can use the device's camera to capture and analyze their facial expressions. This data can be used to create an emotional profile of the user's listening experience, identifying the tracks that evoke the most positive or intense emotional responses.

According to the aspect, the system can collect and analyze behavioral data 503 from music streaming platforms 113, social media 114, and other digital sources to understand how listeners interact with and share music. This data can include, for example, play counts, skip rates, playlist additions, likes, comments, and shares. By combining this behavioral data with biometric and emotional data, the system can gain a more comprehensive understanding of listener engagement and preferences. As an example, the system can analyze the behavioral data of a large sample of users who have listened to a particular album. By identifying the tracks with the highest play counts, lowest skip rates, and most social media shares, the system can infer which songs are the most popular and engaging. This data can be cross-referenced with biometric data to understand the physiological and emotional factors driving these preferences.

By integrating biometric and behavioral data, the system can provide personalized music recommendations 504 that are tailored to each listener's emotional state and preferences. The system can adapt playlists or suggest specific tracks based on the user's current mood or desired emotional outcome. For example, if a user's biometric data indicates that they are feeling stressed or anxious, the system can recommend a playlist of calming, relaxing tracks that have been shown to reduce stress in other listeners with similar profiles. As the user listens to the playlist, the system can continue to monitor their biometric data and adjust the recommendations, accordingly, ensuring an optimal listening experience.

The insights gained from integrating biometric and behavioral data can be applied to the development of music-based therapies and interventions for emotional regulation. By understanding how specific musical elements and styles influence listeners' emotions and physiology, the system can help create targeted interventions for conditions such as anxiety, depression, or sleep disorders. As an example, the system can analyze biometric data from a group of individuals with anxiety disorders to identify the musical characteristics that are most effective in reducing their symptoms. This information can be used to create a music therapy program that incorporates these elements, providing a non-pharmacological approach to managing anxiety.

Integrating biometric and behavioral data into the AI-powered music registry and collaboration system 120 opens up new possibilities for understanding and optimizing the emotional impact of music. By leveraging this data, the system can provide personalized experiences, inform music creation and curation, and support the development of music-based interventions for health and well-being. As our understanding of the complex relationship between music and emotion deepens, this integration will become increasingly valuable for artists, listeners, and the music industry as a whole.

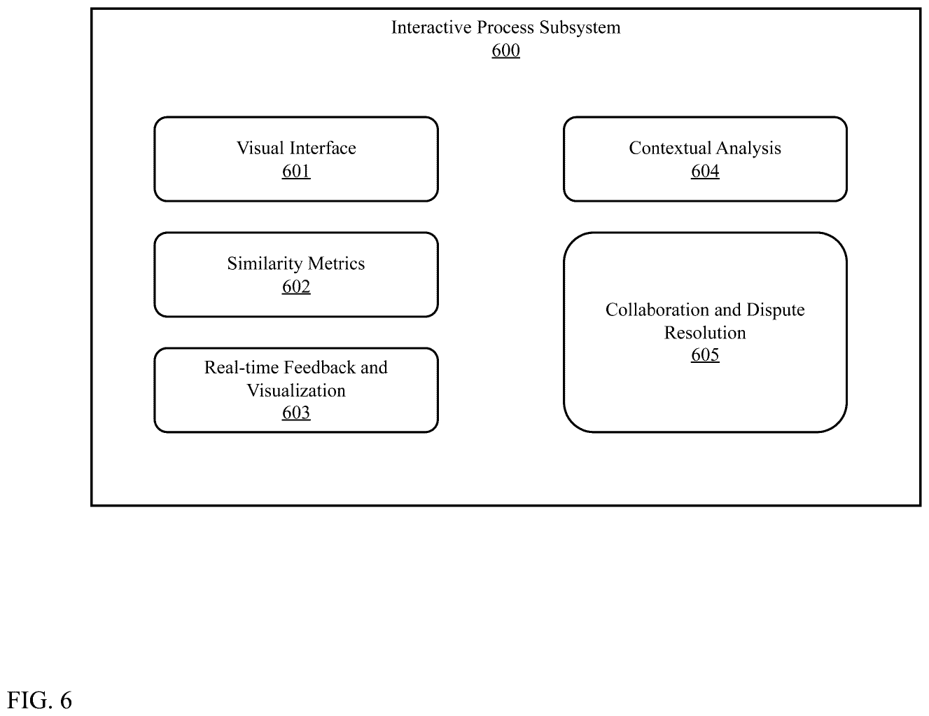

FIG. 6 is a block diagram illustrating an aspect of an artificial intelligence-powered music registry, collaboration, and workflow management system, an interactive process subsystem 600. According to the aspect, interactive process subsystem 600 provides interactive tools for comparing new musical works to existing ones, calculating distance and similarity metrics based on various factors such as melody, harmony, rhythm, and lyrical content. According to the aspect, interactive process subsystem 600 comprises a visual interface component 601, a similarity metrics component 602, a real-time feedback and visualization component 603, a contextual analysis component 604, and a collaboration and dispute resolution component 605.

According to the aspect, the system employs various similarity metrics 602 to quantify the distance or closeness between musical works. These metrics can be based on audio features, melodic and harmonic content, rhythmic patterns, or lyrical similarities. Some common similarity metrics which may be implemented include, but are not limited to: Euclidean distance which measures the straight-line distance between two feature vectors in a high-dimensional space; Cosine Similarity, which calculates the cosine of the angle between two feature vectors, indicating their similarity in terms of orientation; Dynamic Time Warping (DTW), which aligns two temporal sequences (e.g., melodies) and measures their similarity while allowing for local stretching or compression; edit distance, which quantifies the number of operations (insertions, deletions, or substitutions) required to transform one sequence into another. As an example, when a composer creates a new melody, the system can compare it to a database of existing melodies using DTW and compute a similarity score. If the similarity score exceeds a certain threshold, the system can alert the composer and suggest modifications to make the melody more distinctive.

One example is the generation of interactive 3D experiences using Mirasol3d technology. The AI system can take user inputs, such as story concepts, character descriptions, or scene settings, and generate immersive 3D environments that users can explore and interact with. By leveraging techniques for maintaining scene continuity and consistency, the AI can create seamless transitions between different areas or chapters of the experience. Users can make choices that influence the narrative direction, and the AI will dynamically generate new content that adapts to those decisions while maintaining visual and thematic coherence. Additionally, the system can incorporate sophisticated lighting, textures, and physics simulations to enhance the realism and immersion of the generated 3D content.

Another example is the creation of dynamic, interactive narratives using state-of-the-art (SOTA) spacetime patches. The AI system can generate branching storylines that allow users to explore different paths and outcomes based on their choices. These narratives can be presented in various formats, such as interactive videos, text adventures, or even augmented reality experiences. The AI can generate content that seamlessly blends different media elements, such as text, images, audio, and video, to create rich and engaging stories. By leveraging techniques for adapting content to user preferences and characteristics, the AI can tailor the narrative experience to individual users, adjusting factors like pacing, complexity, or emotional tone based on their interactions and feedback. Moreover, the system can employ advanced natural language processing and generation techniques to create compelling dialogue, descriptions, and narration that enhance the storytelling experience.

To add further depth and communicative value to the generated content, the AI system can incorporate a “temperature-like” control for metaphor construction. This feature allows users to adjust the level of metaphorical complexity and richness in the generated text, visuals, or audio based on their intended audience or specific communication goals. For example, if the user is creating content for a younger audience, they can set the metaphor temperature to a lower level, resulting in more straightforward and easily understandable language and imagery. On the other hand, if the user is targeting a more sophisticated or literature-savvy audience, they can increase the metaphor temperature to generate content with more complex and nuanced metaphors, symbolism, and allusions. This granular control over the figurative language and symbolic elements in the generated content enables creators to fine-tune their narratives and experiences to resonate with specific audiences and achieve their desired emotional and intellectual impact.

The system can provide real-time feedback and visualization 603 of the similarity metrics as users create or modify musical works. This allows users to immediately see how their changes impact the originality of their work and make adjustments accordingly. The feedback can be presented through intuitive visual interfaces 601, such as color-coded similarity matrices, interactive graphs, or side-by-side comparisons. For example, as a producer is working on a new track, the system can continuously analyze the audio and provide a visual representation of its similarity to existing tracks in the database. The producer can use this feedback to identify potential copyright issues and iterate on the track until it achieves a satisfactory level of originality.

The interactive process allows users to iteratively refine their musical works based on the similarity feedback provided by the system. Users can experiment with different variations, make targeted modifications, and explore alternative creative directions to minimize the risk of copyright infringement while still maintaining their artistic vision. If a songwriter, for example, is notified that their lyrics are too similar to an existing song, they can use the system's suggestions and feedback to iteratively modify the lyrics, adjusting specific words, phrases, or rhyme schemes until the similarity scores fall within an acceptable range.

The system may be configured to take into account the context and genre of the musical works when calculating similarity metrics. This ensures that the comparisons are meaningful and relevant within the specific musical domain. The system can also consider factors such as the popularity, cultural significance, and historical context of existing works to provide more nuanced guidance to users. For example, when analyzing the similarity of a new hip-hop track to existing works, the system can focus on elements that are particularly important in that genre, such as the beat, flow, and lyrical content. The system can also consider the influence and popularity of existing tracks to help the artist understand the potential impact of any similarities.

The interactive process subsystem 600 can facilitate collaboration between multiple stakeholders, such as composers, lyricists, and producers, by providing a shared platform for evaluating and refining musical works. In case of disputes or conflicting opinions, the system can provide objective metrics and evidence to support decision-making and help resolve any issues. As an example, if a composer and a lyricist disagree on whether a particular section of a song is too similar to an existing work, they can use the system's similarity metrics and visual feedback to have a data-driven discussion and reach a consensus on how to proceed.

By incorporating interactive processes for determining distance and similarity metrics, the AI-powered music registry and collaboration system 120 empowers users to create original and distinctive musical works while minimizing the risk of copyright infringement. These processes foster creativity, collaboration, and responsible artistic practices, ultimately benefiting the entire music ecosystem.

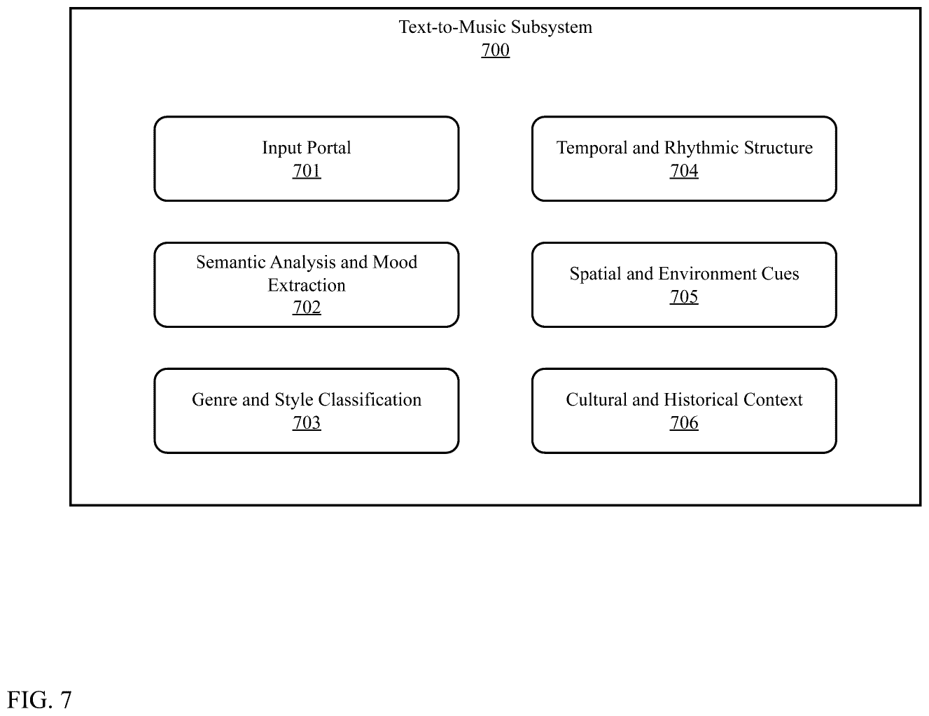

FIG. 7 is a block diagram illustrating an aspect of an artificial intelligence-powered music registry, collaboration, and workflow management system, a text-to-music subsystem 700. In one embodiment, the text-to-music subsystem may be expanded to include conversion between a plurality of other modalities, including but not limited to video, voice, physics, music, and olfactory data. According to the aspect, text-to-music subsystem 700 allows users to generate musical compositions or elements based on textual input, taking into account various characteristics such as mood, genre, tempo, instrumentation, and cultural context. This enables the creation of custom music for specific contexts, such as film scenes, video games, or marketing campaigns, while ensuring the generated content aligns with the desired emotional and aesthetic goals. By leveraging advanced natural language processing (NLP) and deep learning techniques, the system can interpret and translate textual descriptions into meaningful musical representations. According to the aspect, text-to-music subsystem 700 comprises an input portal 701, a semantic analysis and mood extraction component bb702b, a genre and style classification component 703, a temporal and rhythmic structure component 704, a spatial and environment cues component 705, and a cultural and historical context component 706.

Text-to-music subsystem 700 may implement an input portal 701 wherein a system user can input a textual description/prompt of a musical composition or element they wish to generate.

According to the aspect, the system may use NLP techniques, such as sentiment analysis and emotion detection, to extract the underlying mood and emotional intent from the input text. This allows the system to generate music that aligns with the desired emotional tone, whether it's happy, sad, suspenseful, or romantic. As an example, if a user inputs the text “A melancholic rainy day in Paris,” the system can analyze the semantic content and generate a musical piece that evokes feelings of melancholy and nostalgia, possibly using a slow tempo, minor key, and instruments associated with Parisian culture, such as an accordion or a piano.

According to the aspect, the system can classify the input text into specific musical genres or styles 703 based on keywords, phrases, or cultural references. By understanding the intended genre or style, the system can generate music that adheres to the characteristic elements and conventions of that particular genre. For example, if the input text mentions “funky bass line” or “soulful groove,” the system can infer that the desired music should be in the funk or soul genre. It can then generate a composition that incorporates elements such as syncopated rhythms, prominent bass lines, and brass or organ instrumentation.

The text-to-music capabilities can interpret temporal and rhythmic 704 cues from the input text to generate music with the appropriate pacing, meter, and structure. This includes understanding phrases like “fast-paced,” “slow and steady,” or “waltz-like” to create music with the corresponding tempo and rhythmic patterns. If the input text describes a “heart-pounding chase scene,” for example, the system can generate music with a fast tempo, driving rhythms, and intense orchestration to match the desired level of excitement and urgency. In some embodiments, text-to-music capabilities may be expanded to include other emotional and narrative extraction elements beyond just tempo to go along with a film or other generated elements.

The system can interpret spatial and environmental descriptions 705 in the input text to generate music that evokes a sense of place or atmosphere. This includes understanding references to specific locations, landscapes, or settings and incorporating appropriate musical elements to create an immersive auditory experience. For example, if the input text mentions “a serene mountain vista” or “a bustling city street,” the system can generate music that captures the essence of those environments, using elements such as nature sounds, ambient textures, or urban rhythms to transport the listener to the described location.

The AI-powered content generation system's music and audio capabilities can be further enhanced by introducing “alt-music” or “alt-soundeffect” features, similar to the concept of “elegant failover” in music generation. This functionality allows for the dynamic generation of alternative soundtracks, sound effects, or even dialogue that can seamlessly replace or augment existing audio elements in the generated content. One key application of this feature is in addressing specific content elements or licensure issues. For example, if a particular piece of music or a sound effect used in the generated content is subject to licensing restrictions or becomes unavailable due to legal disputes, the AI system can automatically generate a suitable alternative that maintains the desired style, mood, and continuity of the audio experience. This ensures that the overall narrative and aesthetic integrity of the content remains uncompromised, even in the face of licensing challenges or changes.

Moreover, this functionality enables on-demand generation of new audio content for specific subsets of the generated media. For instance, if a content creator wants to explore different musical directions for a particular scene or chapter, they can use the “alt-music” feature to generate multiple variations of the soundtrack that align with different artistic visions or target audiences. Similarly, if a specific character's voice needs to be modified or replaced due to actor availability or creative decisions, the AI can generate “alt-dialogue” that seamlessly integrates with the existing content while preserving the character's personality and narrative arc.

This dynamic audio generation capability is particularly valuable in scenarios involving time-limited licenses, endorsements, or collaborations. For example, if a celebrity voice actor provides dialogue for a character in an interactive narrative experience, but their contract or endorsement deal has a specific time horizon, the AI system can preemptively generate alternative dialogue options that can be used to replace the celebrity's voice once the contract expires. This allows for the smooth continuation of the content's distribution and monetization without disrupting the user experience or requiring extensive manual reworking of the audio elements.

The text-to-music capabilities can consider the cultural and historical context 706 mentioned in the input text to generate music that is authentic and respectful to the referenced traditions or eras. This includes understanding cultural references, musical styles, and instrumentation specific to certain regions or time periods. As an example, if the input text describes a “traditional Japanese tea ceremony,” the system can generate music that incorporates elements of traditional Japanese music, such as the use of the koto, shakuhachi, or taiko drums, and adheres to the principles of simplicity, tranquility, and harmony associated with the tea ceremony.

The text-to-music process can be iterative, allowing users to provide feedback and make adjustments to the generated music. The system can learn from user preferences and refine its output based on the feedback, creating a personalized and collaborative music generation experience. For example, after generating an initial musical composition based on the input text, the user can provide feedback such as “make it more upbeat” or “add more brass instruments.” The system can then modify the composition, accordingly, iterating until the user is satisfied with the result.

By incorporating text-to-music capabilities with temporal, spatial, contextual, and other characteristics, the AI-powered music registry and collaboration system 120 enables users to create musical compositions or elements that are tailored to their specific needs and preferences. This technology opens up new possibilities for creative expression, storytelling, and cross-modal collaboration, allowing users to translate their ideas and emotions into compelling musical experiences.

According to various embodiments, the system can provide suggestion of sounds, generation of backing tracks, and exploration of new sonic possibilities. These capabilities enable artists, producers, and composers to expand their creative horizons, discover new musical ideas, and streamline their production workflows. By leveraging advanced machine learning techniques and vast databases of musical knowledge, the system can offer intelligent suggestions, generate high-quality backing tracks, and help users explore novel sonic territories.

The system can analyze a user's musical preferences, genre interests, and current project context to suggest relevant and inspiring sounds, samples, or presets. By understanding the user's creative intent and the characteristics of their existing work, the system can recommend complementary or contrasting sounds that can elevate the production and spark new ideas. For instance, a film composer working on a tense action scene can input their current musical draft into the system. The system analyzes the composition's key, tempo, and emotional tone, and suggests a collection of percussive hits, atmospheric textures, and pulse-pounding basslines that can enhance the scene's intensity and momentum. The composer can audition these suggestions, tweaking and incorporating them into their work to create a more impactful and immersive soundtrack.

Furthermore, the system can generate high-quality backing tracks based on user-specified parameters such as genre, tempo, key, instrumentation, and mood. By leveraging deep learning models trained on vast datasets of musical compositions and performances, the system can create coherent, structured, and emotionally resonant backing tracks that serve as a solid foundation for the user's creative vision. As an example, a singer-songwriter has a melody and lyric idea but struggles to come up with an accompanying instrumental arrangement. They input their vocal recording and specify the desired genre (e.g., folk-pop), tempo, and emotional tone (e.g., introspective and melancholic). The system generates a backing track featuring fingerpicked acoustic guitar, gentle piano chords, and subtle string swells that perfectly complement the vocalist's delivery and lyrical themes. The artist can then refine and build upon this generated backing track to create a fully realized song or soundtrack.

The system can help users explore new sonic possibilities by suggesting unconventional combinations of sounds, processing techniques, or musical styles. By analyzing the user's existing work and creative preferences, the system can propose experimental ideas that push the boundaries of their comfort zone and encourage them to discover novel and exciting musical directions. For example, an electronic music producer typically works within the confines of the techno genre, characterized by repetitive four-on-the-floor beats and industrial textures. The system analyzes their production style and suggests exploring the integration of organic, world music elements, such as African percussion samples, Middle Eastern string instruments, or South Asian vocal chants. The producer can experiment with these suggestions, blending them with their trademark techno sound to create a fresh and innovative fusion that sets them apart from other artists in the genre.

The system may offer intelligent audio processing and mixing suggestions based on the analysis of the user's project and the characteristics of the individual tracks. By understanding the spectral balance, dynamics, and spatial positioning of each element in the mix, the system can recommend equalization (EQ), compression, reverb, and other processing settings that enhance the clarity, cohesion, and emotional impact of the overall production. As an example, consider a mixing engineer is working on a dense rock track with multiple layers of guitars, bass, drums, and vocals. The system analyzes the frequency content and dynamics of each track and suggests EQ cuts and boosts to prevent masking and ensure each element has its own space in the mix. It also recommends compressor settings to control the dynamics and create a punchy, energetic sound. The engineer can use these suggestions as a starting point, fine-tuning them to taste and creating a polished, professional-sounding mix. The same principles can be applied to multimedia content with optional combinations of video elements, cinematography, coloration, mix dynamics, music, sound effects and then create A/B type testing elements for engagement. This can also enable different “versioning” of content for different commercial audiences, like different voice or actor for moviegoers in cinema vs those streaming a particular piece of content at home. It can also support product placement and name-image-likeness rights management more efficiently since it enables content owners to “swap” specific elements. For example consider a new CBS hit series where the main character drives a GMC Sierra pickup truck. CBS could use this system to replace this singular content element across all the existing and future work with a Ford F150.

The system can inspire users to explore new creative possibilities by suggesting remix ideas or reinterpretations of their existing works. By analyzing the structure, harmony, and rhythmic elements of a user's composition, the system can propose alternative arrangements, instrument substitutions, or stylistic shifts that give the piece a fresh perspective and open up new avenues for experimentation. A classical pianist, for example, has recorded a solo piano piece in the style of Chopin. The system analyzes the composition and suggests a jazz-inspired reinterpretation, complete with a walking bassline, swung rhythms, and extended harmonies. The pianist can use this suggestion as a creative prompt, adapting their playing style and improvising over the proposed changes to create a unique and captivating jazz rendition of their original piece.

By offering intelligent sound suggestions, generating high-quality backing tracks, and facilitating sonic exploration and experimentation, the AI-powered music registry and collaboration system 120 enables artists, producers, and composers to expand their creative possibilities and push the boundaries of their musical expression. These features streamline the production process, inspire new ideas, and ultimately lead to more innovative, diverse, and emotionally resonant musical works.

According to some embodiments, the AI-powered music registry and collaboration system may be configured for re-computing, arranging, composing, sampling, and reinterpretation of works for different timescales and distribution mechanisms. These features allow artists, producers, and composers to adapt their musical works to various contexts, platforms, and audience preferences, maximizing the impact and reach of their creations. By leveraging advanced algorithms and machine learning techniques, the system can automate and streamline the process of transforming musical content to suit different temporal, spatial, and distribution requirements.

The system may automatically adjust the duration and pacing of a musical work to fit different timescales and contexts. This is particularly useful for adapting music to various media formats, such as advertisements, social media content, or video game soundtracks, where the music needs to conform to specific time constraints or narrative structures. For example, a composer has created a 3-minute cinematic orchestral piece for a film trailer. The system can analyze the composition's structure, identifying key moments, transitions, and emotional peaks. It can then generate multiple versions of the piece, such as a 30-second edit for a TV spot, a 15-second version for an Instagram ad, or a 60-second loop for a menu screen in a video game. The system ensures that each version maintains the essence and impact of the original composition while adapting it to the specific timescale requirements.

The system may recompute and adapt musical works for different spatial audio formats and immersive experiences, such as surround sound, binaural audio, or virtual reality environments. By analyzing the spatial characteristics of the original mix and the target format's specifications, the system can intelligently redistribute and optimize the audio elements to create a compelling and immersive listening experience. As an example, a producer has created a stereo mix of a pop song for regular headphone listening. The system can analyze the mix and generate a binaural version optimized for spatial audio platforms like Google Resonance or Facebook 360. It can place the individual instruments, vocals, and effects in a virtual 3D space, creating a sense of depth, directionality, and immersion that enhances the emotional impact of the song. The system can also adapt the mix for a 5.1 surround sound system, placing the elements in the appropriate channels to create a cinematic and enveloping listening experience.

According to some implementations, the system may reinterpret a musical work in different styles or genres, allowing artists to explore new creative directions and reach diverse audiences. By analyzing the harmonic, melodic, and rhythmic elements of the original composition and the characteristics of the target style or genre, the system can generate new versions that maintain the essence of the original while infusing it with the flavors and conventions of the chosen style. For instance, an electronic dance music (EDM) artist has created a high-energy, synth-driven track in the style of big room house. The system can analyze the track's structure, melody, and chord progression and generate reinterpretations in various styles, such as a laid-back tropical house version, a funky disco-inspired remix, or a stripped-down acoustic ballad. These reinterpretations can help the artist reach new audiences, showcase their versatility, and open up opportunities for cross-genre collaborations and remixes.

The system can facilitate the creation of new works by suggesting and integrating relevant samples, loops, and remixes from its vast library of musical content. By analyzing the characteristics of the user's project and the musical elements in the library, the system can recommend samples that complement or enhance the original composition, sparking new creative ideas and enabling the creation of rich, layered, and diverse musical works. For example, a hip-hop producer is working on a new track and looking for a catchy vocal hook to complement their beats. The system analyzes the track's tempo, key, and style, and suggests a range of vocal samples from its library that match these characteristics. The producer can audition these samples, chopping, pitching, and arranging them to create a memorable and infectious hook that elevates the track. The system can also suggest drum breaks, instrumental loops, or sound effects that add texture, depth, and variety to the production.

According to an embodiment, the system may generate adaptive and interactive musical content for video games, virtual reality experiences, or other interactive media. By analyzing the structure and elements of a composer's work and the requirements of the interactive environment, the system can create dynamic music that responds to user actions, game states, or narrative events in real-time. For instance, a video game composer has created a main theme for an open-world adventure game. The system can analyze the theme's structure, motifs, and emotional arc, and generate adaptive variations that match the game's different environments, player actions, and story beats. It can create a peaceful, ambient version of the theme for exploration, an uplifting and heroic variation for moments of triumph, or a tense and dissonant rendition for combat sequences. The system ensures that the music seamlessly transitions between these variations based on the player's actions and the game's narrative flow, creating an immersive and emotionally engaging gaming experience.

By enabling the re-computing, arranging, composing, sampling, and reinterpretation of works for different timescales and distribution mechanisms, the AI-powered music registry and collaboration system 120 enables artists, producers, and composers to adapt their creations to a wide range of contexts and platforms. These capabilities help maximize the impact, reach, and value of musical works, opening up new creative possibilities and engaging diverse audiences across multiple mediums and distribution channels.

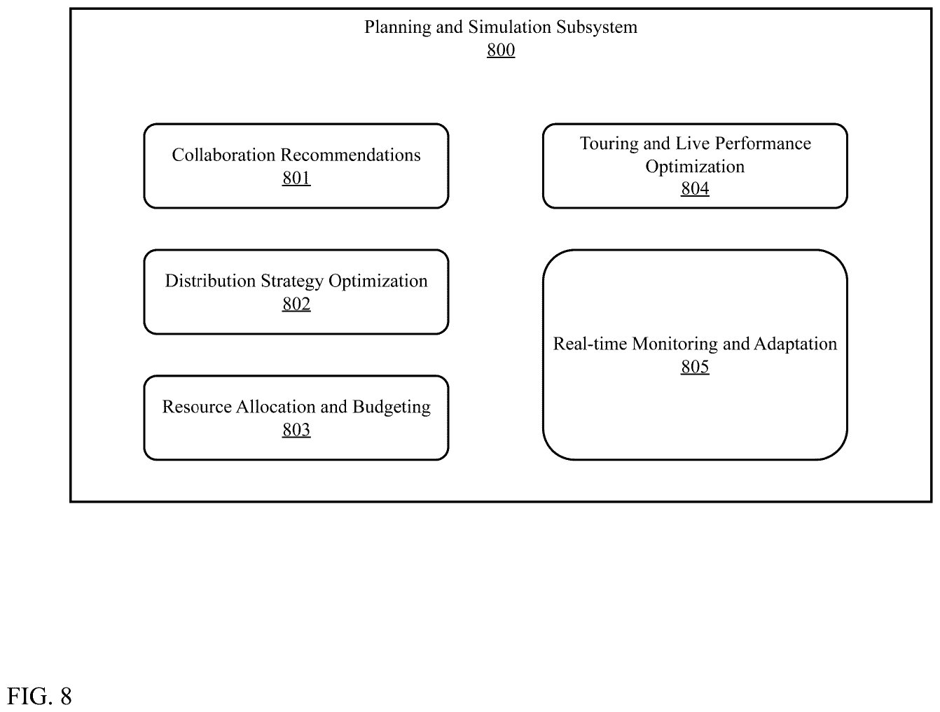

FIG. 8 is a block diagram illustrating an aspect of an artificial intelligence-powered music registry, collaboration, and workflow management system, a planning and simulation subsystem 800. According to the aspect, planning and simulation subsystem 800 integrates with planning and simulation tools to help artists and producers make informed decisions about collaborations, distribution strategies, and marketing efforts. By analyzing market trends, audience preferences, and competitor performance, the system can provide data-driven recommendations to optimize resource allocation and maximize the success of a musical project. According to the aspect, text-to-music subsystem 800 comprises a collaboration recommendation component 801, a distribution strategy optimization component 802, a resource allocation and budgeting component 803, a touring and live performance optimization component 804, and a real-time monitoring and adaptation component 805.

According to the aspect, the system can analyze the musical styles, influences, and historical collaborations of artists to recommend potential collaborations that are likely to yield successful and innovative results. By considering factors such as genre compatibility, audience overlap, and creative synergy, the system can suggest collaborations that have a high likelihood of resonating with fans and creating a significant impact. For example, if an electronic music producer is looking for a vocalist to collaborate with, the system can analyze their musical style and recommend vocalists who have previously collaborated with similar producers or whose vocal style complements the producer's sound. The system can also consider the popularity and audience demographics of the potential collaborators to ensure maximum reach and engagement.

The system can optimize the distribution strategy 802 for a musical project by analyzing market trends, audience preferences, and historical performance data. By simulating different distribution scenarios and predicting their outcomes, the system can recommend the most effective combination of platforms, release timings, and promotional activities to maximize the project's reach and revenue potential. When planning the release of a new album, for example, the system can analyze data from previous releases in the same genre or by similar artists to determine the optimal release date, pricing strategy, and distribution channels. The system can also simulate different marketing and promotional scenarios to identify the most cost-effective and impactful activities, such as social media campaigns, music videos, or live performances.

The system can help optimize resource allocation and budgeting 803 decisions for musical projects by analyzing historical data and predicting the expected return on investment (ROI) for different options. By considering factors such as production costs, marketing expenses, and potential revenue streams, the system can recommend the most efficient and effective allocation of resources to maximize the project's profitability and success. As an example, when planning a music video production, the system can analyze data from previous music videos in the same genre or by similar artists to estimate the expected viewership, engagement, and revenue generation. The system can then recommend the optimal budget allocation for different aspects of the production, such as location, casting, visual effects, and promotion, to ensure the best possible ROI.

The system may optimize touring and live performance 804 decisions by analyzing audience demand, venue characteristics, and historical ticket sales data. By simulating different touring scenarios and predicting their financial and logistical outcomes, the system can recommend the most effective routing, venue selection, and ticket pricing strategies to maximize attendance, revenue, and artist satisfaction. For example, when planning a concert tour, the system can analyze data from previous tours by the artist or similar acts to identify the most promising markets, venues, and time periods. The system can also simulate different ticket pricing and promotion strategies to optimize revenue and attendance, while considering factors such as travel costs, production expenses, and artist preferences.

According to the aspect, the system can provide real-time monitoring and adaptive recommendations 805 throughout the lifecycle of a musical project. By continuously analyzing data on audience engagement, sales performance, and market trends, the system can identify opportunities for optimization and suggest adjustments to the project's strategy in real-time. For example, during the first week of an album's release, the system can monitor streaming numbers, social media engagement, and fan feedback to identify which tracks are resonating the most with listeners. Based on this data, the system can recommend adjustments to the promotional strategy, such as focusing on certain tracks or platforms, to capitalize on the album's early success and momentum.

By integrating planning, optimization routines, and simulation modeling into the AI-powered music registry and collaboration system 120, users can make data-driven decisions that maximize the creative, commercial, and operational success of their musical projects. These capabilities empower artists, managers, and labels to navigate the complex and dynamic landscape of the music industry with greater confidence, efficiency, and agility, ultimately fostering a more sustainable and thriving music ecosystem.

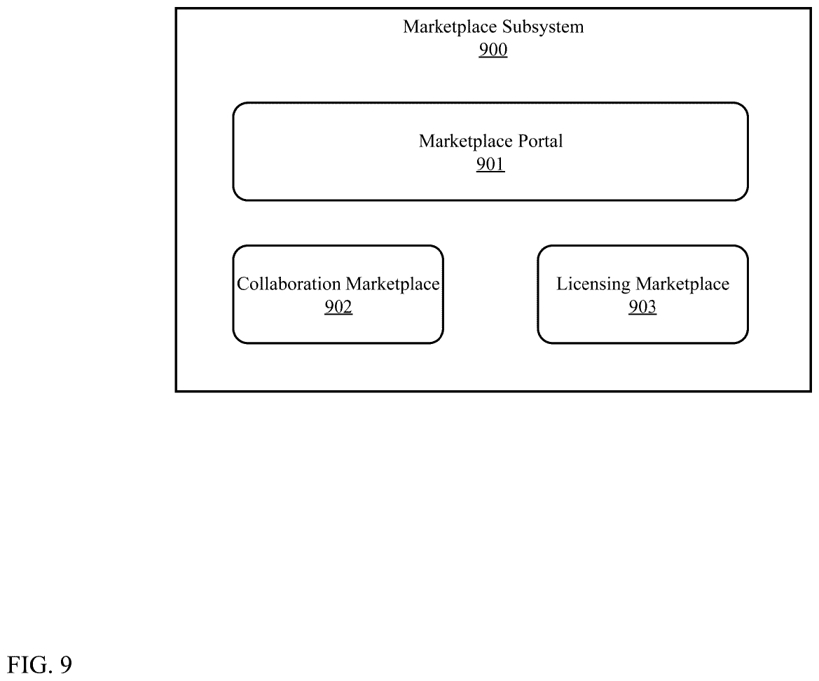

FIG. 9 is a block diagram illustrating an aspect of an artificial intelligence-powered music registry, collaboration, and workflow management system, a marketplace subsystem 900. According to the aspect, the marketplace subsystem facilitates the efficient and transparent exchange of creative assets and services between artists, producers, and rights holders. Artists can bid on collaboration opportunities or the rights to remix existing works. This platform facilitates creative partnerships and allows emerging artists to gain exposure by working with established names in the industry. The marketplace also provides a transparent and efficient way to manage the legal and financial aspects of collaborations and remixes. According to the aspect, marketplace subsystem 900 comprises marketplace portal 901, a collaboration marketplace 902, and a licensing marketplace 903.

According to the aspect, a marketplace portal 901 is present and configured to provide a user interface where system users can browse marketplace offerings, upload content to the marketplace, and engage in marketplace transactions.

According to the aspect, the collaboration marketplace 902 allows artists to post their projects or creative needs and invite other artists, producers, or musicians to submit their proposals or bids for collaboration. This can include requests for specific instrumentals, vocals, lyrics, or production services. Artists can specify their budget, timeline, and creative requirements, while potential collaborators can showcase their skills, portfolio, and previous work to attract interest. For example, a hip-hop artist looking for a featured verse on their new track can post a request on the collaboration marketplace, specifying the desired style, theme, and budget. Interested rappers can then submit their proposals, including a sample verse and their creative vision for the collaboration. The artist can review the proposals, negotiate terms, and select the most suitable collaborator for the project.

According to the aspect, the remix licensing marketplace 903 enables artists and rights holders to make their original works available for remixing, sampling, or adaptation by other creators. Artists can specify the terms and conditions under which their work can be licensed, including the permitted uses, royalty rates, and any creative restrictions. Interested remixers or producers can then browse the available works, negotiate the licensing terms, and secure the necessary permissions to create derivative works. For instance, an electronic music producer wants to create a remix of a popular indie rock song. They can search the remix licensing marketplace for the original song, review the licensing terms set by the rights holder, and submit a request to secure the necessary permissions. Once the license is granted, the producer can create their remix, knowing that they have the legal right to use the original work and that the rights holder will be fairly compensated.

The system can facilitate the clearance and licensing of samples used in musical works by connecting artists with the original rights holders and automating the negotiation and payment processes. Artists can identify the samples they want to use, and the system can automatically contact the relevant rights holders, present the proposed terms of use, and handle the licensing transactions securely and efficiently. As an example, a producer wants to use a sample from a classic soul record in their new track. They can use the system to identify the original rights holders, propose the terms of use (e.g., duration, context, and royalty rate), and initiate the licensing process. The system can automate the negotiation, contract generation, and payment, ensuring that all parties are fairly compensated and that the use of the sample is legally compliant.

In some embodiments, the marketplaces can integrate with the system's rights management and revenue sharing capabilities to ensure that all collaborators and rights holders are fairly compensated for their contributions. The system can automatically track the usage and revenue generated by collaborative works, remixes, or licensed samples, and distribute the earnings according to the agreed-upon terms and royalty splits. For example, consider a collaborative track featuring multiple artists is released and generates revenue through streaming, downloads, and sync placements. The system can automatically track the revenue sources, calculate the royalty splits based on the agreed-upon terms, and distribute the earnings to each collaborator's account, providing transparency and fairness in the revenue sharing process.

The marketplaces may incorporate reputation and feedback systems to help artists and rights holders make informed decisions about potential collaborators or licensees. Participants can rate and review their experiences working with others, providing valuable insights into their professionalism, creativity, and reliability. This information can help build trust and foster long-term collaborative relationships within the creative community. For instance, an artist receives multiple collaboration proposals for a project and wants to select the most reliable and skilled collaborator. They can review the feedback and ratings provided by previous collaborators, assess the quality of their work samples, and make an informed decision based on the collective experiences of the creative community.

By incorporating bid-type and licensing marketplaces into the AI-powered music registry and collaboration system 120, artists and rights holders can unlock new creative and commercial opportunities, while ensuring that all parties are fairly compensated and recognized for their contributions. These marketplaces foster a more open, efficient, and equitable music ecosystem, where creativity can flourish, and collaborations can thrive.

FIG. 10 is a block diagram illustrating an exemplary aspect of an embodiment of a distributed computational graph computing system utilizing an advanced cyber decision platform (ACDP) for external network reconnaissance and contextual data collection. Client access to the system 1005 for specific data entry, system control and for interaction with system output such as automated predictive decision making and planning and alternate pathway simulations, occurs through the system's distributed, extensible high bandwidth cloud interface 1010 which uses a versatile, robust web application driven interface for both input and display of client-facing information via network 1007 and operates a data store 1012 such as, but not limited to MONGODB™, COUCHDB™, CASSANDRA™ or REDIS™ according to various arrangements. Much of the enterprise knowledge/context data analyzed by the system both from sources within the confines of the enterprise business, and from cloud based sources, also enter the system through the cloud interface 1010, data being passed to the connector module 1035 which may possess the API routines 1035a needed to accept and convert the external data and then pass the normalized information to other analysis and transformation components of the system, the directed computational graph module 1055, high volume web crawler module 1015, multidimensional time series database (MDTSDB) 1020 and the graph stack service 1045. The directed computational graph module 1055 retrieves one or more streams of data from a plurality of sources, which includes, but is in no way not limited to, enterprise knowledge, RAGs, expert judgment/scores, a plurality of physical sensors, network service providers, web based questionnaires and surveys, monitoring of electronic infrastructure, crowdsourcing campaigns, and human input device information. Within the directed computational graph module 1055, data may be split into two identical streams in a specialized pre-programmed data pipeline 1055a, wherein one sub-stream may be sent for batch processing and storage while the other sub-stream may be reformatted for transformation pipeline analysis. The data is then transferred to the general transformer service module 1060 for linear data transformation as part of analysis or the decomposable transformer service module 1050 for branching or iterative transformations that are part of analysis. The directed computational graph module 1055 can represent all data as directed graphs where the transformations are nodes and the result messages between transformations edges of the graph. The high volume web crawling module 1015 uses multiple server hosted preprogrammed web spiders, which while autonomously configured are deployed within a web scraping framework 1015a of which SCRAPY™ is an example, to identify and retrieve data of interest from web based sources that are not well tagged by conventional web crawling technology. Data persistence stores such as the multiple dimension time series data store module 1020 may receive streaming data from a large plurality of sensors that may be of several different types. The multiple dimension time series data store module may also store any time series data encountered by the system such as but not limited to enterprise network usage data, component and system logs, environmental context, edge device state information, performance data, network service information captures such as, but not limited to news and financial feeds, and sales and service related customer data. The module is designed to accommodate irregular and high volume surges by dynamically allocating network bandwidth and server processing channels to process the incoming data. Inclusion of programming wrappers 1020a for languages examples of which are, but not limited to C++, PERL, PYTHON, Rust, GoLang, and ERLANG™ allows sophisticated programming logic to be added to the default function of the multidimensional time series database 1020 without intimate knowledge of the core programming, greatly extending breadth of function. Data retrieved by various data stores such as SQL, graph, key-value, or the multidimensional time series database (MDTSDB) 1020 and the high volume web crawling module 1015 may be further analyzed and transformed into task optimized results by the directed computational graph 1055 and associated general transformer service 1050 and decomposable transformer service 1060 modules. Alternately, data from the multidimensional time series database and high volume web crawling modules may be sent, often with scripted cuing information determining important vertexes 1045a, to the graph stack service module 1045 which, employing standardized protocols for converting streams of information into graph representations of that data, for example, open graph internet technology although the invention is not reliant on any one standard. Through the steps, the graph stack service module 1045 represents data in graphical form influenced by any predetermined scripted modifications 1045a and stores it in a graph-based data store 1045b such as Neptunre or GIRAPH™ or a key value pair type data store REDIS™, or RIAK™, among others, all of which are suitable for storing graph-based information.

Results of the transformative analysis process may then be combined with further client directives, and additional business rules and practices relevant to the analysis and situational information external to the already available data in the automated planning service module 1030 which also runs powerful information theory 1030a based predictive statistics functions and machine learning algorithms to allow future trends and outcomes to be rapidly forecast based upon the current system derived results and choosing each a plurality of possible business decisions. Using all available data, the automated planning service module 1030 may propose business decisions most likely to result is the most favorable business outcome with a usably high level of certainty. Closely related to the automated planning service module in the use of system derived results in conjunction with possible externally supplied additional information (i.e., context) in the assistance of end user business decision making, the action outcome simulation module 1025 with its discrete event simulator programming module 1025a coupled with the end user facing observation and state estimation service 1040 which is highly scriptable 1040b as circumstances require and has a game engine 1040a to more realistically stage possible outcomes of business decisions under consideration, allows business decision makers to investigate the probable outcomes of choosing one pending course of action over another based upon analysis of the current available data.

FIG. 11 is a block diagram illustrating another exemplary aspect of an embodiment 1100 of a distributed computational graph computing system utilizing an advanced cyber decision platform. According to the aspect the integrated platform 1100, is very well suited to perform advanced predictive analytics and predictive simulations to produce investment predictions. Much of the trading specific programming functions are added to the automated planning service module 1030 of the modified advanced cyber decision platform 1100 to specialize it to perform trading analytics. Specialized purpose libraries may include but are not limited to financial markets functions libraries 1151, Monte-Carlo risk routines 1152, numeric analysis libraries 1153, deep learning libraries 1154, contract manipulation functions 1155, money handling functions 1156, Monte-Carlo search libraries 1157, and quant approach securities routines 1158. Pre-existing deep learning routines including information theory statistics engine 1159 may also be used. The invention may also make use of other libraries and capabilities that are known to those skilled in the art as instrumental in the regulated trade of items of worth. Data from a plurality of sources used in trade analysis are retrieved, much of it from remote, cloud resident 1101 servers through the system's distributed, extensible high bandwidth cloud interface 110 using the system's connector module 135 which is specifically designed to accept data from a number of information services both public and private through interfaces to those service's applications using its messaging service 135a routines, due to ease of programming, are augmented with interactive broker functions 1135, market data source plugins 1136, e-commerce messaging interpreters 1137, business-practice aware email reader 1138 and programming libraries to extract information from video data sources 1139.

Other modules that make up the advanced cyber decision platform may also perform significant analytical transformations on trade related data. These may include the multidimensional time series data store 1020 with its robust scripting features which may include a distributive friendly, fault-tolerant, real-time, continuous run prioritizing, programming platform such as, but not limited to Erlang/OTP 1121 and a compatible but comprehensive and proven library of math functions of which the C++ math libraries are an example 1122, data formalization and ability to capture time series data including irregularly transmitted, burst data; the GraphStack service 145 which transforms data into graphical representations for relational analysis and may use packages for graph format data storage such as Titan 1145 or the like and a highly interface accessible programming interface an example of which may be Akka/Spray, although other, similar, combinations may equally serve the same purpose in this role 1146 to facilitate optimal data handling; the directed computational graph module 155 and its distributed data pipeline 155a supplying related general transformer service module 160 and decomposable transformer module 150 which may efficiently carry out linear, branched, and recursive transformation pipelines during trading data analysis may be programmed with multiple trade related functions involved in predictive analytics of the received trade data. Both possibly during and following predictive analyses carried out by the system, results must be presented to clients 1005 in formats best suited to convey both important results for analysts to make highly informed decisions and, when needed, interim or final data in summary and potentially raw for direct human analysis. Simulations which may use data from a plurality of field spanning sources to predict future trade conditions these are accomplished within the action outcome simulation module 1025. Data and simulation formatting may be completed or performed by the observation and state estimation service 1040 using its ease of scripting and gaming engine to produce optimal presentation results.

In cases where there are both large amounts of data to be ingested, schematized, normalized, semantified or otherwise cleansed, enriched or formalized and then intricate transformations such as those that may be associated with deep machine learning, predictive analytics and predictive simulations, distribution of computer resources to a plurality of systems may be routinely required to accomplish these tasks due to the volume of data being handled and acted upon. The advanced cyber decision platform employs a distributed architecture that is highly extensible to meet these needs. A number of the tasks carried out by the system are extremely processor intensive and for these, the highly integrated process of hardware clustering of systems, possibly of a specific hardware architecture particularly suited to the calculations inherent in the task, is desirable, if not required for timely completion. The system includes a computational clustering module 1180 to allow the configuration and management of such clusters during application of the advanced cyber decision platform. While the computational clustering module is drawn directly connected to specific co-modules of the advanced cyber decision platform these connections, while logical, are for ease of illustration and those skilled in the art will realize that the functions attributed to specific modules of an embodiment may require clustered computing under one use case and not under others. Similarly, the functions designated to a clustered configuration may be role, if not run, dictated. Further, not all use cases or data runs may use clustering.

### Detailed Description of Exemplary Aspects

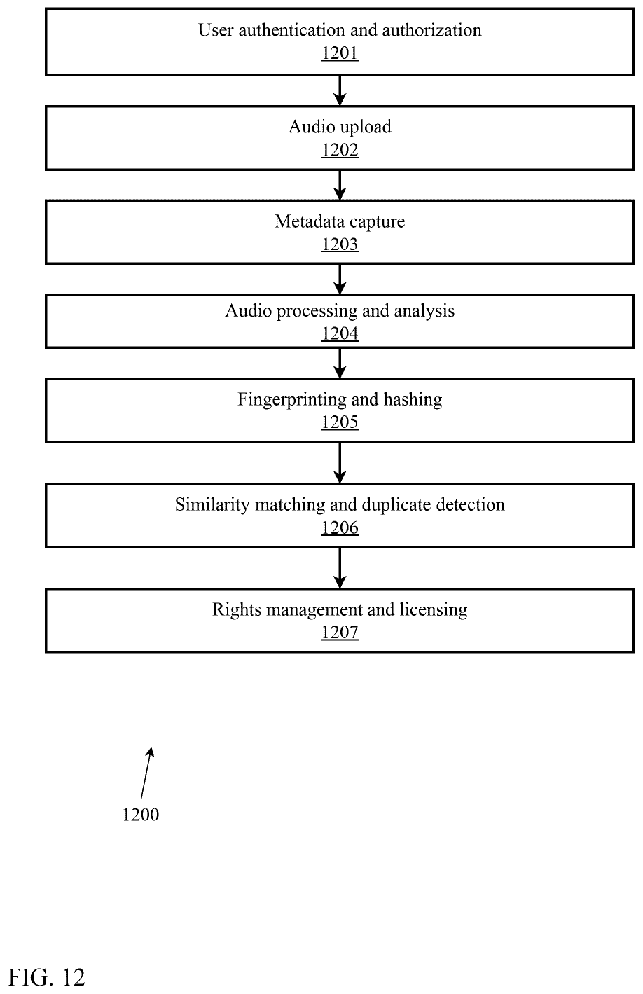

FIG. 12 is a flow diagram illustrating an exemplary workflow 1200 when a user uploads a musical piece to the music registry and collaboration system, according to an embodiment. According to the embodiment, the process starts at step 1201 with user authentication and authorization. The user logs into the system using their credentials (e.g., username and password) or through a third-party authentication provider (e.g., Google, Facebook). The system verifies the user's identity and permissions to ensure they have the necessary rights to upload and manage musical content. At step 1202 the user uploads their audio data. The user selects the audio file they want to upload to the system. The file can be in various formats such as MP3, WAV, or AIFF. The system validates the audio file to ensure it meets the required quality standards and file format specifications. If the file is valid, the system initiates the upload process and stores the audio file in a secure and scalable storage system, such as, for example, Amazon S3 or Google Cloud Storage.

At step 1203 the system captures metadata associated with the uploaded audio data. During the upload process, the user may be prompted to provide metadata associated with the musical piece, such as the title, artist name, album, genre, release year, and any additional tags or descriptions. In some implementations, the system may be configured to scan the Internet for available metadata. The system may also automatically extract metadata from the audio file, such as ID3 tags or embedded information. The user can review and edit the metadata to ensure accuracy and completeness. At step 1204, once the audio file is uploaded, the system initiates a series of audio processing and analysis tasks. This may include tasks such as audio normalization, trimming, format conversion, and feature extraction. The system may also apply machine learning algorithms to analyze the audio content, such as genre classification, mood detection, or instrument recognition.

At step 1205 the system generates a unique audio fingerprint for the uploaded musical piece using algorithms like Shazam's fingerprinting or Chromaprint. The fingerprint is then hashed using a secure cryptographic hash function, such as SHA-256, to create a compact and unique identifier for the audio content. The hashed fingerprint is stored in the system's database along with the associated metadata. At step 1206 the system performs similarity matching and duplicate detection. The system can compare the hashed fingerprint of the newly uploaded musical piece against the existing database of fingerprints. It uses similarity matching algorithms, such as locality-sensitive hashing (LSH) or nearest neighbor search, to identify any potential duplicates or highly similar pieces. If a duplicate or similar piece is found, the system may prompt the user to confirm the upload and/or provide additional information to differentiate the new piece from existing ones.

As a last step 1207, the system performs actions directed to rights management and licensing. The user specifies the rights and licensing information associated with the uploaded musical piece. This may include details such as copyright ownership, distribution permissions, and any applicable licenses or restrictions. The system stores this information securely and associates it with the specific musical piece.

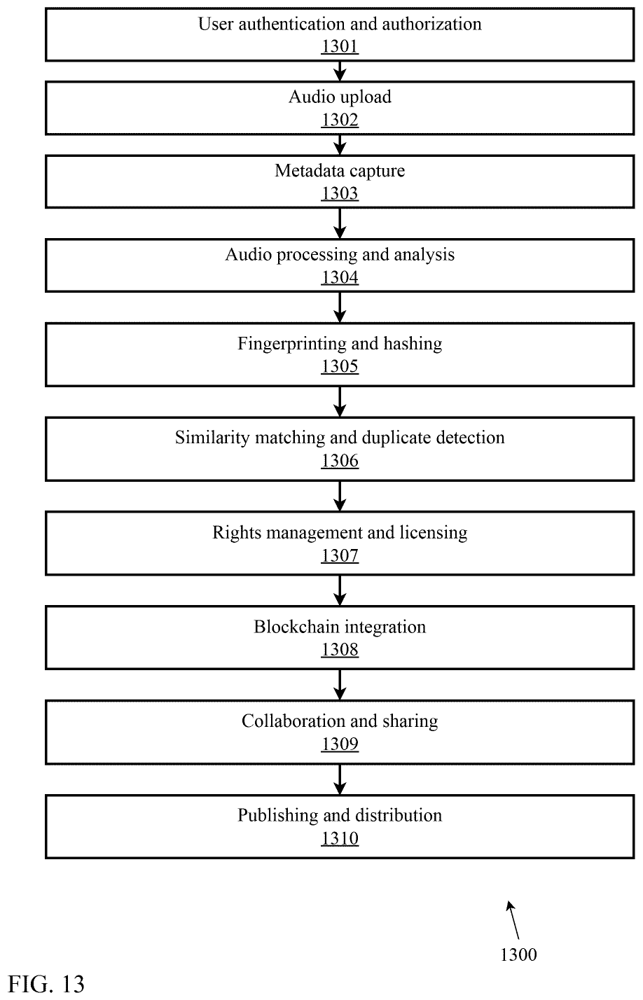

FIG. 13 is a flow diagram illustrating another exemplary workflow 1300 when a user uploads a musical piece to the music registry and collaboration system, according to an embodiment. This general workflow provides an overview of the key steps involved when a user uploads a musical piece to the music registry and collaboration system. The specific implementation details and additional features may vary depending on the system's architecture, design choices, and business requirements.

According to the embodiment, the process starts at step 1301 with user authentication and authorization. The user logs into the system using their credentials (e.g., username and password) or through a third-party authentication provider (e.g., Google, Facebook). The system verifies the user's identity and permissions to ensure they have the necessary rights to upload and manage musical content. At step 1302 the user uploads their audio data. The user selects the audio file they want to upload to the system. The file can be in various formats such as MP3, WAV, or AIFF. The system validates the audio file to ensure it meets the required quality standards and file format specifications. If the file is valid, the system initiates the upload process and stores the audio file in a secure and scalable storage system, such as, for example, Amazon S3 or Google Cloud Storage.

At step 1303 the system captures metadata associated with the uploaded audio data. During the upload process, the user may be prompted to provide metadata associated with the musical piece, such as the title, artist name, album, genre, release year, and any additional tags or descriptions. In some implementations, the system may be configured to scan the Internet for available metadata. The system may also automatically extract metadata from the audio file, such as ID3 tags or embedded information. The user can review and edit the metadata to ensure accuracy and completeness. At step 1304, once the audio file is uploaded, the system initiates a series of audio processing and analysis tasks. This may include tasks such as audio normalization, trimming, format conversion, and feature extraction. The system may also apply machine learning algorithms to analyze the audio content, such as genre classification, mood detection, or instrument recognition.

At step 1305 the system generates a unique audio fingerprint for the uploaded musical piece using algorithms like Shazam's fingerprinting or Chromaprint. The fingerprint is then hashed using a secure cryptographic hash function, such as SHA-256, to create a compact and unique identifier for the audio content. The hashed fingerprint is stored in the system's database along with the associated metadata. At step 1306 the system performs similarity matching and duplicate detection. The system can compare the hashed fingerprint of the newly uploaded musical piece against the existing database of fingerprints. It uses similarity matching algorithms, such as locality-sensitive hashing (LSH) or nearest neighbor search, to identify any potential duplicates or highly similar pieces. If a duplicate or similar piece is found, the system may prompt the user to confirm the upload and/or provide additional information to differentiate the new piece from existing ones.

At step 1307, the system performs actions directed to rights management and licensing. The user specifies the rights and licensing information associated with the uploaded musical piece. This may include details such as copyright ownership, distribution permissions, and any applicable licenses or restrictions. The system stores this information securely and associates it with the specific musical piece. At step 1308 the system integrates with a blockchain network, such as Ethereum or Hyperledger, to record the metadata, rights information, and hashed fingerprint of the uploaded musical piece. The blockchain provides an immutable and transparent ledger for tracking the ownership, provenance, and licensing history of the musical piece.

If the user chooses to enable collaboration or sharing features, the system allows them to invite other users to contribute to or access the uploaded musical piece at step 1309. Collaborators can be assigned specific roles and permissions, such as the ability to edit metadata, provide feedback, or remix the piece. The system can track and record all collaborative activities and modifications made to the musical piece. Once the musical piece is uploaded, processed, and all necessary information is captured, the user can choose to publish and distribute the piece through the system's platform or integrated distribution channels at step 1310. The system may offer options for monetization, such as setting a price for downloads or enabling streaming through partner platforms. The system ensures that the published piece adheres to the specified rights and licensing terms and tracks usage and revenue data for reporting and royalty distribution.

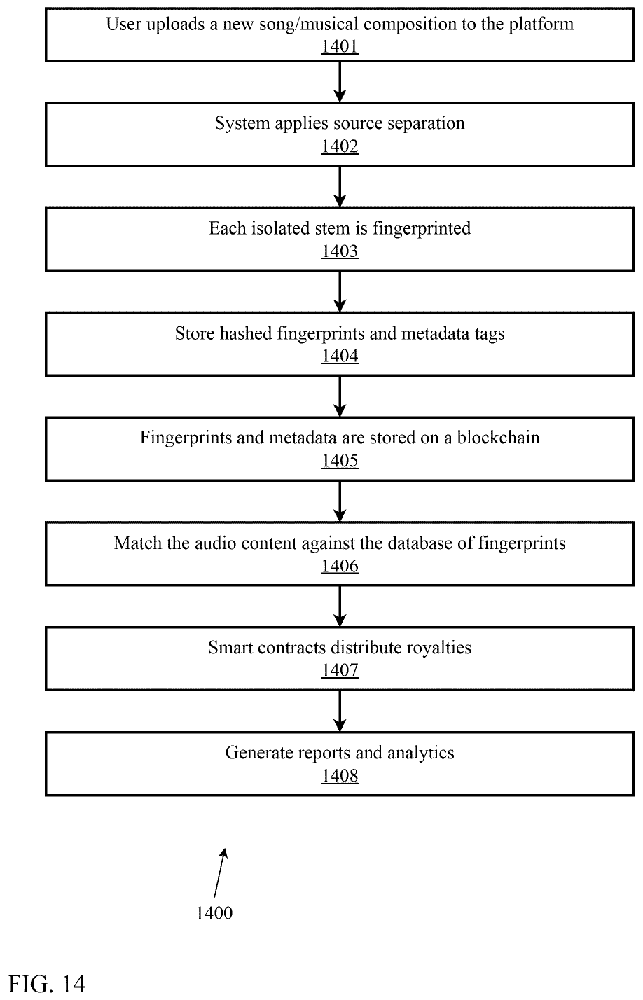

FIG. 14 is a flow diagram illustrating an exemplary method 1400 for segmenting and hashing instruments, vocals, and other elements of a music composition to enhance crediting and royalty distribution, according to an embodiment. At step 1401 a user (e.g., producer, song writer, etc.) uploads a new song or musical composition to the platform. At step 1402 the system applies source separation (e.g., via specific methods like Deep Extractor, Spleeter) to isolate the vocals, drums, bass, and guitar stems or other instruments or vocals. At step 1403 each isolated stem is fingerprinted using an algorithm (e.g., Shazam's algorithm) and hashed using a secure cryptographic hashing algorithm, for example SHA-256. The hashed fingerprints are stored in a database, along with metadata tags indicating, for example, the instrument type, performer name, and time range within the song at step 1404. At step 1405 the metadata and fingerprints may also be recorded on a blockchain network for immutable and transparent tracking of ownership and licensing information.

When a song is streamed or downloaded, the system can match the audio content against the database of fingerprints to identify the usage of each segmented component at step 1406. At step 1407 the blockchain smart contracts automatically distribute the royalties to the respective contributors based on the predefined splits and licensing terms. As a last step 1408 the system generates reports and analytics showing the popularity and usage metrics for each musical element, providing valuable insights to the rights holders. Any blockchain use is optional and not required for the system to function as intended.

By implementing these processes for segmenting and hashing instruments, vocals, and other elements of a music composition, the AI-powered music registry and collaboration platform can enable more granular and accurate crediting and royalty distribution. This empowers musicians, producers, and rights holders to have greater control over their creative contributions and ensures fair compensation for their work.

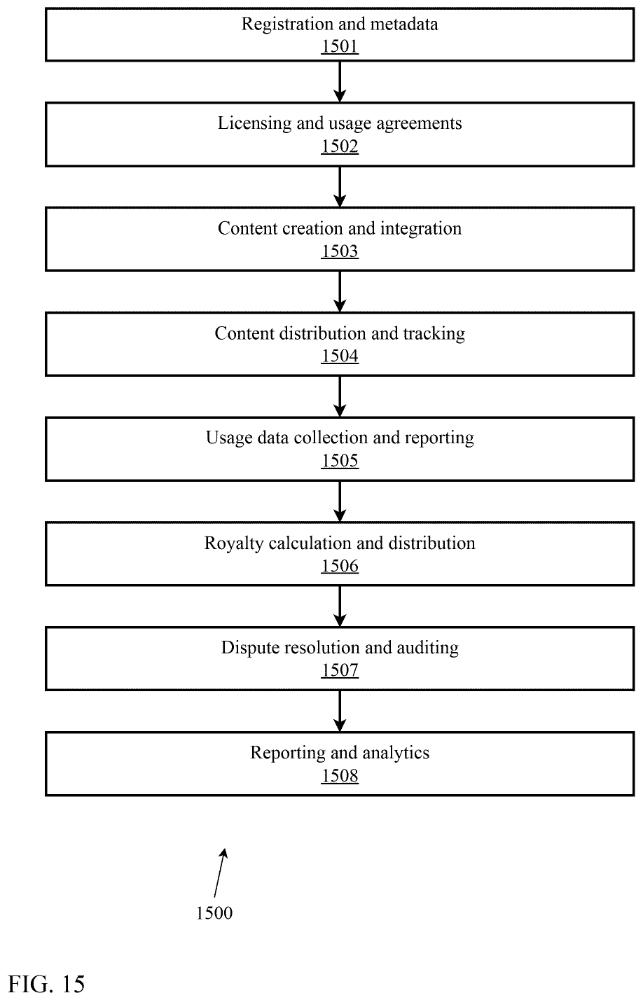

FIG. 15 is a flow diagram illustrating an exemplary method 1500 for tracking musical component usage and distributing royalties based on licensing and/or usage agreements, according to an embodiment. According to the embodiment, the process begins at step 1501 when rights holders (e.g., artists, producers, publishers, etc.) register their musical components (e.g., songs, stems, samples, etc.) in the system 120. They can provide detailed metadata for each component, including title, creator(s), ownership splits, and licensing terms. The system may assign a unique identifier to each registered component. At step 1502 licensees (e.g., music services, content creators) browse and discover musical components in the system. The licensees can negotiate and enter into licensing agreements with the rights holders for the usage of specific components. The licensing agreements specify the terms of use, such as duration, territory, media, and royalty rates. The system records these agreements and associates them with the respective musical components.

At step 1503, licensees integrate the licensed content components into their content (e.g., songs, videos, advertisements, product placements, etc.). They provide the system with information about the content, including the usage of the licensed components. The system tracks the usage of each component within the content. At step 1504, the content containing the licensed musical components is distributed through various channels (e.g., streaming platforms 113, social media 114, broadcasts/traditional media 112). The system can integrate with these distribution channels to track the usage and consumption of the content. It captures data such as the number of plays, views, downloads, and any other relevant metrics. The system collects and aggregates the usage data from the distribution channels at step 1505. It generates usage reports for each musical component, showing the total usage and breakdowns by content, platform, and territory. The usage reports are made available to the rights holders for transparency and verification.

The AI-powered content generation system's licensing and rights management capabilities may extend beyond traditional content reproduction to encompass a wide range of licensing scenarios, including those related to name, image, and likeness (NIL) rights, product placement, and alternative “failover” content licenses. This flexibility allows content creators to navigate the complex landscape of intellectual property rights and commercial partnerships while maintaining the integrity and adaptability of their generated content.

One key aspect of this system is its ability to handle NIL rights, particularly in the context of generated content that features or is inspired by real individuals. For example, if a content creator wants to include a virtual character that resembles or is voiced by a famous actor, like Scarlett Johansson, the AI system can generate content that captures the essence of the actor's likeness or voice while adhering to the specific terms of the NIL agreement. This can involve generating “inspired by” content that evokes the actor's style or personality without directly replicating their exact appearance or voice, allowing for greater creative flexibility and reducing the risk of licensing disputes.

Similarly, the AI system can intelligently incorporate product placement into the generated content based on predefined commercial partnerships and licensing agreements. This can range from subtle brand integrations, such as a character using a specific product in a natural context, to more overt product showcases that align with the narrative and aesthetic style of the content. The AI's ability to dynamically generate and adapt these product placements ensures that they seamlessly blend with the content and remain relevant to the target audience.

In situations where specific licensed elements, such as a particular song, sound effect, or brand integration, become unavailable or need to be replaced, the AI system's “failover” content licensing capabilities come into play. Much like the “alt-music” and “alt-soundeffect” features described earlier, this functionality allows for the automatic generation of alternative content that maintains the desired style, tone, and continuity of the original element. For example, if a licensed song used in the background of a scene expires, the AI can generate an original composition that closely matches the mood and tempo of the original track, ensuring a seamless transition for the audience.

Furthermore, the AI system's licensing management may extend to the realm of “inspired by” content, where the generated material draws inspiration from existing works or intellectual properties without directly replicating them. This can involve creating new stories, characters, or worlds that capture the spirit and themes of beloved franchises or genres while avoiding direct infringement of copyrights or trademarks. By leveraging the AI's ability to analyze and understand the key elements and conventions of these inspiring works, content creators can generate fresh and engaging content that resonates with fans while minimizing legal risks.

Based on the usage data and the licensing agreements, the system calculates the royalties owed to each rights holder at step 1506. It may consider factors such as the agreed-upon royalty rates, usage metrics, and any applicable deductions or fees. The system can generate royalty statements detailing the earnings for each musical component. It initiates the distribution of royalties to the rights holders according to the specified payment terms and methods. In case of any discrepancies or disputes regarding the usage data or royalty calculations, the system may provide a mechanism for resolution at step 1507. Rights holders can raise queries or disputes through the system, providing supporting evidence if necessary. The system facilitates communication between the parties involved and assists in resolving the issues. It maintains an audit trail of all transactions, usage data, and royalty calculations for accountability and transparency.

At step 1508, the system generates comprehensive reports and analytics for rights holders and licensees. Rights holders can access insights into the usage and performance of their musical components across different content and platforms. Licensees can track the effectiveness and ROI of their licensed components and make informed decisions for future licensing. The system provides data visualization tools and customizable reporting features to cater to different stakeholders' needs.

The system 120 may be configured to continuously monitor the usage and performance of the licensed musical components. It identifies trends, anomalies, and opportunities for optimization. The system can provide recommendations to rights holders and licensees based on the data insights. It may suggest potential licensing opportunities, revenue optimization strategies, and areas for improvement. This workflow ensures that musical component usage is accurately tracked, royalties are calculated fairly, and rights holders are compensated according to the licensing agreements. The system automates the process, reduces manual effort, and provides transparency and accountability for all parties involved.

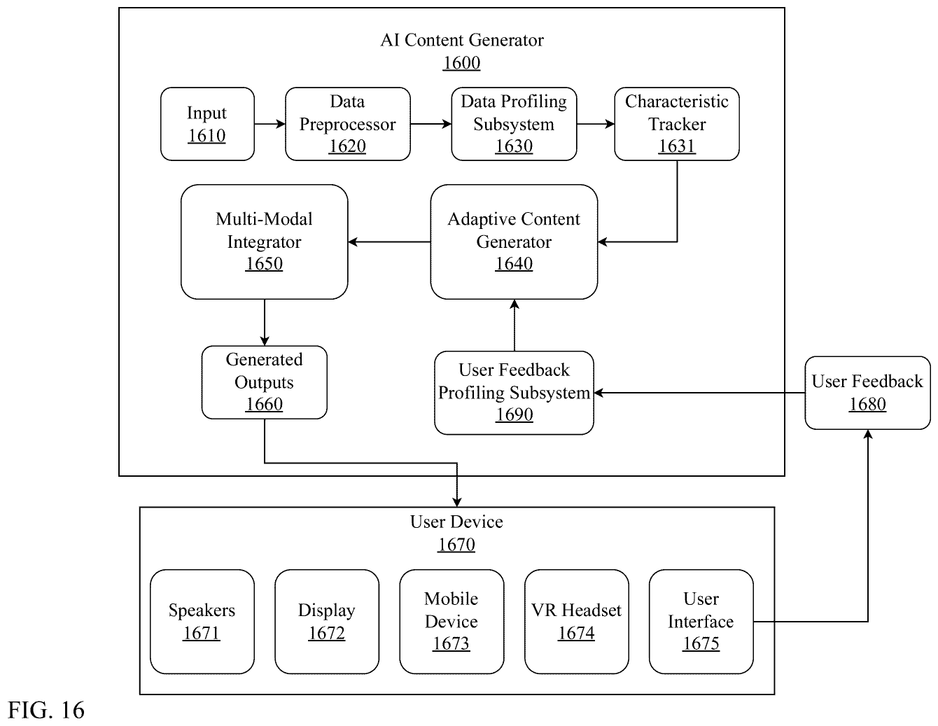

FIG. 16 is a block diagram illustrating an exemplary system architecture for an artificial intelligence-powered large-scale content generator. An AI content generator 1600 is a comprehensive system designed to take user inputs and generate a wide range of content, including text, video, sound, and other types of experiences. The system leverages advanced artificial intelligence techniques to analyze, profile, and process the input data, ensuring consistency and continuity throughout the content generation process.

A user interface 1675 serves as the primary point of interaction between the user and the AI content generator 1600. It allows users to provide their inputs 1610, which can include text, audio, video, or any other relevant data. The interface is designed to be intuitive and user-friendly, enabling users to easily input their ideas, requirements, and preferences. Once the user input is received, it undergoes a series of preprocessing steps in a data preprocessor 1620. This module is responsible for cleaning, formatting, and normalizing the input data to ensure compatibility with the subsequent components of the system. It may involve tasks such as text tokenization, audio segmentation, or video frame extraction, depending on the nature of the input.

The preprocessed data then flows into a data profiling subsystem 1630, which employs various AI techniques, such as natural language processing (NLP), computer vision, and audio analysis, to identify and extract important elements from the input. It segments the data into key subjects, adjectives, settings, and any other relevant components that contribute to the overall context and meaning of the input. A characteristic tracker 1631 may access the segments created by the data profiling subsystem to flag and track important sections of the input. It maintains a record of key characteristics, such as main characters, recurring themes, or consistent settings, to ensure continuity throughout the content generation process. The characteristic tracker 1631 helps maintain coherence and consistency across different parts of the generated content.

The profiled and tracked data is then passed to an adaptive content generator 1640, which forms the core of the AI Content Generator 1600. The adaptive content generator 1640 consists of a plurality of AI models and algorithms working together to process various aspects of the input and generate corresponding content. The adaptive content generator may include specialized AI models for text generation, image synthesis, audio processing, and more. These models are trained on vast amounts of data and can generate highly contextual and relevant content based on the profiled input.

The generated content from the adaptive content generator is then fed into a multi-modal integrator 1650. This module is responsible for combining and synchronizing the generated content across different modalities, such as text, video, and sound. It ensures that the generated outputs are coherent, seamless, and aligned with each other. The multi-modal integrator 1650 may employ techniques like temporal alignment, cross-modal attention, or multimodal fusion to create a unified and immersive experience.

The final generated outputs 1660 from the AI Content Generator 1600 can take various forms, depending on the user's requirements and the capabilities of the system. These outputs can include text documents, videos, audio files, or even interactive experiences. The generated content is designed to be highly engaging, contextually relevant, and tailored to the user's input. Generated outputs 1660 may be displayed on or generated to a user device 1670 which represents the various devices through which users can access and consume the generated content. This may include but is not limited to speakers 1671 for audio output, display 1672 for visual content, a mobile device 1673 for on-the-go access, or VR headset 1674 for immersive experiences. The user interface 1675 on these devices allows users to interact with the generated content, providing feedback, and making adjustments as needed.

Using the user interface 1675, a user may provide user feedback 1680 which plays a vital role in the continuous improvement and refinement of the AI Content Generator. The user feedback profiling subsystem 1690 collects and analyzes user feedback, preferences, and engagement data. This information may be used to update the characteristic tracker 1631, fine-tune the AI models, and improve the overall quality and relevance of the generated content.

In one embodiment, the system may be used to generate a novel, where the user input 1610 could be a brief synopsis or a set of key ideas that outline the desired story. For example, the user might input: “A young protagonist discovers a hidden magical world and embarks on a quest to save it from an ancient evil force.” The data preprocessor 1620 would then clean and format this input, preparing it for analysis.

The data profiling subsystem 1630 may analyze the preprocessed input to identify and extract crucial elements. In this case, it would recognize the main character (young protagonist), the setting (hidden magical world), and the central conflict (saving the world from an ancient evil force). The characteristic tracker 1631 would flag and store these elements to ensure consistency throughout the novel generation process. For instance, if the protagonist's age is later mentioned as 16 years old, the characteristic tracker 1631 would record this information. If, in a subsequent chapter, the protagonist is referred to as a 12-year-old, the system would detect the inconsistency and prompt the user or make necessary adjustments to maintain coherence.

The adaptive content generator 1640 would then generate the content of the novel based on the profiled input. It would create detailed descriptions of the magical world, develop the protagonist's backstory and personality, and construct a compelling narrative arc with multiple plot points, challenges, and revelations. The generator might introduce supporting characters, such as a wise mentor or a loyal sidekick, to enrich the story. As the story progresses, the characteristic tracker 1631 would continue monitoring the consistency of various elements. It would ensure that the protagonist's actions and decisions align with their established personality and growth throughout the narrative. It would also track the continuity of the magical world's rules and lore, making sure that any new elements introduced are coherent with the previously established context.

Similarly, when generating a movie, the user input could be a high-level concept or a brief script treatment. For example: “In a dystopian future, a group of rebels uncover a government conspiracy and fight to expose the truth.” The data profiling subsystem 1630 would identify key elements like the setting (dystopian future), main characters (group of rebels), and central plot (uncovering a government conspiracy).

The adaptive content generator 1640 may generate various aspects of the movie, such as character designs, dialogue, and storyboards. It would create visually striking scenes that depict the dystopian world, generate tense conversations between the rebels as they plan their resistance, and develop action sequences that showcase their fight against the oppressive government. The characteristic tracker 1631 would monitor the consistency of the generated content, ensuring that the visual style remains cohesive throughout the movie. It would track the development of each rebel character, making sure their actions and motivations align with their established traits and arcs. If a character suddenly behaves in a way that contradicts their previous development, the system would flag the inconsistency for review and refinement.

In both examples multi-modal integrator 1650 combines the generated content across different modalities. In the novel example, it may integrate the generated text with any accompanying illustrations, ensuring that the visual elements align with the descriptions in the narrative. For the movie, it may synchronize the generated dialogue with the character animations, and match the sound effects and music to the visuals, creating a seamless and immersive experience. The generated outputs 1660 could be a complete novel in various formats (e.g., PDF, e-book) or a fully realized movie, including the final video file, soundtrack, and any associated promotional materials. Users can access these outputs through different devices 1670 and provide feedback 1680 on the generated content. Additionally, the system may be used to generate portions of an experience. For example, single chapters in a novel or single scenes in a movie. The system is not limited to generating entire experiences at a time.

After generation, the user feedback profiling subsystem 1690 would analyze feedback to identify areas for improvement. For example, if users consistently point out plot holes or inconsistencies in the generated novel, the system would learn from this feedback and refine its algorithms to address these issues in future iterations. Similarly, if users highlight particular scenes or characters in the movie that resonate with them, the system would recognize these patterns and incorporate them into subsequent movie generation projects.

In another embodiment, the system may be used to create an entire environment. Imagine a user inputs the following concept: “A mysterious, abandoned space station orbiting a distant planet, filled with puzzles and challenges that unlock its secrets.” The data preprocessor 1620 would clean and process this input. The data profiling subsystem 1630 would identify key elements such as the setting (space station), atmosphere (mysterious and abandoned), and gameplay mechanics (puzzles and challenges). The characteristic tracker 1631 would record these elements, ensuring consistency throughout the generation process.

The adaptive content generator 1640 would then generate various aspects of the virtual environment. It would create detailed 3D models of the space station's interior, including eerie corridors, high-tech laboratories, and hidden passageways. The generator would also design puzzles and challenges that the user must solve to progress through the environment, such as deciphering alien languages, repairing damaged equipment, or navigating zero-gravity areas. To enhance the immersive experience, the adaptive content generator 1640 may create dynamic lighting and atmospheric effects, such as flickering lights, sparking wires, and drifting smoke particles. It would also generate ambient sound effects, like the hum of machinery, the creaking of metal, and the echoes of distant noises, to heighten the sense of isolation and mystery.

The characteristic tracker 1631 would continuously monitor the consistency of the generated content. It would ensure that the visual style remains cohesive throughout the environment, with consistent color palettes, architectural designs, and texture quality. It would also track the difficulty progression of the puzzles and challenges, ensuring that they build upon each other logically and provide a satisfying sense of progression. The multi-modal integrator 1650 would play a crucial role in combining the generated content into a seamless, interactive experience. It may integrate the 3D models, lighting, and sound effects into a unified virtual environment that users can explore and interact with. The integrator 1650 may also ensure that the puzzles and challenges are properly triggered and resolved based on the user's actions.

The generated output 1660 would be a fully realized, interactive virtual environment that users can access through various devices 1670, such as VR headsets, gaming consoles, or mobile devices. The user interface 1675 would provide intuitive controls for navigating and interacting with the environment, such as hand gestures in VR or touch controls on mobile devices. As users explore the space station, they would encounter the generated puzzles and challenges, piecing together the story and uncovering the secrets hidden within. The characteristic tracker 1631 would ensure that the narrative remains consistent, with clues and revelations building upon each other coherently. In one embodiment, the generated output 1660 may be passed back through the system as an input to help foster improved generation in the future. In addition to being trained on user feedback, the system may be trained by analyzing how far away the generated content is from an expected generated content.

User feedback 1680 may be collected through various means, such as in-game surveys, player analytics, or social media discussions. The user feedback profiling subsystem 1690 may analyze this feedback to identify areas for improvement and refinement. For example, if users find certain puzzles too difficult or confusing, the system would adjust the difficulty level or provide clearer clues in future iterations. If users particularly enjoy certain types of challenges or atmospheric elements, the system would incorporate more of those features in subsequent generated environments.

This example demonstrates the versatility of the AI content generator system, showcasing its ability to create comprehensive, interactive experiences that transcend traditional forms of media. By leveraging advanced AI techniques and the power of user feedback, the system can generate compelling, personalized content that adapts to individual preferences and pushes the boundaries of creative expression.

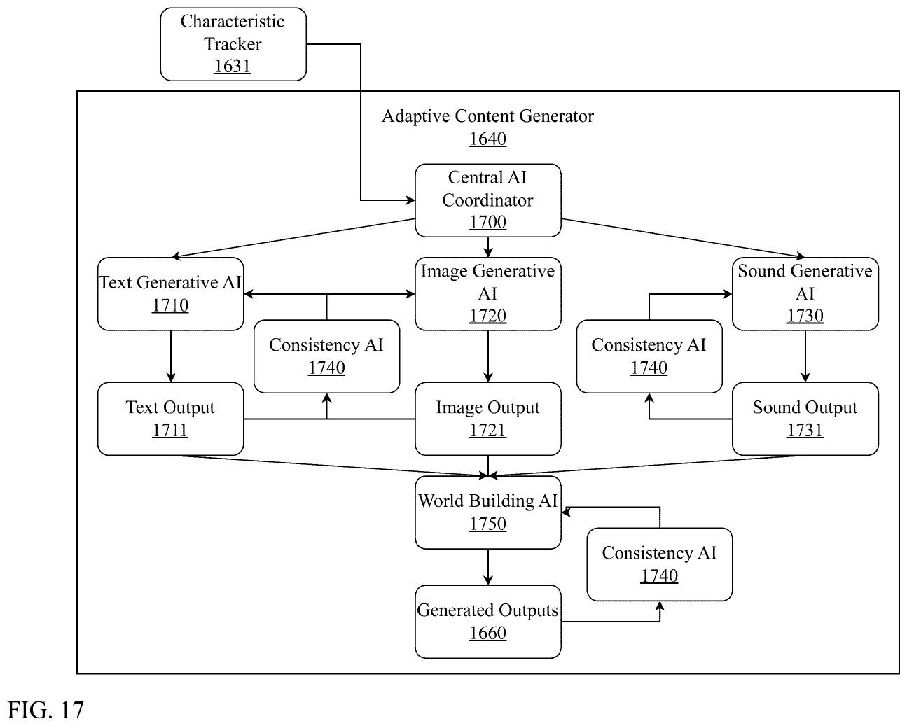

FIG. 17 is a block diagram illustrating an aspect of an artificial intelligence-powered large-scale content generator, an adaptive content generator. The adaptive content generator 1640 is responsible for creating consistent, coherent, and engaging content across multiple modalities. In one embodiment the adaptive content generator 1640 comprises several specialized AI components working together under the coordination of a central AI coordinator 1700.

The central AI coordinator 1700 acts as the main orchestrator of the content generation process. It receives the profiled and tracked data from the characteristic tracker 1631, which analyzes user input and identifies key elements and characteristics to maintain continuity throughout the generation process. The central AI coordinator distributes this information to the relevant specialized AI components based on their specific functions and modalities.

A text generative AI 1710 is a specialized component designed to generate textual content. It utilizes advanced natural language processing (NLP) techniques and deep learning models, such as transformer-based architectures, to create coherent, contextually relevant, and stylistically appropriate text. The text generative AI 1710 takes into account the information provided by the central AI coordinator 1700 and generates text outputs 1711 that align with the specified characteristics, themes, and continuity requirements. An image generative AI 1720 focuses on creating visual content, such as images, illustrations, and textures. It may state-of-the-art computer vision and generative models, like Generative Adversarial Networks (GANs) or Variational Autoencoders (VAEs), to produce high-quality and visually consistent images. The image generative AI 1720 receives relevant information from the central AI coordinator 1700 and generates image outputs 1721 that adhere to the desired styles, themes, and visual continuity. A sound generative AI 1730 specializes in generating audio content, including music, sound effects, and voiceovers. It may leverage advanced audio processing and synthesis techniques, such as WaveNet or SampleRNN, to create realistic and immersive audio outputs 1731. The sound generative AI 1730 takes into account the information provided by the central AI coordinator 1700 to generate audio that complements the textual and visual content, maintaining consistency in terms of mood, genre, and overall coherence.

To ensure the consistency and continuity of the generated content, the Adaptive Content Generator 1640 may incorporate several consistency AI components 1740. These components continuously monitor the outputs of the text, image, and sound generative Als, checking for any inconsistencies, discrepancies, or deviations from the established characteristics and continuity requirements. The consistency AI 1740 components may employ various techniques, such as anomaly detection, pattern recognition, and machine learning, to identify and flag any content that violates the consistency rules. They provide feedback to the respective generative AIs to make necessary adjustments and maintain the overall coherence of the generated content.

A world building AI 1750 focuses on maintaining the consistency and coherence of the generated world, setting, or environment. The world building AI 1750 keeps track of the established rules, lore, and constraints of the fictional world and ensures that the generated content aligns with these guidelines. It collaborates with the consistency AI 1740 components to identify any inconsistencies or contradictions in the generated world-building elements and provides feedback to the Generative AIs to maintain the integrity of the fictional world.

The outputs from the text generative AI 1711, image generative AI 1721, and sound generative AI 1731, along with the consistency checks performed by the consistency AI components 1740 and the world building AI 1750, are combined to form the final generated outputs 1660. These outputs represent a coherent, consistent, and engaging multi-modal content experience that adheres to the specified characteristics, themes, and continuity requirements. The Adaptive Content Generator 1640 iterates and refines the generated content based on the feedback received from the consistency AI components 1740 and the world building AI 1750. This iterative process ensures that the final outputs meet the desired quality standards and maintain a high level of consistency and coherence across all modalities.

Moreover, the Adaptive Content Generator incorporates a feedback loop that allows it to learn and improve over time based on user interactions and preferences. The user feedback is processed by the user feedback profiling subsystem and fed back into the Adaptive Content Generator. This feedback is used to fine-tune the Generative AIs, adjust the consistency rules, and adapt the content generation process to better align with user expectations and preferences.

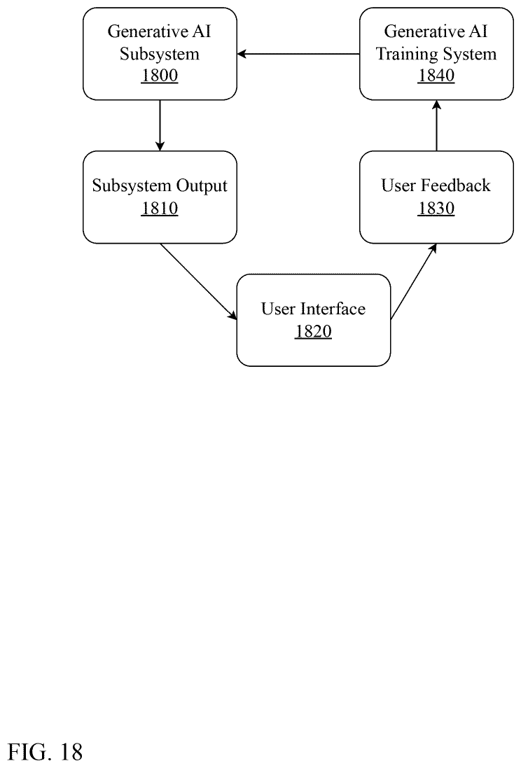

FIG. 18 is a block diagram illustrating an exemplary aspect of an embodiment of an artificial intelligence-powered large-scale content generator, where the adaptive content generator is trained by a generative AI training system. The Generative AI Subsystem 1800 receives input from the user through the user interface 1820. This input can take various forms, such as text prompts, sketches, or audio samples, depending on the desired content modality. The user interface 1820 provides a user-friendly and intuitive way for users to specify their content requirements, preferences, and constraints. It may include features such as natural language processing for text input, drawing tools for image input, or voice recognition for audio input. Once the user input is received, the Generative AI Subsystem 1800 processes it using the trained deep learning models. The models generate content that aligns with the user's input and preferences while maintaining coherence, consistency, and quality. For example, if the user provides a text prompt for a story, the text generation model within the Generative AI Subsystem will generate a continuation of the story that follows the specified style, tone, and theme.

The generated content is then presented to the user through the User Interface 1820 as subsystem output 1810. The user interface 1820 displays the generated text, images, or audio in a way that allows the user to easily review and interact with the content. It may include features such as text highlighting, image zooming, or audio playback controls to enhance the user experience. The user interface 1820 provides mechanisms for users to provide feedback 1830 on the generated content. This feedback can take various forms, such as ratings, comments, or suggestions for improvement. The user feedback is captured and processed by the Generative AI Subsystem 1800 to update and refine the deep learning models.

A generative AI training system 1840 utilizes the user feedback 1830 collected through the user interface 1820 to fine-tune and adapt the deep learning models. The training system applies techniques such as transfer learning, fine-tuning, or reinforcement learning to update the model parameters based on the user feedback. This allows the Generative AI Subsystem to learn from user preferences, adapt to specific styles or themes, and generate content that better aligns with user expectations. The generative AI training system 1840 may also incorporate additional data sources, such as external datasets or curated examples, to further enhance the training process. It can utilize techniques like data augmentation, domain adaptation, or few-shot learning to improve the models' ability to generate diverse and high-quality content across different domains and styles.

The iterative feedback loop between the Generative AI Subsystem 1800, user interface 1820, and generative AI training system 1840 enables the continuous refinement and improvement of the generated content. As users provide more feedback and the models are updated accordingly, the Generative AI Subsystem becomes more adept at creating content that meets user preferences and expectations.

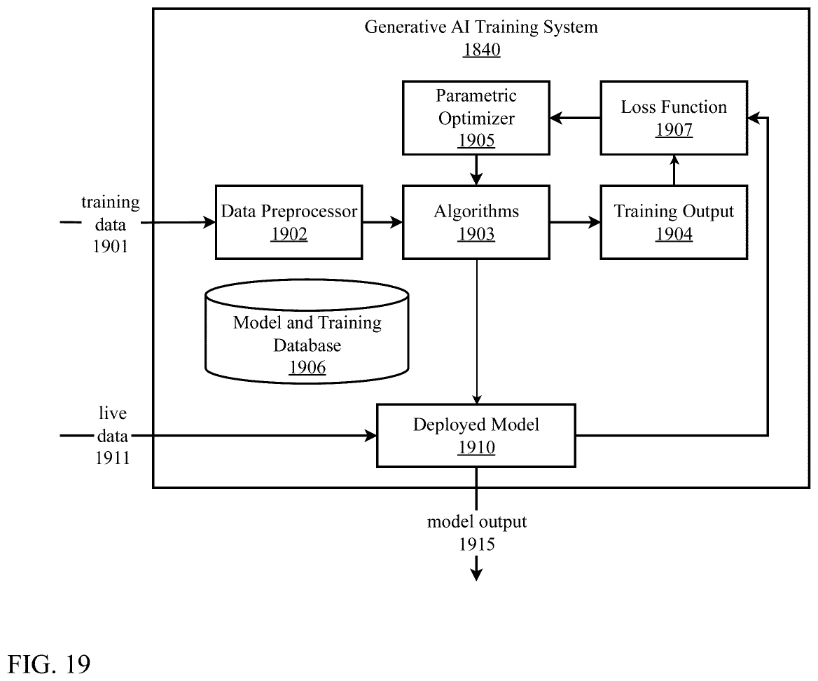

FIG. 19 is a block diagram illustrating an aspect of an artificial intelligence-powered large-scale content generator, a generative AI training system. According to the embodiment, the generative AI training system 1840 may comprise a model training stage comprising a data preprocessor 1902, one or more machine and/or deep learning algorithms 1903, training output 1904, and a parametric optimizer 1905, and a model deployment stage comprising a deployed and fully trained model 1910 configured to perform tasks described herein such determining correlations between compressed data sets. The generative AI training system 1840 may be used to train and deploy a machine learning energy optimizer in order to support the services provided by the artificial intelligence-powered large-scale content generator.

At the model training stage, a plurality of training data 1901 may be received by the energy generative AI training system 1840. Data preprocessor 1902 may receive the input data (e.g., user prompt, text file, images) and perform various data preprocessing tasks on the input data to format the data for further processing. For example, data preprocessing can include, but is not limited to, tasks related to data cleansing, data deduplication, data normalization, data transformation, handling missing values, feature extraction and selection, mismatch handling, and/or the like. Data preprocessor 1902 may also be configured to create training dataset, a validation dataset, and a test set from the plurality of input data 1901. For example, a training dataset may comprise 80% of the preprocessed input data, the validation set 10%, and the test dataset may comprise the remaining 10% of the data. The preprocessed training dataset may be fed as input into one or more machine and/or deep learning algorithms 1903 to train a predictive model for object monitoring and detection.

During model training, training output 1904 is produced and used to measure the accuracy and usefulness of the predictive outputs. During this process a parametric optimizer 1905 may be used to perform algorithmic tuning between model training iterations. Model parameters and hyperparameters can include, but are not limited to, bias, train-test split ratio, learning rate in optimization algorithms (e.g., gradient descent), choice of optimization algorithm (e.g., gradient descent, stochastic gradient descent, of Adam optimizer, etc.), choice of activation function in a neural network layer (e.g., Sigmoid, ReLu, Tanh, etc.), the choice of cost or loss function the model will use, number of hidden layers in a neural network, number of activation unites in each layer, the drop-out rate in a neural network, number of iterations (epochs) in a training the model, number of clusters in a clustering task, kernel or filter size in convolutional layers, pooling size, batch size, the coefficients (or weights) of linear or logistic regression models, cluster centroids, and/or the like. Parameters and hyperparameters may be tuned and then applied to the next round of model training. In this way, the training stage provides a machine learning training loop.

In some implementations, various accuracy metrics may be used by the energy optimizer training system 1950 to evaluate a model's performance. Metrics can include, but are not limited to, word error rate (WER), word information loss, speaker identification accuracy (e.g., single stream with multiple speakers), inverse text normalization and normalization error rate, punctuation accuracy, timestamp accuracy, latency, resource consumption, custom vocabulary, sentence-level sentiment analysis, multiple languages supported, cost-to-performance tradeoff, and personal identifying information/payment card industry redaction, to name a few. In one embodiment, the system may utilize a loss function 1907 to measure the system's performance. The loss function 1907 compares the training outputs with an expected output and determines how the algorithm needs to be changed in order to improve the quality of the model output. During the training stage, all outputs may be passed through the loss function 1907 on a continuous loop until the algorithms 1903 are in a position where they can effectively be incorporated into a deployed model 1915.

The test dataset can be used to test the accuracy of the model outputs. If the training model is establishing correlations that satisfy a certain criterion such as but not limited to quality of the correlations and amount of restored lost data, then it can be moved to the model deployment stage as a fully trained and deployed model 1910 in a production environment generating content based on live input data 1911 (e.g., user inputs, text files, image files). Further, model correlations and restorations made by deployed models can be used as feedback and applied to model training in the training stage, wherein the model is continuously learning over time using both training data and live data and predictions. A model and training database 1906 is present and configured to store training/test datasets and developed models. Database 1906 may also store previous versions of models.

According to some embodiments, the one or more machine and/or deep learning models may comprise any suitable algorithm known to those with skill in the art including, but not limited to: LLMs, generative transformers, transformers, supervised learning algorithms such as: regression (e.g., linear, polynomial, logistic, etc.), decision tree, random forest, k-nearest neighbor, support vector machines, Naïve-Bayes algorithm; unsupervised learning algorithms such as clustering algorithms, hidden Markov models, singular value decomposition, and/or the like. Alternatively, or additionally, algorithms 1903 may comprise a deep learning algorithm such as neural networks (e.g., recurrent, convolutional, long short-term memory networks, etc.).

In some implementations, the energy generative AI training system 1840 automatically generates standardized model scorecards for each model produced to provide rapid insights into the model and training data, maintain model provenance, and track performance over time. These model scorecards provide insights into model framework(s) used, training data, training data specifications such as chip size, stride, data splits, baseline hyperparameters, and other factors. Model scorecards may be stored in database(s) 1906.

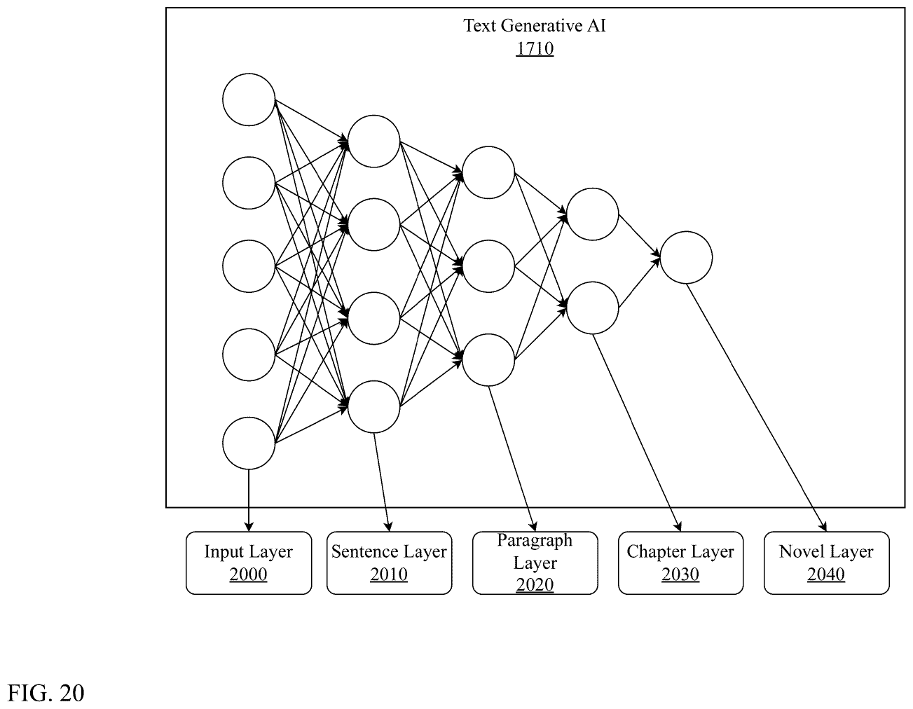

FIG. 20 is a block diagram illustrating how an adaptive content generator may be used to create entire experiences, or portions of an experience based on a user input. In one embodiment, the text generative AI 1710 is a hierarchical, multi-layered system that generates textual content with increasing levels of specificity and coherence. The text generative AI 1710 may be comprised of several layers, each responsible for generating content at a different level of granularity. This hierarchical structure allows for the creation of coherent and well-structured text, ranging from individual sentences to complete novels, while providing users with the flexibility to extract content at various levels of detail. An input layer 2000 receives the user's input, such as a prompt, a set of keywords, or a brief description of the desired content. The Input Layer processes this information and passes it to the subsequent layers for content generation.

A sentence layer 2010 may be the first level of content generation in the text generative AI 1710. This layer focuses on generating individual sentences based on the input received from the input layer 2000. The sentence layer 2010 utilizes advanced natural language processing techniques, such as language models and syntactic parsing, to create grammatically correct and semantically coherent sentences. It takes into account factors like sentence structure, word choice, and contextual relevance to ensure that the generated sentences align with the user's input and the desired style or tone.

Building upon the output of the sentence layer, a paragraph layer 2020 combines and arranges the generated sentences into well-structured paragraphs. The paragraph layer 2020 may consider factors such as topic coherence, logical flow, and transition between sentences to create paragraphs that effectively convey a unified idea or concept. It employs techniques like coreference resolution and discourse analysis to maintain consistency and coherence within each paragraph. A chapter layer 2030 takes the paragraphs generated by the paragraph layer 2020 and organizes them into chapters. This layer focuses on creating a coherent narrative structure and ensuring that each chapter contributes to the overall progression of the story or content. The chapter layer 2030 considers aspects like pacing, character development, and plot advancement to generate chapters that engage the reader and maintain their interest. It may employ techniques such as event extraction, sentiment analysis, and story arc modeling to create compelling and well-structured chapters.

A novel layer 2040 combines the chapters generated by the chapter layer 2030 to create a complete novel. The novel layer 2040 ensures that the overall narrative is coherent, engaging, and satisfying for the reader. It considers factors like overarching themes, character arcs, and plot resolution to generate a well-rounded and immersive reading experience. The novel layer 2040 may employ techniques like story generation, plot optimization, and style transfer to create novels that align with the user's preferences and expectations.

One of the key advantages of this hierarchical structure is that it allows users to extract content at various levels of specificity. If a user only requires a single sentence or a paragraph, they can access the output of the sentence layer 2010 or the paragraph layer 2020 directly, without the need for generating an entire novel. Similarly, if a user wants a specific chapter or a portion of a novel, they can extract the desired content from the chapter layer 2030 or the novel layer 2040. This flexibility enables users to tailor the generated content to their specific needs and requirements.

The hierarchical structure of the text generative AI 1710 can be extended to other modalities, such as the image generative AI and the sound generative AI. In the case of the image generative AI, the layers could represent different levels of visual detail, ranging from individual objects or characters to complete scenes or environments. Users could extract specific visual elements, such as a single frame or a particular object, without generating an entire video or animation. Additionally, they could access scenes of a movie without needing the system to generate an entire movie. Similarly, in the sound generative AI, the layers could represent different levels of audio composition, ranging from individual sound effects or musical notes to complete soundtracks or compositions. Users could extract specific audio elements, such as a particular sound effect or a musical phrase, without generating an entire audio track.

The node/layer framework of the text generative AI 1710 provides a flexible and modular approach to content generation, allowing users to customize the scope and specificity of the generated content based on their needs. By enabling users to extract content at various levels of detail, the system offers a versatile and adaptable solution for a wide range of applications, from content creation and story development to personalized user experiences and interactive media.

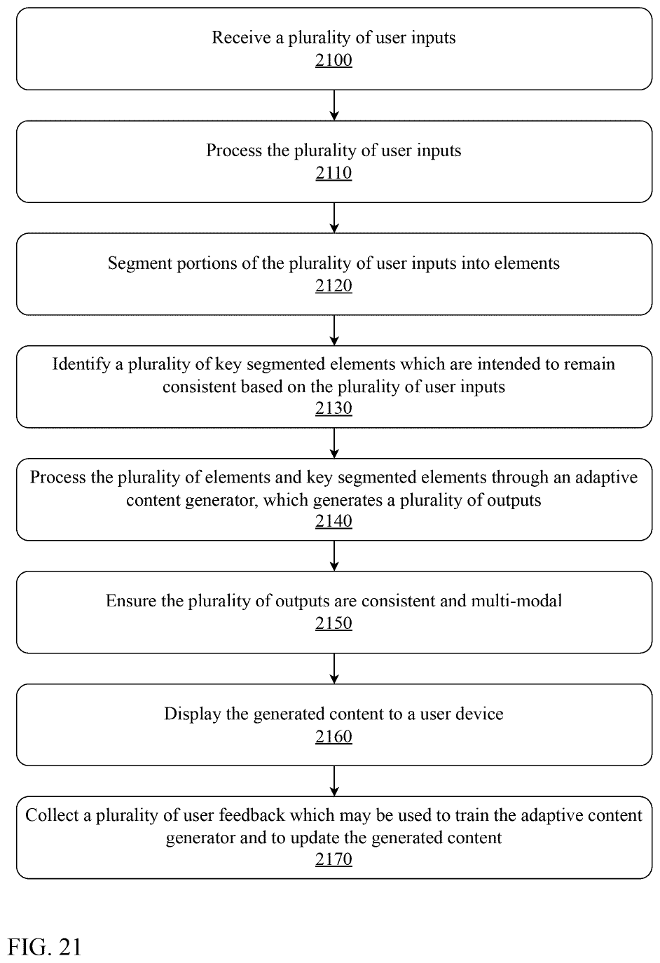

FIG. 21 is a flow diagram illustrating an exemplary method for adaptive content generation using an artificial intelligence-powered large-scale content generator. The method described outlines a comprehensive process for generating a wide range of content, including but not limited to texts, movies, images, scenes, music compositions, and interactive environments, using an adaptive content generator. The method focuses on maintaining consistency across the generated content while incorporating user feedback to improve and refine the output.

In a first step 2100, receive a plurality of user inputs. These inputs can take various forms depending on the type of content being generated. For example, in the case of a novel, the user inputs may include a plot summary, character descriptions, setting details, and desired themes or genres. For a movie, the inputs may consist of a script, storyboards, concept art, and musical references. In the case of an interactive environment, the user may provide a description of the desired setting, objects, characters, and interactions.

In a step 2110, preprocess the plurality of user inputs to extract relevant information and prepare them for the subsequent steps. This processing may involve techniques like natural language processing (NLP) for textual inputs, image analysis for visual inputs, and audio processing for musical or sound-related inputs. The processing step aims to structure and organize the user inputs in a format that can be easily utilized by the adaptive content generator.

In a step 2120, segment portions of the processed user inputs into distinct elements. This segmentation allows for a more granular analysis and generation of content. For instance, in the case of a novel, the segmentation may divide the plot summary into individual scenes or chapters. For a movie, the script may be segmented into different shots or sequences. In an interactive environment, the segmentation may identify distinct objects, characters, or areas within the overall setting.

In a step 2130, identify a plurality of key elements that are intended to remain consistent throughout the generated content. These key elements serve as the foundation and anchors for maintaining coherence and continuity across the output. For example, in a novel, the key elements may include the main characters, their personalities, and the overarching theme. In a movie, the key elements may consist of the central plot points, the visual style, and the primary musical themes. In an interactive environment, the key elements may include the laws of physics, the behaviors of objects and characters, and the overall aesthetic.

In a step 2140, process the segmented elements and the identified key elements through an adaptive content generator. The adaptive content generator is a sophisticated system that utilizes artificial intelligence and machine learning techniques to generate coherent and consistent content based on the provided inputs. It consists of multiple specialized AI components, such as generative models for text, images, and audio, as well as consistency enforcers and world-building modules. The adaptive content generator may utilize the segmented elements and the key elements to generate a plurality of outputs. These outputs can include generated text for a novel, generated scenes for a movie, generated images and animations for an interactive environment, and generated music compositions. The generator takes into account the relationships between the elements, the desired style and tone, and the specified constraints to create content that is coherent and aligned with the user's inputs.

In a step 2150, ensure the consistency and multi-modality of the generated outputs through various techniques. The adaptive content generator may utilizes consistency enforcer modules that continuously monitor the generated content for any inconsistencies or contradictions. These modules check for continuity in character behaviors, plot progression, visual coherence, and adherence to the established rules and constraints. The generator also ensures that the outputs are multi-modal, meaning that they seamlessly integrate different forms of content, such as text, images, and audio, to create a rich and immersive experience.

In a step 2160, the generated content is then displayed to the user through appropriate interfaces and devices. For example, a generated novel may be presented as a digital book or an e-reader application, while a generated movie may be played back on a video streaming platform. An interactive environment may be experienced through a virtual reality headset or a gaming console.

In a step 2170, user feedback is collected throughout the generation process and after the content is displayed. This feedback can come in various forms, such as user ratings, comments, suggestions, and interactions with the generated content. The collected feedback is used to train and refine the adaptive content generator, allowing it to learn from user preferences and improve its outputs over time. The feedback can also be used to update and modify the generated content dynamically, ensuring that it remains engaging and satisfying for the user.

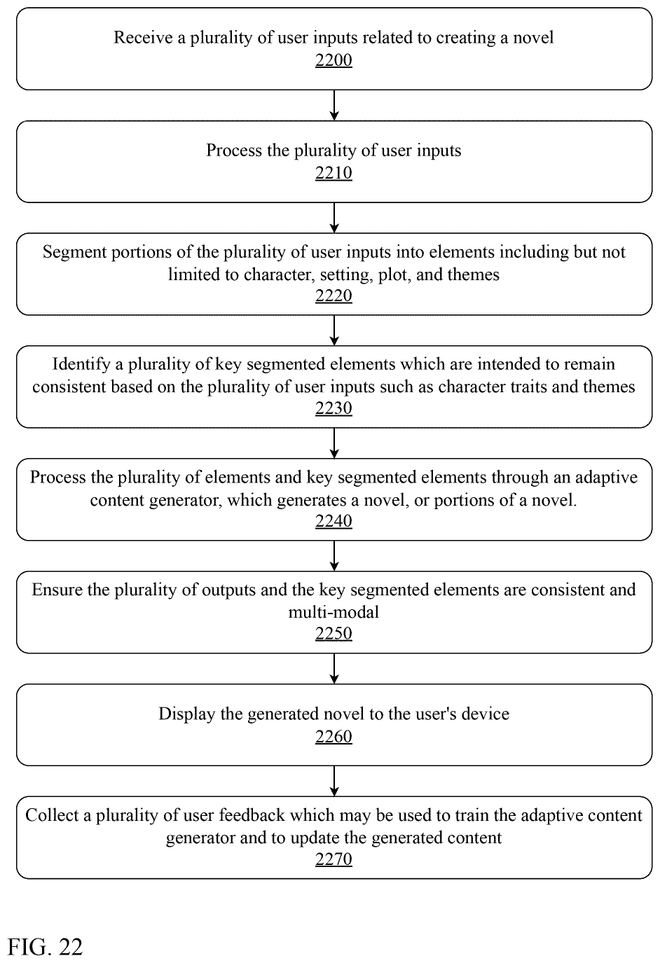

FIG. 22 is a flow diagram illustrating an exemplary method for generating a novel or a subset of a novel using an artificial intelligence-powered large-scale content generator. In a first step 2200, receive a plurality of user inputs related to creating a novel. These inputs may include a brief synopsis, character descriptions, setting details, desired themes, genre preferences, and any other information relevant to the story. The user inputs serve as the foundation for generating the novel and guide the adaptive content generator in creating content that aligns with the user's vision.

In a step 2210, the received user inputs are then processed to extract meaningful information and structure them in a format suitable for the adaptive content generator. This processing step may involve techniques such as natural language processing (NLP) to analyze and interpret the textual inputs, as well as data structuring and organization to prepare the inputs for the subsequent stages.

In a step 2220, the processed user inputs are segmented into distinct elements. These elements include characters, settings, plot points, and themes. The segmentation allows for a more focused and detailed analysis of each component of the novel. For example, character elements may include descriptions of their appearance, personality traits, backstories, and motivations. Setting elements may encompass details about the time period, location, and atmosphere of the story. Plot elements may include key events, conflicts, and turning points in the narrative. Theme elements may represent the underlying messages, morals, or ideas that the novel aims to convey.

In a step 2230, identify key segmented elements from the segmented elements that are intended to remain consistent throughout the novel 2230. These key elements are crucial for maintaining coherence and continuity in the generated content. For instance, character traits such as personalities, behaviors, and relationships should remain consistent across different scenes and chapters. The setting should maintain its established characteristics, such as the time period, location, and social norms. The plot should follow a logical progression, with events building upon each other in a coherent manner. Themes should be woven throughout the narrative, providing a unifying thread that ties the story together.

In a step 2240, the segmented elements and the identified key elements are processed through the adaptive content generator. The adaptive content generator is a sophisticated system that utilizes artificial intelligence and machine learning techniques to generate coherent and consistent content based on the provided inputs. It may comprise multiple layers, each responsible for generating content at a different level of granularity.

At the sentence level, the adaptive content generator creates individual sentences that are grammatically correct, semantically meaningful, and contextually relevant to the story. The paragraph level combines these sentences into well-structured and coherent paragraphs, ensuring smooth transitions and logical flow. The chapter level organizes the paragraphs into distinct chapters, each with its own narrative arc and purpose within the overall story. Finally, the novel level integrates the chapters into a complete and cohesive novel, ensuring that the overarching plot, character arcs, and themes are well-developed and satisfying.

In a step 2250, the adaptive content generator ensures the consistency and multi-modality of the outputs. It may employ consistency enforcer modules that continuously monitor the generated content for any inconsistencies or contradictions in the key elements. For example, if a character's personality or behavior deviates from their established traits, the consistency enforcer will flag the issue and prompt the generator to make necessary adjustments. Similarly, if the plot veers off course or introduces elements that contradict previous events, the consistency enforcer will intervene to maintain narrative coherence.

The AI-powered content generation system's licensing and rights management capabilities may extend beyond traditional content reproduction to encompass a wide range of licensing scenarios, including those related to name, image, and likeness (NIL) rights, product placement, and alternative “failover” content licenses. This flexibility allows content creators to navigate the complex landscape of intellectual property rights and commercial partnerships while maintaining the integrity and adaptability of their generated content.

One key aspect of this system is its ability to handle NIL rights, particularly in the context of generated content that features or is inspired by real individuals. For example, if a content creator wants to include a virtual character that resembles or is voiced by a famous actor, like Scarlett Johansson, the AI system can generate content that captures the essence of the actor's likeness or voice while adhering to the specific terms of the NIL agreement. This can involve generating “inspired by” content that evokes the actor's style or personality without directly replicating their exact appearance or voice, allowing for greater creative flexibility and reducing the risk of licensing disputes.

Similarly, the AI system can intelligently incorporate product placement into the generated content based on predefined commercial partnerships and licensing agreements. This can range from subtle brand integrations, such as a character using a specific product in a natural context, to more overt product showcases that align with the narrative and aesthetic style of the content. The AI's ability to dynamically generate and adapt these product placements ensures that they seamlessly blend with the content and remain relevant to the target audience.

In situations where specific licensed elements, such as a particular song, sound effect, or brand integration, become unavailable or need to be replaced, the AI system's “failover” content licensing capabilities come into play. Much like the “alt-music” and “alt-soundeffect” features described earlier, this functionality allows for the automatic generation of alternative content that maintains the desired style, tone, and continuity of the original element. For example, if a licensed song used in the background of a scene expires, the AI can generate an original composition that closely matches the mood and tempo of the original track, ensuring a seamless transition for the audience.

Furthermore, the AI system's licensing management may extend to the realm of “inspired by” content, where the generated material draws inspiration from existing works or intellectual properties without directly replicating them. This can involve creating new stories, characters, or worlds that capture the spirit and themes of beloved franchises or genres while avoiding direct infringement of copyrights or trademarks. By leveraging the AI's ability to analyze and understand the key elements and conventions of these inspiring works, content creators can generate fresh and engaging content that resonates with fans while minimizing legal risks.

In a step 2260, the generated novel or portions of the novel are displayed to the user through an appropriate interface or device. This could be in the form of a digital book, an e-reader application, or a web-based platform or streaming device (e.g. phone, tablet, tv, AR/VR headset, hologram). The user can interact with the generated content, reading through the novel, navigating between chapters, and exploring the story at their own pace.

In a step 2270, user feedback is collected throughout the generation process and after the novel is displayed. This feedback may include user ratings, comments, suggestions, and other forms of input that reflect the user's engagement and satisfaction with the generated content. The collected feedback is used to train and refine the adaptive content generator, allowing it to learn from user preferences and improve its outputs over time. For example, if users consistently provide positive feedback for certain types of characters or plot twists, the generator will learn to incorporate more of those elements in future iterations. Conversely, if users express dissatisfaction with specific aspects of the generated novel, the generator will adjust its approach to address those concerns.

The feedback can also be used to update and modify the generated content dynamically. If users suggest alternative plot developments or character actions, the adaptive content generator can incorporate those suggestions into the novel, creating a more interactive and personalized reading experience. This dynamic updating ensures that the novel remains engaging and relevant to the user's preferences and expectations.

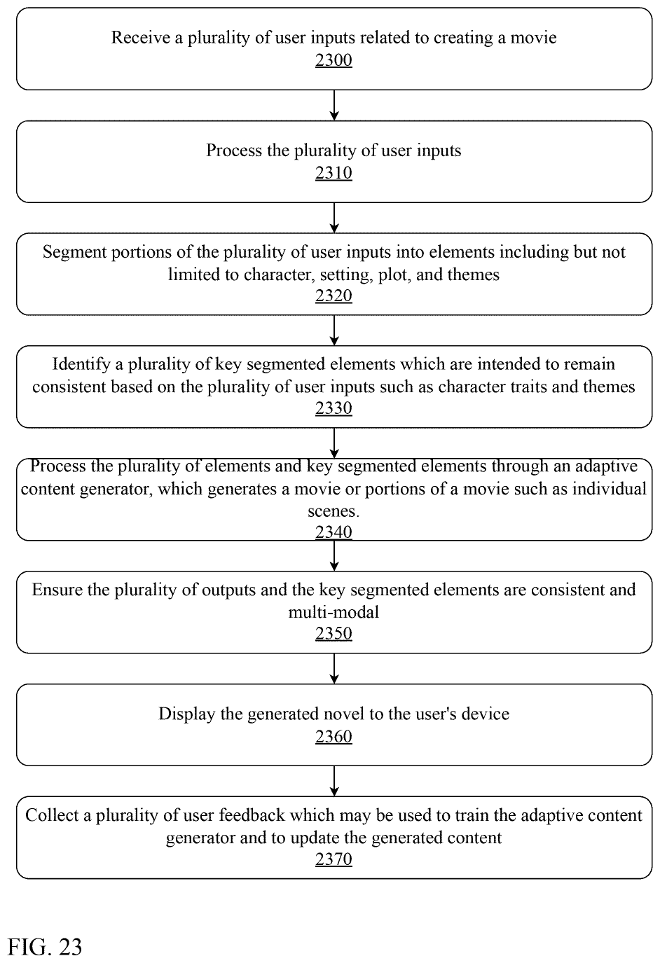

FIG. 23 is a flow diagram illustrating an exemplary method for generating a movie or a plurality of scenes within a movie using an artificial intelligence-powered large-scale content generator. In a first step 2300, receive a plurality of user inputs related to creating a movie. The inputs may include a script or story outline, character descriptions, setting details, desired themes, genre preferences, visual style references, and any other information relevant to the movie. The user inputs serve as the foundation for generating the movie and guide the adaptive content generator in creating content that aligns with the user's vision.

In a step 2310, the received user inputs are processed to extract meaningful information and structure them in a format suitable for the adaptive content generator. This processing step may involve techniques such as natural language processing (NLP) to analyze and interpret textual inputs, image analysis to process visual references, and data structuring to prepare the inputs for the subsequent stages.

In a step 2320, the processed user inputs are segmented into distinct elements. These elements may include but are not limited to characters, settings, plot points, and themes. The segmentation allows for a more focused and detailed analysis of each component of the movie. For example, character elements may include descriptions of their appearance, personality traits, backstories, and motivations. Setting elements may encompass details about the time period, location, and atmosphere of the movie. Plot elements may include key events, conflicts, and turning points in the narrative. Theme elements may represent the underlying messages, morals, or ideas that the movie aims to convey.

In a step 2330, identify a plurality of key elements that are intended to remain consistent throughout the movie. These key elements are crucial for maintaining coherence and continuity in the generated content. For instance, character traits such as appearances, behaviors, and relationships should remain consistent across different scenes. The setting should maintain its established characteristics, such as the time period, location, and visual style. The plot should follow a logical progression, with events building upon each other in a coherent manner. Themes should be woven throughout the narrative, providing a unifying thread that ties the movie together.

In a step 2340, the segmented elements and the identified key elements are processed through the adaptive content generator. The adaptive content generator is a sophisticated system that utilizes artificial intelligence and machine learning techniques to generate coherent and consistent content based on the provided inputs. It consists of multiple layers, each responsible for generating content at a different level of granularity.

At the still level, the adaptive content generator creates individual frames or images that capture specific moments or scenes from the movie. These stills are visually coherent, aesthetically pleasing, and aligned with the overall style and tone of the movie. The scene level combines these stills into dynamic and engaging sequences, ensuring smooth transitions, appropriate pacing, and visual consistency. The movie level integrates the scenes into a complete and cohesive film, ensuring that the overarching plot, character arcs, and themes are well-developed and impactful.

In a step 2350, the adaptive content generator ensures the consistency and multi-modality of the outputs. It employs consistency enforcer modules that continuously monitor the generated content for any inconsistencies or contradictions in the key elements. For example, if a character's appearance or behavior deviates from their established traits, the consistency enforcer will flag the issue and prompt the generator to make necessary adjustments. Similarly, if the plot veers off course or introduces elements that contradict previous events, the consistency enforcer will intervene to maintain narrative coherence.

In a step 2360, the generated movie or portions of the movie are then displayed to the user through an appropriate interface or device. This could be in the form of a video player, a streaming platform, or a virtual reality experience. The user can interact with the generated content, watching the movie, navigating between scenes, and exploring the visual and auditory elements of the film.

In a step 2370, user feedback is collected throughout the generation process and after the movie is displayed. This feedback can include user ratings, comments, suggestions, and other forms of input that reflect the user's engagement and satisfaction with the generated content. The collected feedback is used to train and refine the adaptive content generator, allowing it to learn from user preferences and improve its outputs over time. For example, if users consistently provide positive feedback for certain types of visual effects or storytelling techniques, the generator will learn to incorporate more of those elements in future iterations. Conversely, if users express dissatisfaction with specific aspects of the generated movie, the generator will adjust its approach to address those concerns.

The feedback can also be used to update and modify the generated content dynamically. If users suggest alternative scene compositions, character actions, or plot developments, the adaptive content generator can incorporate those suggestions into the movie, creating a more interactive and personalized viewing experience. This dynamic updating ensures that the movie remains engaging and relevant to the user's preferences and expectations.

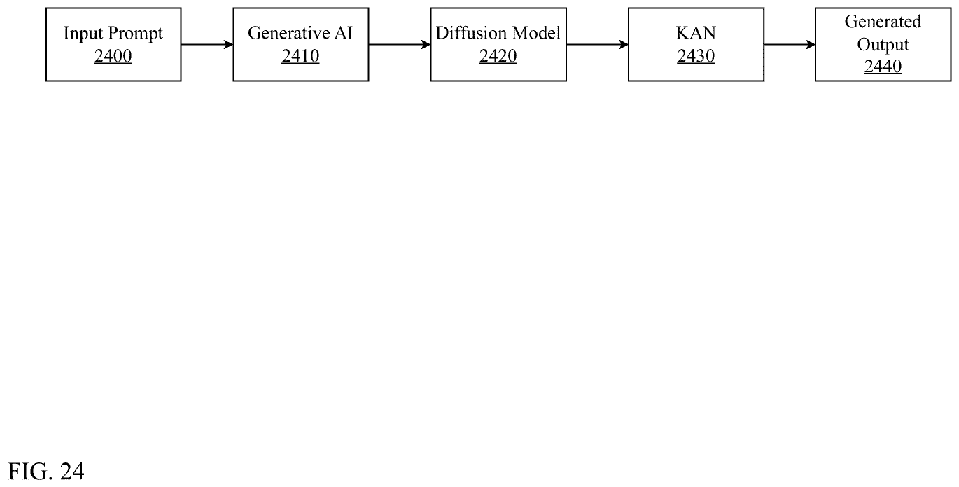

FIG. 24 is a block diagram illustrating an exemplary aspect of an embodiment of an artificial intelligence-powered large-scale content generator, where the adaptive content generator incorporates a Knowledge-Augmented Network (KAN). In one embodiment, an input prompt 2400 is passed through a generative AI module 2410. The input prompt 2400 which represents the user's desired content or the specific task they want the system to perform. This prompt could be in the form of text, images, or a combination of both, depending on the nature of the content generation task. The Generative AI component leverages state-of-the-art deep learning techniques and architectures to process the input and generate initial content representations.

To produce higher quality generated outputs, after being processed by the generative AI module 2410, the input prompts 2400 may be further processed by a diffusion model 2420 and a Knowledge-Augmented Network (KAN) 2430. The Diffusion Model 2420 is a powerful generative model that excels at creating high-quality images or other visual content. It takes the input prompt and generates an initial visual representation by iteratively refining a noise signal until it converges to a coherent and realistic image that aligns with the prompt. Diffusion Models have shown remarkable results in tasks such as image synthesis, style transfer, and super-resolution.

The Knowledge-Augmented Network (KAN) 2430 is a neural network architecture that incorporates external knowledge sources to enhance the content generation process. KANs are designed to integrate structured or unstructured knowledge, such as knowledge graphs, databases, or expert systems, into the model's reasoning and generation capabilities. In this system, the KAN 2430 works in tandem with the Diffusion Model 2420 to augment the generated content with relevant knowledge and contextual information. The KAN can provide domain-specific facts, commonsense reasoning, or semantic understanding to guide the Diffusion Model in generating more accurate, coherent, and contextually appropriate visual content.

The interaction between the Diffusion Model and the KAN is iterative and bidirectional. The Diffusion Model generates initial visual content based on the input prompt, which is then refined and enhanced by the KAN's knowledge integration. The KAN can provide feedback and guidance to the Diffusion Model, helping it to align the generated content with the relevant knowledge and constraints. Through this collaborative process, the Generative AI component produces a high-quality generated output 2440 that combines the visual fidelity and realism of the Diffusion Model with the knowledge-augmented coherence and contextual relevance provided by the KAN. The generated output 2440 can take various forms depending on the specific content generation task. It could be a complete image, a portion of an image, or even a sequence of images that tell a coherent story or convey a specific concept. The output is the culmination of the input prompt, the generative capabilities of the Diffusion Model, and the knowledge-augmented refinement provided by the KAN.

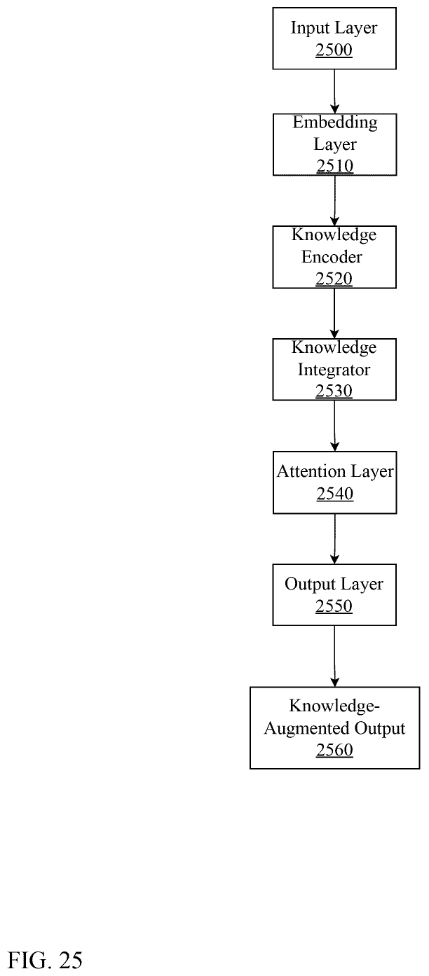

FIG. 25 is a block diagram illustrating an aspect of an artificial intelligence-powered large-scale content generator, a Knowledge-Augmented Network (KAN). The KAN architecture begins with an input layer 2500 that receives the query or prompt that needs to be processed. This input can be in various forms, such as text, images, or structured data, depending on the specific task and domain. The input layer is responsible for handling and preprocessing the input data to make it suitable for further processing by the subsequent layers. From the input layer, the preprocessed data flows into an embedding layer 2510, which converts the input into a dense vector representation. This layer aims to capture the semantic meaning and contextual information of the input query. It can utilize pre-trained word embeddings or learn task-specific embeddings to map the input into a continuous vector space, allowing the KAN to work with a more compact and meaningful representation of the input query.

The embedded input query is then passed to a knowledge encoder 2520, which is responsible for processing and encoding the relevant knowledge sources that will be used to augment the input query. The knowledge encoder takes the knowledge sources, such as knowledge graphs, databases, or expert systems, and converts them into a vector representation. It can employ various techniques, such as graph neural networks (GNNs) or transformer-based architectures, to capture the structure and semantics of the knowledge, creating a rich and informative representation that can be effectively integrated with the input query. The encoded input query from the embedding layer 2510 and the encoded knowledge representation from the knowledge encoder 2520 are then combined in a knowledge integrator 2530. This component fuses the query and knowledge representations in a meaningful way, allowing the KAN to leverage the relevant knowledge to enhance the input query. The knowledge integrator can utilize techniques like concatenation, attention mechanisms, or cross-attention to effectively merge the query and knowledge representations, enabling the KAN to incorporate the knowledge into the processing of the input query and provide additional context and information.

The integrated representation from the knowledge integrator 2530 then passes through a plurality of attention layers 2540, which determines the importance and relevance of different parts of the integrated representation. It computes attention weights that indicate which aspects of the query and knowledge are most relevant for generating the final output. The attention layer can employ various attention mechanisms, such as self-attention, multi-head attention, or hierarchical attention, to selectively focus on different parts of the input and knowledge. By assigning higher weights to the most relevant information, the attention layer helps the KAN prioritize and emphasize the key aspects of the query and knowledge for generating the knowledge-augmented output.

The attended representation from the plurality of attention layers 2540 is processed by an output layer 2550 to generate a final knowledge-augmented output 2560. The specific form of the output depends on the task and domain, such as text generation, classification, or regression. The output layer can utilize various techniques, such as softmax classification, language modeling, or sequence generation, to produce the desired output format. The knowledge-augmented output incorporates the relevant knowledge and provides a more accurate, informative, and contextually relevant response to the input query.

The KAN architecture shown in this figure demonstrates a modular and flexible approach to integrating knowledge into the content generation process. Each layer and component plays a specific role in processing the input query, encoding and integrating knowledge, and generating the final knowledge-augmented output. The modular nature of this architecture allows for flexibility and adaptability in incorporating different types of knowledge sources and tailoring the KAN to specific tasks and domains. By leveraging external knowledge sources and employing attention mechanisms, the KAN can generate outputs that are not only contextually relevant but also informed by domain-specific facts and reasoning capabilities. This architecture showcases the power of combining deep learning techniques with knowledge integration to enhance the content generation process and produce more accurate, informative, and contextually relevant outputs.

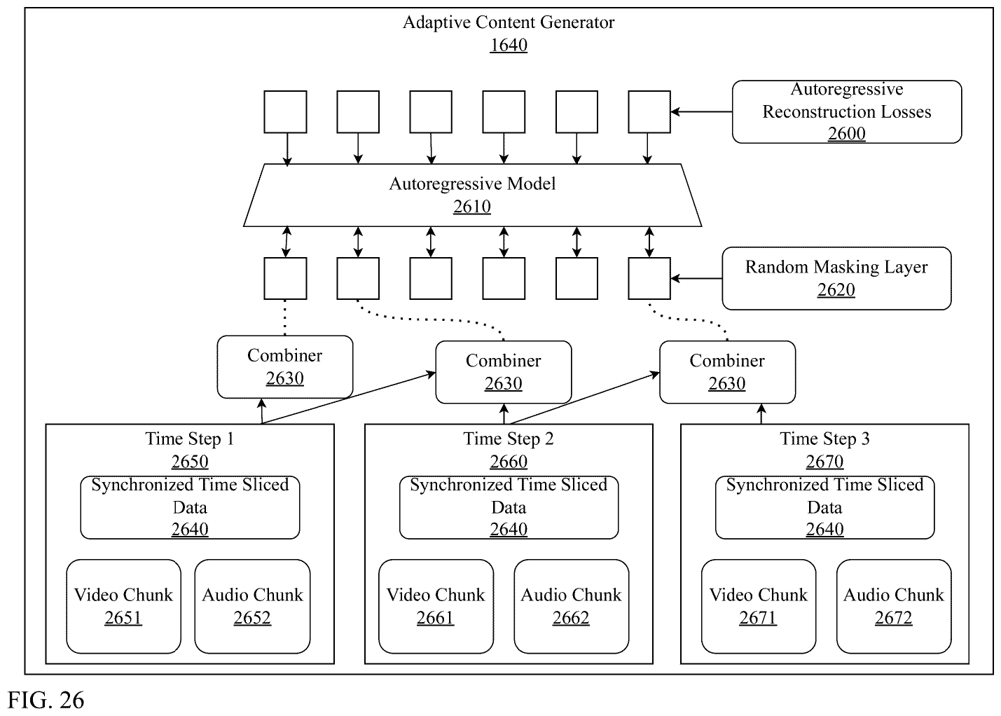

FIG. 26 is a block diagram illustrating an exemplary aspect of an embodiment of an artificial intelligence-powered large-scale content generator with spatiotemporal indexing. The input to the system is synchronized time-sliced data 2640, which may contain both video and audio chunks for each time step. The data is divided into multiple time steps each representing a specific temporal segment of the video and audio content. Each time step includes a video chunk and a corresponding audio chunk capturing the visual and auditory information for that particular time segment. A random masking layer 2620 is introduced to facilitate spatiotemporal indexing and enable the system to learn robust representations. During training, the random masking layer randomly masks out a portion of the video and audio chunks across different time steps. The masking process can involve setting the masked regions to zero or replacing them with random noise. The purpose of random masking is to encourage the system to learn to reconstruct the missing information based on the available spatiotemporal context.

A combiner module 2630 is responsible for integrating the video and audio chunks at each time step, taking into account the spatial and temporal dependencies. The combiner can be implemented using various techniques, such as attention mechanisms, convolutional neural networks, or transformer architectures. The combiner processes the masked video and audio chunks and learns to combine them effectively, considering the spatiotemporal relationships within and across time steps. The output of the combiner represents a fused representation that captures the integrated video and audio information for each time step.

An autoregressive model 2610 is employed to capture the temporal dependencies and generate coherent content across time steps. It takes the output of the combiner for each time step and models the sequential nature of the video and audio data. The autoregressive model can be implemented using recurrent neural networks (RNNs), such as LSTMs or GRUs, or using transformer-based architectures with causal masking. The autoregressive model learns to predict the next time step's video and audio chunks based on the previous time steps' information, enabling the generation of temporally consistent content. Autoregressive reconstruction losses 2600 are used to train the system to reconstruct the original video and audio chunks based on the spatiotemporal context. The reconstruction losses compare the generated video and audio chunks with the original unmasked chunks at each time step. Common reconstruction loss functions, such as mean squared error (MSE) or mean absolute error (MAE), can be employed. The autoregressive nature of the reconstruction losses ensures that the system learns to generate content that is consistent with the previous time steps and maintains temporal coherence.

Spatiotemporal indexing works by leveraging the random masking layer and autoregressive reconstruction losses 2600 to capture and utilize the spatial and temporal dependencies within the synchronized time-sliced data. The random masking layer introduces spatial and temporal gaps in the input data, forcing the system to learn to fill in the missing information based on the available context. By reconstructing the masked regions, the system learns to capture the spatiotemporal relationships and generate content that is coherent and contextually relevant. During training, the system is presented with masked video and audio chunks at each time step. The combiner module integrates the masked chunks, considering the spatial and temporal dependencies, and produces a fused representation. The autoregressive model then generates the next time step's video and audio chunks based on the previous time steps' information, ensuring temporal consistency. The autoregressive reconstruction losses guide the system to reconstruct the original unmasked chunks, encouraging it to learn the spatiotemporal patterns and generate coherent content.

At inference time, the system can generate novel video and audio content by providing an initial set of time steps and iteratively generating subsequent time steps using the trained autoregressive model. The generated content will maintain spatiotemporal coherence and consistency, as the system has learned to capture and utilize the spatial and temporal dependencies during training. The spatiotemporal indexing achieved through this architecture enables the adaptive content generator to create content that is not only visually and auditorily coherent but also temporally consistent and contextually relevant. By learning to reconstruct missing information based on the available spatiotemporal context, the system can generate content that seamlessly integrates the video and audio modalities across time, resulting in more natural and engaging multimedia experiences.

Furthermore, the spatiotemporal indexing capability allows for efficient retrieval and manipulation of specific spatial and temporal regions within the generated content. The system can index and access specific video and audio segments based on their spatial and temporal coordinates, enabling applications such as content editing, summarization, and recommendation. Overall, the expanded architecture with autoregressive reconstruction losses and random masking layer enhances the adaptive content generator's ability to capture and utilize spatiotemporal dependencies, enabling the generation of coherent and contextually relevant multimedia content. The spatiotemporal indexing achieved through this architecture opens up new possibilities for content creation, manipulation, and retrieval, empowering users to explore and interact with the generated content in more meaningful and intuitive ways.

The architecture of the adaptive content generator, with or without its ability to capture and utilize spatiotemporal dependencies, can be leveraged to generate immersive and dynamic video game environments. By training the system on a diverse range of video game data, including game mechanics, characters, environments, and storylines, it can learn to create novel and engaging game experiences that blend elements from different sources.

One application of this system is the generation of “mashup” video game environments that combine characters, settings, and storylines from various game franchises or even other media, such as books or movies. For example, imagine playing a Grand Theft Auto-style game where your favorite book characters are integrated into the game world. The system can generate a seamless fusion of the open-world mechanics of Grand Theft Auto with the personalities, abilities, and narratives of the book characters. You could explore a vast city while interacting with characters from your favorite novels, experiencing a unique and personalized gaming experience.

Another possibility is the creation of crossover game environments that bring together elements from different video game universes. Picture a mashup of Horizon Zero Dawn and Titanfall, where the post-apocalyptic world of Horizon is invaded by the advanced robotic warfare of Titanfall. The adaptive content generator can generate a coherent and immersive game environment that combines the stunning landscapes and tribal societies of Horizon with the high-tech Titans and fast-paced combat of Titanfall. The system can generate missions, encounters, and storylines that intertwine the narratives of both games, creating a fresh and exciting gaming experience.

The spatiotemporal indexing capabilities of the system enable the generation of dynamic and responsive game environments that adapt to the player's actions and choices. The system can generate content on the fly, ensuring that the game world remains consistent and coherent as the player progresses through the game. It can generate new areas, quests, and characters based on the player's decisions and playstyle, providing a personalized and immersive gaming experience.

Furthermore, the system's ability to generate content based on user preferences and feedback opens up possibilities for user-generated content within video games. Players can input their own ideas, characters, or storylines, and the system can generate custom game environments that incorporate those elements. This allows for a new level of player involvement and creativity, enabling players to shape their own unique gaming experiences.

Overall, the architecture of the adaptive content generator has the potential to revolutionize video game development by enabling the creation of dynamic, immersive, and personalized game environments. The ability to generate “mashup” and crossover game experiences, combining elements from different sources, offers endless possibilities for creative and engaging gameplay. With the power of spatiotemporal indexing and user-driven content generation, this system can redefine the boundaries of video game design and deliver unparalleled gaming experiences to players.

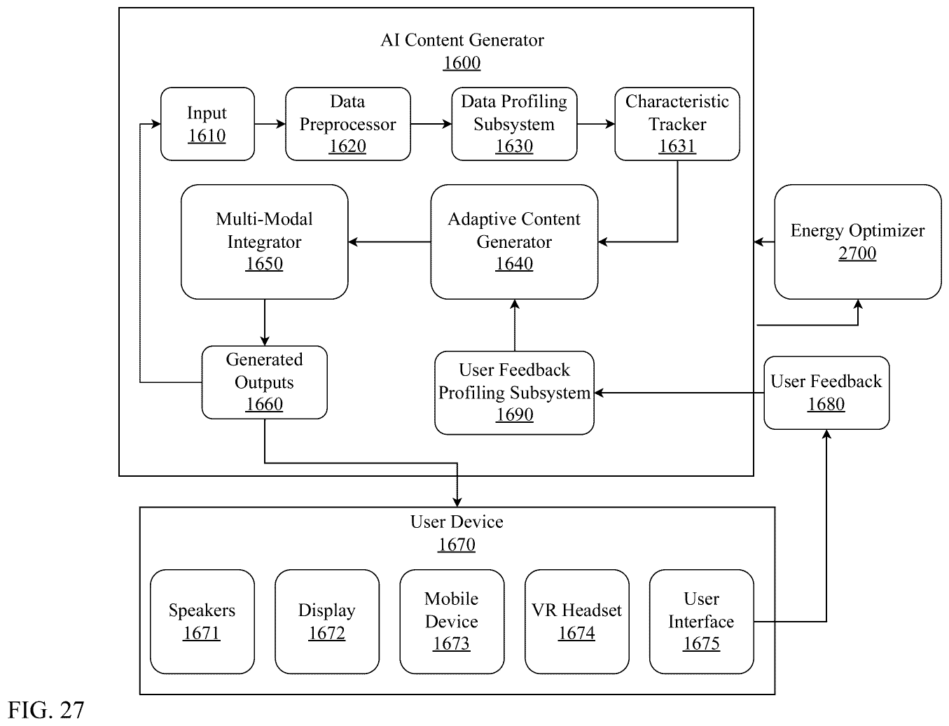

FIG. 27 is a block diagram illustrating an exemplary aspect of an embodiment of an artificial intelligence-powered large-scale content generator with energy optimization. An energy optimizer is a key component that works in conjunction with other subsystems to minimize energy consumption while maintaining the quality and performance of the generated outputs. The AI content generator receives user input 1610 through a user interface 1675. The input data undergoes preprocessing in the data preprocessor 1620 to clean, normalize, and prepare it for further analysis. The preprocessed data is then passed to the data profiling subsystem 1630, which extracts relevant features, identifies patterns, and creates a structured representation of the input data. The characteristic tracker 1631 within the data profiling subsystem 1630 keeps track of important characteristics and ensures consistency throughout the content generation process.

An energy optimizer 2700 plays a role in optimizing the energy consumption of the AI content generator. It continuously monitors and analyzes the energy usage of various components within the system. By collecting real-time data on power consumption, computational load, and resource utilization, the Energy Optimizer identifies energy-intensive tasks and opportunities for optimization. The energy optimizer 2700 works closely with the adaptive content generator 1640 to implement energy-efficient algorithms and techniques. It optimizes the allocation of computational resources, such as GPUs and memory, based on the energy profiles and requirements of different tasks. The Energy Optimizer also explores energy-aware model architectures and techniques like model compression and quantization to reduce the computational complexity and power consumption of the content generation models.

In collaboration with the multi-modal integrator 1650, the energy optimizer 2700 ensures that the generated outputs are delivered efficiently to the user devices 1670. It implements adaptive content delivery mechanisms that dynamically adjust the quality and resolution of the generated content based on the target device capabilities and network conditions. This optimization minimizes energy consumption during content distribution while maintaining a satisfactory user experience. The energy optimizer 2700 may also incorporate user feedback 1680 and preferences related to energy efficiency. It collects and analyzes user feedback through the user feedback profiling subsystem 1690 to refine its energy optimization strategies. By continuously learning from user interactions and adapting its algorithms, the energy optimizer 2700 ensures that the AI content generator operates in an energy-efficient manner while meeting user expectations.

Through the integration of the energy optimizer 2700, the AI content generator system achieves a balance between energy efficiency and high-quality content generation. It dynamically adapts its processing pipelines, resource allocation, and content delivery mechanisms to minimize energy consumption without compromising the visual and auditory quality of the generated outputs. This enables the system to operate sustainably and reduce its environmental impact while delivering engaging and immersive content to users through various devices.

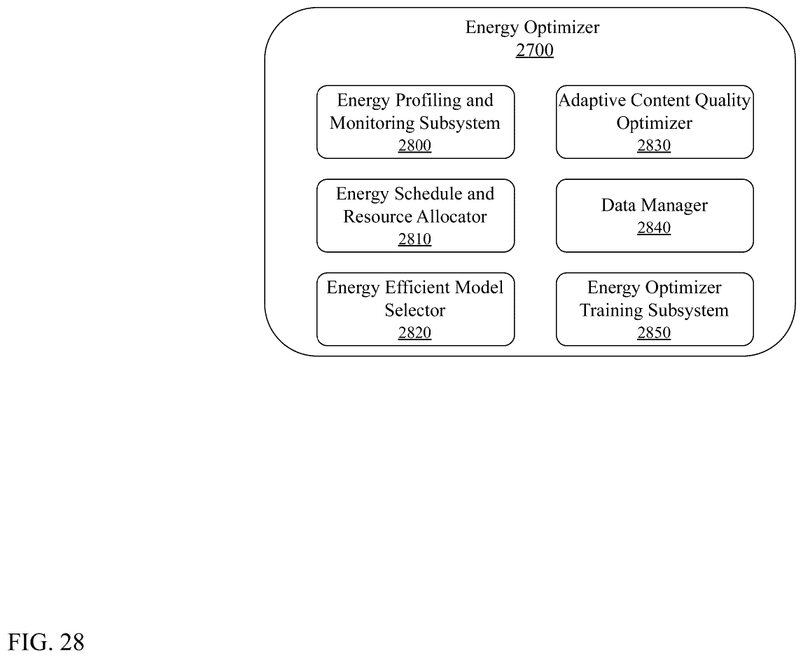

FIG. 28 is a block diagram illustrating an aspect of an artificial intelligence-powered large-scale content generator, an energy optimizer. The energy optimizer 2700 is responsible for minimizing energy consumption while maintaining the quality and performance of the content generation process. It consists of several interconnected subsystems that work together to achieve energy efficiency.

At the core of the energy optimizer 2700 is an energy profiling and monitoring subsystem 2800. This subsystem continuously monitors and collects real-time data on the energy consumption, computational load, and resource utilization of various components within the AI Content Generator. It employs advanced profiling techniques and energy measurement frameworks to accurately assess the energy footprint of different tasks and processes. The collected data is analyzed to identify energy-intensive operations, bottlenecks, and opportunities for optimization.

An energy schedule and resource allocator 2810 optimizes the allocation of computational resources based on the energy profiles and requirements of different tasks. It implements intelligent scheduling algorithms that consider energy efficiency alongside performance and resource availability. By dynamically assigning tasks to the most energy-efficient resources, such as low-power GPUs or specialized AI accelerators, the energy schedule and resource allocator 2810 minimizes overall energy consumption while ensuring optimal utilization of available resources.

An energy efficient model selector 2820 focuses on identifying and selecting the most energy-efficient AI models for content generation. It explores a wide range of model architectures, including compact and lightweight models that strike a balance between performance and energy efficiency. The model selector 2820 may employ techniques such as neural architecture search, model compression, and quantization to reduce the computational complexity and memory footprint of the models without compromising their accuracy or quality. By carefully selecting energy-efficient models, the energy optimizer 2700 significantly reduces the power consumption associated with content generation.

An adaptive content quality optimizer 2830 dynamically adjusts the quality and resolution of the generated content based on the target device capabilities, network conditions, and user preferences. It implements adaptive content delivery mechanisms that optimize the trade-off between energy consumption and visual/auditory quality. By intelligently scaling the content resolution, applying efficient compression techniques, and leveraging device-specific optimizations, the adaptive content quality optimizer minimizes 2830 energy consumption during content distribution while ensuring a satisfactory user experience across various devices.

A data manager 2840 is responsible for optimizing data storage, retrieval, and processing operations to minimize energy consumption. It implements energy-aware data management techniques, such as data compression, deduplication, and intelligent caching, to reduce the storage footprint and minimize data movement. The data manager 2840 also employs energy-efficient data processing algorithms and frameworks to minimize the computational overhead associated with data handling. By optimizing data management, the Energy Optimizer reduces the energy consumption associated with data-intensive tasks in the content generation pipeline.

An energy optimizer training subsystem 2850 is dedicated to continuously training and updating the energy optimization models and algorithms. It may utilize the collected energy profiles, user feedback, and performance metrics to fine-tune the energy optimization strategies. The training subsystem 2850 employs machine learning techniques to learn patterns, predict energy consumption, and adapt the optimization algorithms based on real-world usage scenarios. Through continuous learning and adaptation, the energy optimizer 2700 may stay up-to-date with the latest energy-efficient techniques and ensures optimal performance in dynamic environments.

The energy optimizer 2700 is a comprehensive subsystem that integrates various energy optimization techniques across the entire content generation pipeline. By combining energy profiling, intelligent resource allocation, energy-efficient model selection, adaptive content quality optimization, and data management, the energy optimizer 2700 significantly reduces the energy consumption of the AI content generator system. It enables the system to operate in a sustainable and environmentally friendly manner while delivering high-quality content to users.

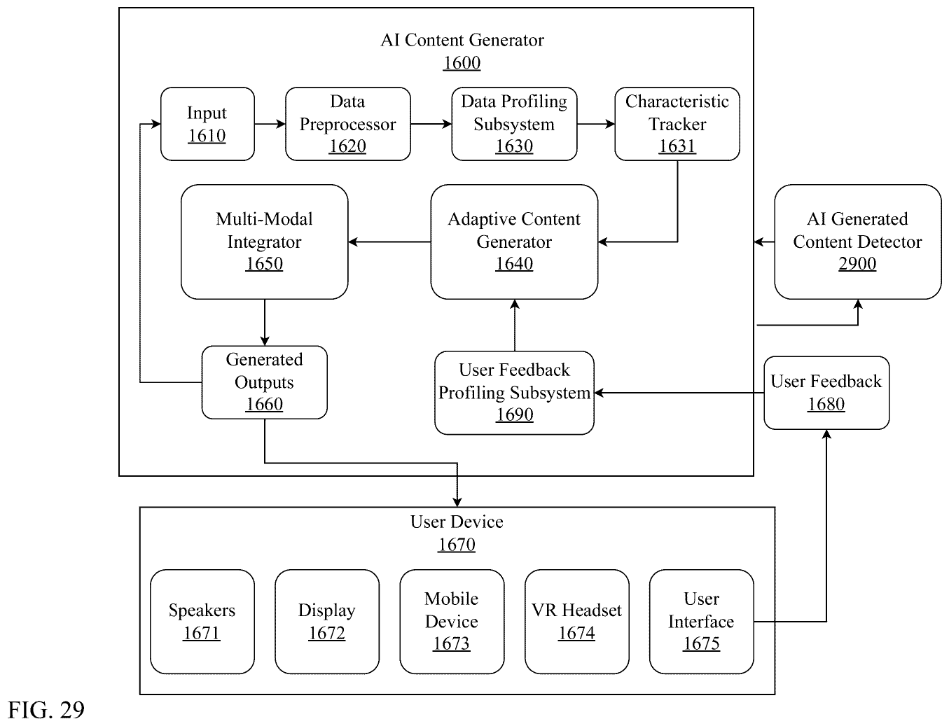

FIG. 29 is a block diagram illustrating an exemplary aspect of an embodiment of an artificial intelligence-powered large-scale content generator with AI generated content detection. Illustrated is an AI content generator system 1600 that incorporates an AI generated content detector 2900 to identify and distinguish AI-generated content from human-created or real-world content. The AI generated content detector is a component that enhances the system's ability to manage and process generated content effectively.

The AI content generator receives user input 1610 through a user interface 1675. The input data undergoes preprocessing in the data preprocessor 1620 to clean, normalize, and prepare it for further analysis. The preprocessed data is then passed to the data profiling subsystem 1630, which extracts relevant features, identifies patterns, and creates a structured representation of the input data. The characteristic tracker 1631 within the data profiling subsystem 1630 keeps track of important characteristics and ensures consistency throughout the content generation process.

The adaptive content generator 1640 may utilize advanced AI and machine learning techniques to generate high-quality content based on the profiled input data. It employs various generative models, such as Generative Adversarial Networks (GANs), Variational Autoencoders (VAEs), and Transformer-based architectures, to create realistic and diverse content across different modalities, including text, images, audio, and video.

An AI generated content detector 2900 plays a role in analyzing the generated content and determining whether it was created by AI algorithms or originated from human creators or real-world sources. The detector employs sophisticated techniques, such as deep learning-based classification models, statistical analysis, and pattern recognition, to identify unique characteristics and artifacts associated with AI-generated content.

The AI generated content detector 2900 examines various aspects of the generated content, including visual features, linguistic patterns, audio signatures, and metadata, to make accurate determinations. It compares the generated content against vast databases of human-created and real-world content to identify similarities, anomalies, and distinguishing features. The detector also leverages advanced algorithms to detect potential manipulations, such as deepfakes or synthetic media, ensuring the integrity and authenticity of the generated content.

By accurately identifying AI-generated content, the AI generated content detector 2900 enables the system to handle and process such content differently from human-created or real-world content. This distinction is crucial for various purposes, such as content filtering, attribution, licensing, and ensuring compliance with legal and ethical guidelines. The detector's output can be used to tag and label the generated content, providing transparency and enabling appropriate handling and distribution.

The AI Generated Content Detector continuously learns and updates its models based on new data and advancements in AI content generation techniques. It stays up-to-date with the latest research and best practices in the field, ensuring its effectiveness in identifying AI-generated content accurately.

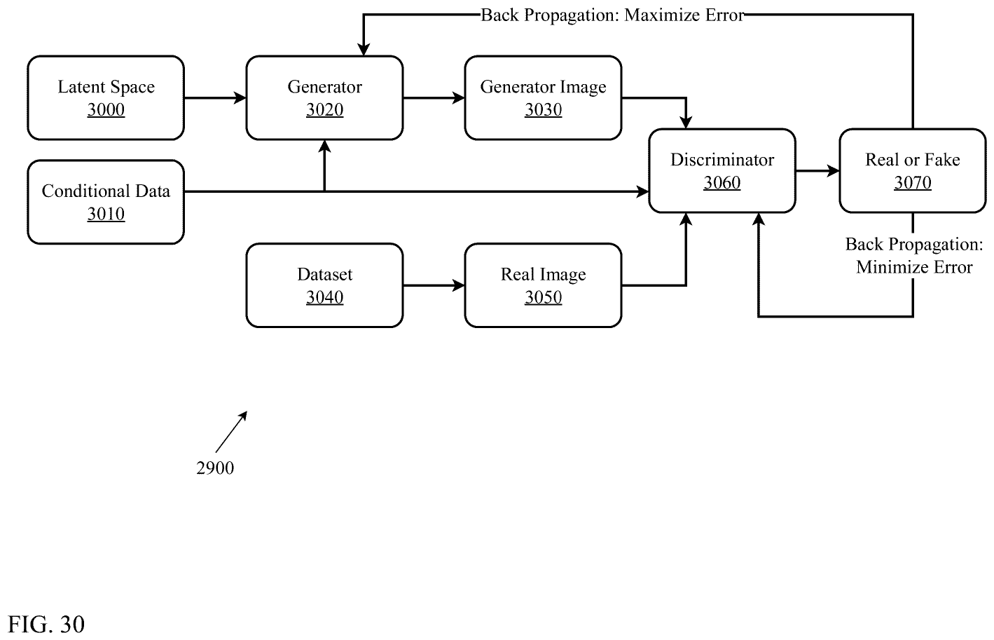

FIG. 30 is a block diagram illustrating an aspect of an artificial intelligence-powered large-scale content generator, an AI generated content detector 2900. According to various embodiments, a generator network 3020 is a fundamental component of the system for identifying generated content. It is responsible for creating realistic and coherent frames or video sequences based on the input conditions and random noise. The generator network learns to map the input space to the output space, effectively capturing the complex distribution of the training data and generating novel content that resembles the real data.

According to an aspect, generator network 3020 is typically implemented as a deep convolutional neural network (CNN) architecture. The specific architecture varies depending on the chosen GAN variant and the requirements of the scene continuity task. Popular architectures for video generation include 3D CNNs, which can capture both spatial and temporal dependencies, and 2D CNNs combined with recurrent neural networks (RNNs) to model temporal dynamics.

The generator network 3020 takes a random noise vector as input, which serves as a latent representation of the generated content. The noise vector is typically sampled from a standard distribution (e.g., latent space 3000), such as a Gaussian or uniform distribution, and has a fixed dimensionality. This random noise introduces stochasticity into the generation process, enabling the generator to produce diverse and varied outputs.

According to an aspect, generator network 3020 consists of a series of convolutional layers that progressively upsample and transform the input noise and conditional information into the desired output resolution. The convolutional layers learn hierarchical features that capture the spatial and temporal patterns present in the training data. Activation functions, such as ReLU or leaky ReLU, are applied after each convolutional layer to introduce non-linearity and enable the network to learn complex mappings.

To ensure the stability and quality of the generated content 3030, various techniques may be implemented in the generator network. Normalization layers, such as batch normalization or instance normalization, can be used to normalize the activations and improve the training dynamics. Skip connections, as used in architectures like U-Net or ResNet, allow the network to propagate information across different scales and help in preserving fine details.

The generator network is trained adversarially alongside the discriminator network 3060. During training, the generator aims to fool the discriminator by producing realistic and coherent content that is indistinguishable from real data. The generator's loss function is designed to optimize the quality and realism of the generated frames or video sequences. Common loss functions include the adversarial loss, which encourages the generator to produce samples that are classified as real by the discriminator, and the perceptual loss, which measures the similarity between the generated content and the ground truth 3050 based on high-level features extracted from a pre-trained CNN.

Consider an example scenario where the generator network 3020 is used to generate scene continuity for a video sequence of a person walking in a park. The input to the generator may be a random noise vector concatenated with conditional information, such as the keyframes of the person at different time steps and the desired camera angles. The generator network would process this input through a series of convolutional layers, gradually upsampling and refining the representation to generate realistic frames of the person walking.

The generated frames would capture the appearance, motion, and coherence of the original video sequence. The generator network would learn to synthesize realistic textures, preserve the identity of the person across frames, and maintain temporal consistency in the generated video. By incorporating the conditional information, the generator can control the generated content, ensuring that the person's movements align with the provided keyframes and that the camera angles match the specified viewpoints.

During training, the generator network iteratively updates its parameters based on the feedback from the discriminator and the optimization of the loss functions. The goal is to minimize the adversarial loss, making the generated frames indistinguishable from real frames, and to minimize the perceptual loss, ensuring that the generated content closely resembles the ground truth.

Once trained, generator network 3020 can be used to generate novel scene continuity by providing new random noise vectors and conditional information. It can interpolate between keyframes to create smooth transitions, synthesize new camera angles, and generate coherent video sequences that maintain the style and content of the original data.

The effectiveness of the generator network relies on its ability to learn meaningful representations, capture the underlying data distribution, and generate high-quality and diverse samples. The choice of architecture, loss functions, and training techniques plays an important role in the performance and stability of the generator.

By leveraging the power of deep learning and adversarial training, GAN enables the system to generate visually compelling and temporally coherent scene continuity. It opens up new possibilities for creative content generation, visual effects, and immersive experiences in the field of visual media production.

According to various embodiments, the discriminator network 3060 is a fundamental component of the system for generating scene continuity in visual media, playing a role in the adversarial training process of the generative adversarial network (GAN). The primary purpose of the discriminator is to distinguish between real 3050 and generated frames or video sequences 3030 (e.g., a sequence of semantic segmentation masks), providing feedback to the generator network to improve the quality and realism of the generated content.

According to an aspect, discriminator network 3060 may be implemented as a deep convolutional neural network (CNN) architecture, designed to process and classify input frames or video sequences. The specific architecture of the discriminator may vary depending on the chosen GAN variant and the requirements of the scene continuity task. Common architectures for video discrimination include 3D CNNs, which can capture both spatial and temporal dependencies, and 2D CNNs combined with recurrent neural networks (RNNs) to model temporal dynamics.

The input to the discriminator network may be either a real frame/video sequence from the training dataset 3040 or a generated frame/video sequence produced by generator network 3020. The discriminator processes this input through a series of convolutional layers, which learn to extract hierarchical features that capture the spatial and temporal patterns present in the data. The convolutional layers are often followed by activation functions, such as ReLU or leaky ReLU, to introduce non-linearity and enable the network to learn complex decision boundaries.

As the input progresses through the layers of the discriminator, the spatial dimensions are gradually reduced while the number of feature channels increases. This allows the discriminator to capture both local and global information from the input data. Pooling layers, such as max pooling or average pooling, can be used to downsample the feature maps and provide translation invariance.

To enhance the discriminator's ability to capture temporal dependencies and coherence in video sequences, techniques such as 3D convolutions or recurrent neural networks can be employed. 3D convolutions operate on the spatial and temporal dimensions simultaneously, allowing the discriminator to learn spatio-temporal features. Recurrent neural networks, such as long short-term memory (LSTM) or gated recurrent units (GRU), can be used to model the temporal dynamics and capture long-range dependencies in the video sequences.

The output of the discriminator network is typically a single scalar value, representing the probability or likelihood of the input being real or generated 3070. The discriminator is trained to assign high probabilities to real frames/sequences and low probabilities to generated ones. This is achieved by minimizing a loss function, such as the binary cross-entropy loss, which measures the discrepancy between the predicted probabilities and the ground truth labels.

During training, the discriminator and generator networks are trained alternately in an adversarial manner. The discriminator 3060 aims to accurately classify real and generated samples, while the generator 3020 tries to fool the discriminator by producing realistic and coherent content. The training process involves optimizing the parameters of both networks simultaneously, with the goal of reaching an equilibrium where the generator produces samples that are indistinguishable from real data.

Consider an example scenario where the discriminator network is used in the context of generating scene continuity for a video sequence of a person walking in a park. The discriminator receives both real video sequences of people walking and generated video sequences produced by the generator network. For each input video sequence, the discriminator processes the frames through its convolutional layers, extracting spatial and temporal features that capture the appearance, motion, and coherence of the person's movements. The discriminator learns to distinguish between the real and generated sequences based on the learned features and patterns. The discriminator assigns high probabilities to the real video sequences, recognizing them as authentic and coherent. On the other hand, it assigns low probabilities to the generated sequences that exhibit artifacts, inconsistencies, or unrealistic movements. The feedback from the discriminator is used to update the generator network, encouraging it to produce more realistic and temporally coherent video sequences. As the training progresses, the discriminator becomes increasingly skilled at identifying the subtle differences between real and generated sequences, while the generator improves its ability to generate convincing and coherent scene continuity. The adversarial training process continues until the generated sequences become nearly indistinguishable from the real ones, indicating that the generator has learned to capture the underlying distribution of the training data.

The effectiveness of the discriminator network relies on its capacity to learn meaningful and discriminative features, its ability to generalize unseen data, and its robustness to various forms of generated content. The choice of architecture, loss functions, and training techniques plays an important role in the performance and stability of the discriminator.

By leveraging the power of deep learning and adversarial training, the discriminator network serves as a critical component in the system for generating scene continuity. It provides the necessary feedback and guidance to the generator, enabling the production of visually compelling and temporally coherent video sequences. The discriminator's ability to distinguish between real and generated content helps ensure the quality and realism of the generated scene continuity, enhancing the overall effectiveness of the system in visual media production.

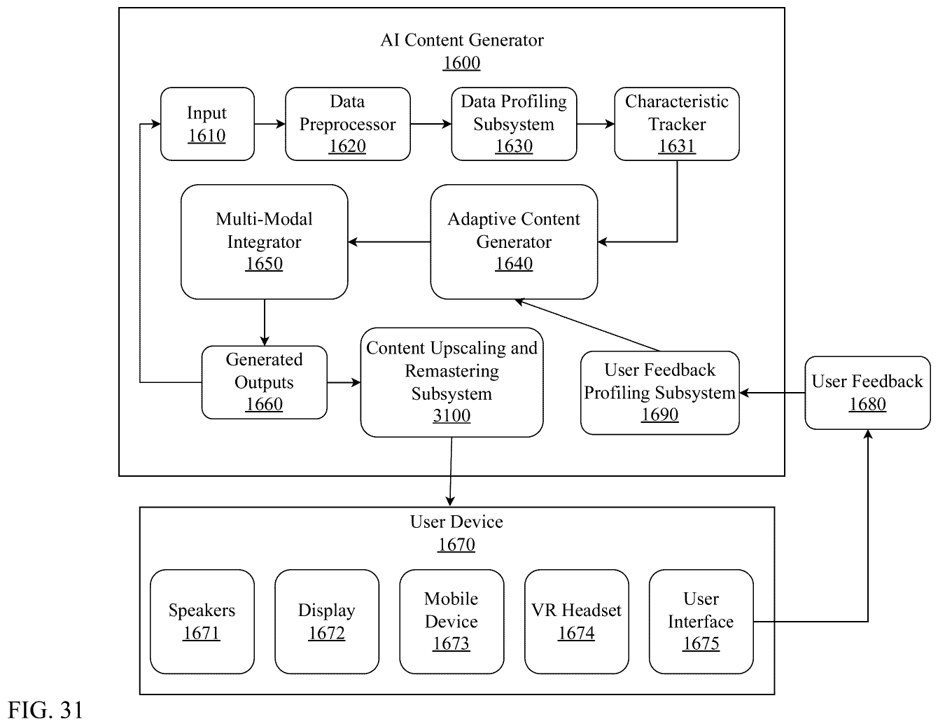

FIG. 31 is a block diagram illustrating an exemplary aspect of an embodiment of an artificial intelligence-powered large-scale content generator with a content upscaling and remastering subsystem. In one embodiment, the AI content generator system 1600 incorporates a content upscaling and remastering subsystem 3100 to enhance the quality and resolution of the generated content. This subsystem is designed to improve the visual and auditory fidelity of the output, ensuring a more immersive and engaging user experience.

The AI Content Generator receives user input 1610 through a user interface 1675. The input data is preprocessed by the data preprocessor 1620 to clean, normalize, and prepare it for further analysis. The data profiling subsystem 1630 then extracts relevant features, identifies patterns, and creates a structured representation of the input data. The characteristic tracker 1631 within the data profiling subsystem 1630 keeps track of important characteristics and ensures consistency throughout the content generation process.

The adaptive content generator 1640 utilizes advanced AI and machine learning techniques to generate high-quality content based on the profiled input data. It employs various generative models, such as Generative Adversarial Networks (GANs), Variational Autoencoders (VAEs), and Transformer-based architectures, to create diverse and realistic content across different modalities, including text, images, audio, and video.

A content upscaling and remastering subsystem 3100 plays a role in enhancing the quality and resolution of the generated content. It applies state-of-the-art techniques to improve the visual and auditory fidelity of the output, ensuring a more immersive and engaging user experience. For visual content, such as images and videos, the content upscaling and remastering subsystem 3100 may employ advanced super-resolution algorithms and deep learning models to increase the spatial resolution and enhance the details of the generated content. These techniques can effectively upscale low-resolution images and videos to higher resolutions while preserving sharpness, texture, and overall quality. The subsystem may utilize techniques like Generative Adversarial Networks (GANs), Convolutional Neural Networks (CNNs), or Transformer-based architectures specifically designed for image and video upscaling tasks.

In addition to spatial upscaling, the content upscaling and remastering subsystem 3100 may also apply advanced restoration and enhancement techniques to improve the visual quality of the generated content. It can remove artifacts, reduce noise, enhance colors, and optimize contrast to create visually stunning and realistic outputs. The subsystem may employ deep learning-based methods for tasks such as image denoising, color correction, and tone mapping to achieve optimal visual quality.

For audio content, the content upscaling and remastering subsystem 3100 focuses on enhancing the sound quality and fidelity of the generated audio. It applies advanced audio processing techniques, such as audio super-resolution, bandwidth extension, and noise reduction, to improve the clarity, richness, and immersiveness of the audio output. The subsystem may utilize deep learning models trained on large datasets of high-quality audio to learn the mapping between low-quality and high-quality audio representations.

The content upscaling and remastering subsystem 3100 works with the multi-modal integrator 1650 to ensure that the enhanced visual and auditory content is seamlessly integrated and synchronized across different modalities. The integrator takes into account the specific characteristics and requirements of each modality to create a coherent and immersive user experience.

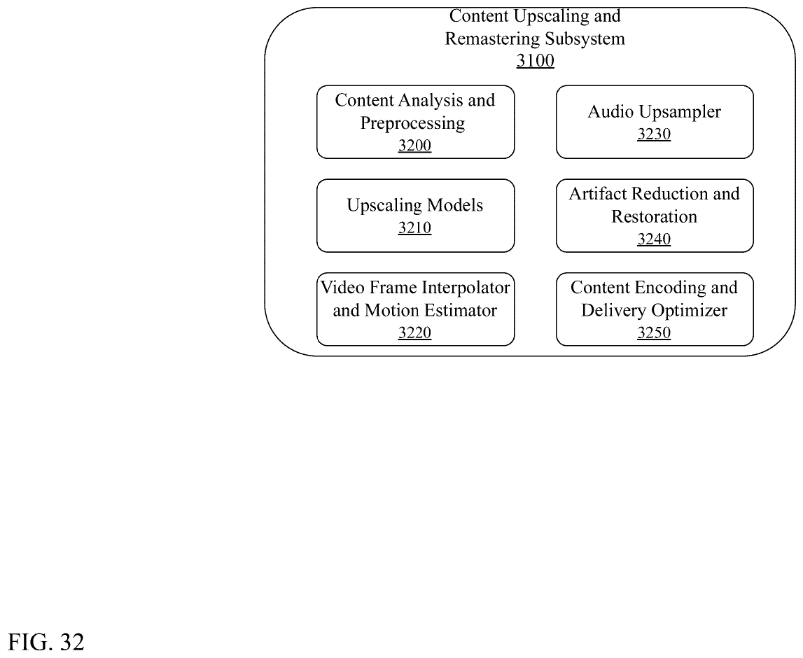

FIG. 32 is a block diagram illustrating an aspect of an artificial intelligence-powered large-scale content generator, a content upscaling and remastering subsystem. This subsystem is responsible for enhancing the quality and resolution of the generated content, ensuring a more immersive and visually/auditorily appealing user experience. It consists of several interconnected modules that work together to achieve optimal content upscaling and remastering results.

A content analysis and preprocessing module 3200 is the first stage of the content upscaling and remastering subsystem 3100. This module receives the generated content from the adaptive content generator and performs a comprehensive analysis to assess its quality, resolution, and potential for enhancement. It applies advanced preprocessing techniques to clean, normalize, and prepare the content for the subsequent upscaling and remastering stages. The preprocessing steps may include noise reduction, contrast enhancement, color space conversion, and format standardization to ensure optimal input for the following modules.

An upscaling models module 3210 is responsible for increasing the spatial resolution and enhancing the details of the visual content, such as images and videos. It employs state-of-the-art deep learning models specifically designed for super-resolution tasks. These models, such as Generative Adversarial Networks (GANs), Convolutional Neural Networks (CNNs), or Transformer-based architectures, are trained on large datasets of high-quality images and videos to learn the mapping between low-resolution and high-resolution representations. By applying these models, the Upscaling Models module can effectively upscale the generated content to higher resolutions while preserving sharpness, texture, and overall quality.

A video frame interpolator and motion estimator module 3220 focus on enhancing the temporal resolution and smoothness of video content. It may apply advanced frame interpolation techniques to generate intermediate frames between existing frames, increasing the frame rate and creating a more fluid and seamless video experience. The module utilizes motion estimation algorithms to accurately predict and compensate for motion between frames, ensuring coherent and consistent video upscaling. It may employ techniques such as optical flow estimation, frame blending, and temporal super-resolution to achieve high-quality video upscaling results.

An audio upsampler 3230 may be dedicated to enhancing the quality and fidelity of the generated audio content. It applies advanced audio processing techniques to increase the sampling rate, bit depth, and overall audio resolution. The module utilizes deep learning models trained on large datasets of high-quality audio to learn the mapping between low-quality and high-quality audio representations. It may employ techniques such as audio super-resolution, bandwidth extension, and spectral band replication to enhance the clarity, richness, and immersiveness of the audio output.

An artifact reduction and restoration module 3240 focuses on identifying and removing artifacts, noise, and distortions from the upscaled and remastered content. It applies advanced image and audio processing algorithms to detect and eliminate various types of artifacts, such as compression artifacts, ringing, and aliasing. The module may utilize deep learning-based methods for tasks such as image denoising, color correction, and audio declipping to achieve optimal visual and auditory quality. It also incorporates restoration techniques to repair any damage or degradation that may have occurred during the upscaling process, ensuring the integrity and fidelity of the final output.

A content encoding and delivery optimizer 3250 may be responsible for efficiently encoding and packaging the upscaled and remastered content for optimal delivery to user devices. It applies advanced compression techniques and adaptive bitrate streaming algorithms to ensure smooth and high-quality content delivery across various network conditions and device capabilities. The module may utilize state-of-the-art video and audio codecs, such as H.265/HEVC or AAC, to achieve efficient compression while maintaining visual and auditory quality. It also optimizes the content packaging and streaming protocols to minimize latency, reduce buffering, and provide a seamless user experience.

The content upscaling and remastering subsystem 3100 plays a role in enhancing the quality and resolution of the generated content, delivering a superior user experience. By leveraging advanced deep learning models, image and audio processing techniques, and optimization algorithms, this subsystem ensures that the AI-generated content meets the highest standards of visual and auditory fidelity, ultimately enhancing user satisfaction and engagement.

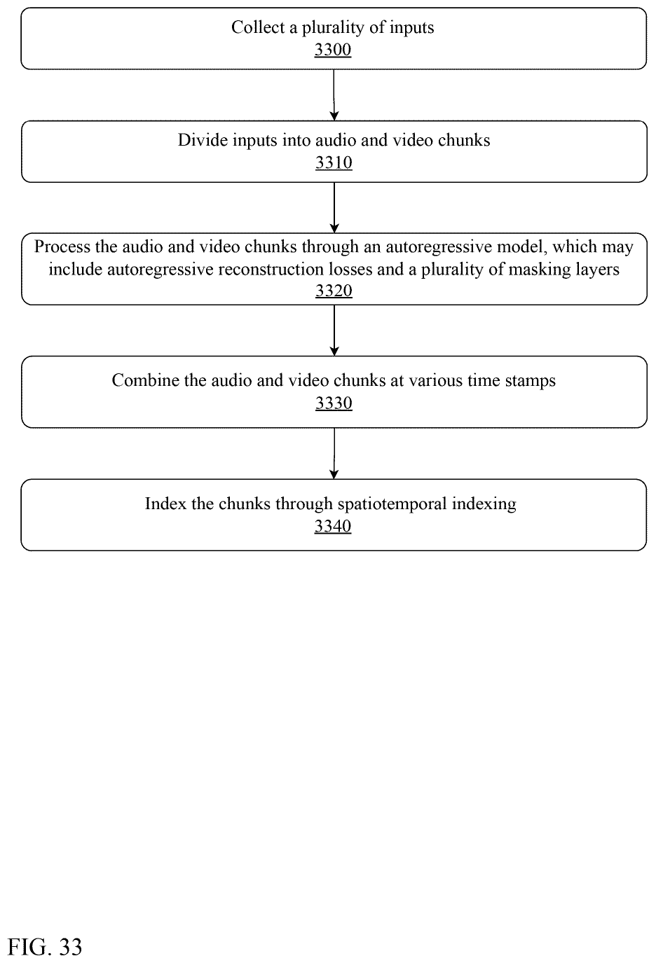

FIG. 33 is a flow diagram illustrating an exemplary method for indexing inputs and outputs of an AI-powered large scale content generator using spatiotemporal indexing. This method is designed to efficiently handle and synchronize multiple modalities, enabling effective analysis and generation of multimedia content. In a first step 3300, collect a plurality of inputs. This step involves gathering a diverse range of audio and video inputs from various sources, such as user-generated content, online platforms, or multimedia databases. It is important to ensure that the collected inputs cover a wide range of genres, styles, and content types to provide a representative dataset for training and processing.

In a step 3310, divide them into audio and video chunks. This involves segmenting the collected audio and video inputs into smaller, manageable chunks of fixed or variable duration. The chunking process allows for more efficient processing and enables the model to capture local temporal dependencies within each chunk. The appropriate chunk size is determined based on factors such as the desired temporal resolution, computational constraints, and the specific requirements of the downstream tasks.

In a step 3320, the audio and video chunks are processed through an autoregressive model. This step may utilize an autoregressive model, such as a recurrent neural network (RNN) or a transformer-based architecture, to process the audio and video chunks sequentially. The autoregressive model captures the temporal dependencies and patterns within each modality, allowing for effective modeling and generation of audio and video sequences. Autoregressive reconstruction losses are incorporated into the training process to encourage the model to accurately reconstruct the input sequences, ensuring high-quality output. Additionally, a plurality of masking layers are applied within the autoregressive model to selectively attend to relevant information and suppress irrelevant or redundant details. Masking techniques, such as attention masks or gating mechanisms, help the model focus on the most informative parts of the input and improve the efficiency of the processing.

In a step 3330, combine the audio and video chunks at various time stamps. This step synchronizes and aligns the processed audio and video chunks based on their corresponding time stamps. Robust synchronization algorithms are developed to handle potential misalignments or temporal inconsistencies between the audio and video modalities. Techniques such as cross-modal attention or alignment learning are employed to establish accurate correspondences between the audio and video chunks at different time stamps. Methods for handling variable-length audio and video sequences and ensuring smooth transitions between the combined chunks are also explored.

In a step 3340, the combined audio and video chunks are indexed through spatiotemporal indexing. This step organizes and indexes the chunks using a spatiotemporal indexing scheme. Unique identifiers are assigned to each chunk based on its spatial and temporal characteristics, such as the position within the original input sequence and the specific time stamp. An efficient indexing structure, such as a hierarchical or multidimensional index, is developed to facilitate fast retrieval and access to specific chunks based on their spatiotemporal properties. The indexing process is optimized to handle large-scale multimedia datasets and enable real-time querying and retrieval of relevant chunks for various applications, such as content-based retrieval, video summarization, or multimedia generation.

By following this method, the system can effectively process and integrate audio and video inputs, leveraging the power of autoregressive models and spatiotemporal indexing. The autoregressive model captures the temporal dependencies and patterns within each modality, while the masking layers help focus on the most informative aspects of the input. The combination of audio and video chunks at various time stamps ensures synchronization and alignment between the modalities. Finally, the spatiotemporal indexing enables efficient organization and retrieval of the processed chunks for various multimedia applications. This method provides a solid foundation for handling and analyzing multimodal data, enabling the development of advanced multimedia processing systems, such as content generation, retrieval, and manipulation. By leveraging the strengths of autoregressive modeling and spatiotemporal indexing, this approach offers a powerful and flexible framework for integrating audio and video modalities seamlessly.

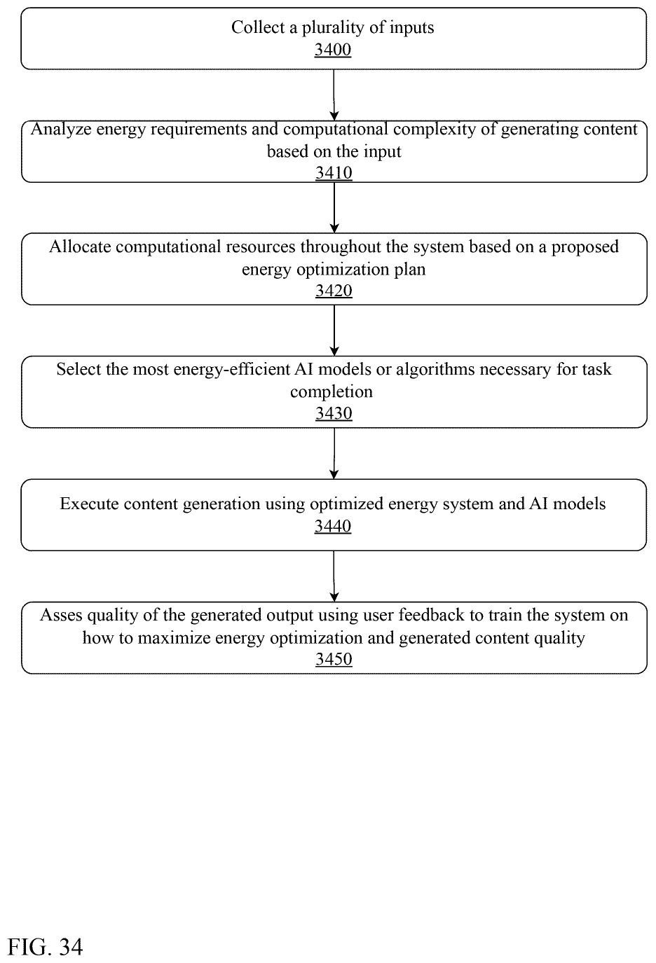

FIG. 34 is a flow diagram illustrating an exemplary method for optimizing the energy usage of an AI-powered large scale content generator. This method focuses on analyzing the energy requirements, allocating resources strategically, selecting energy-efficient AI models, and continuously refining the system based on user feedback to achieve a balance between energy optimization and generated content quality.

In a first step 3400, collect a plurality of inputs. These inputs can include various types of data, such as text, images, audio, or video, depending on the specific content generation task at hand. The collected inputs serve as the foundation for the subsequent energy optimization and content generation processes. In a step 3410, analyze the energy requirements and computational complexity of generating content based on the input. This analysis involves assessing the processing demands, memory usage, and potential energy consumption associated with different content generation techniques and algorithms. By understanding the energy implications of various approaches, the system can make informed decisions to optimize resource allocation and minimize energy consumption.

In a step 3420, based on the energy analysis, allocate computational resources throughout the system according to a proposed energy optimization plan. This step involves strategically distributing the available resources, such as CPUs, GPUs, memory, and storage, across different components of the content generation pipeline. The optimization plan takes into account factors such as the complexity of the task, the expected quality of the generated content, and the overall energy efficiency. By intelligently allocating resources, the system can ensure that the most critical tasks receive sufficient computational power while minimizing energy waste.

In a step 3430, selects the most energy-efficient AI models or algorithms necessary for task completion. This step involves evaluating and comparing different AI architectures, such as deep neural networks, transformers, or generative models, in terms of their energy consumption and performance. The selection process considers the trade-offs between model complexity, accuracy, and energy efficiency. By choosing the most energy-efficient models that still meet the desired quality criteria, the system can optimize the content generation process while reducing its environmental impact.

In a step 3440, execute the content generation task. This step involves applying the selected AI models and algorithms to the collected inputs, leveraging the allocated computational resources. The content generation process may involve techniques such as natural language processing, image synthesis, audio generation, or video rendering, depending on the specific application. The optimized energy system ensures that the content generation process is carried out efficiently, minimizing unnecessary computations and energy consumption.

In a step 3450, the generated output is assessed using user feedback. This step involves collecting user opinions, ratings, and comments on the quality and relevance of the generated content. The feedback is used to train the system and refine its energy optimization strategies and content generation models. By incorporating user preferences and expectations, the system can learn to generate high-quality content while further optimizing its energy consumption. This feedback loop enables the system to adapt and evolve over time, striking a balance between energy efficiency and user satisfaction.

By following this method, the content generation system can effectively optimize its energy consumption and computational efficiency. The energy analysis and resource allocation steps ensure that the system operates within energy constraints while maximizing performance. The selection of energy-efficient AI models and algorithms reduces the environmental impact of the content generation process. The execution of the optimized system generates high-quality content while minimizing energy waste. Finally, the incorporation of user feedback allows the system to continuously improve its energy optimization strategies and content generation capabilities.

This method provides a holistic approach to energy optimization in content generation systems, considering both the technical aspects of AI models and algorithms and the user-centric evaluation of generated content quality. By striking a balance between energy efficiency and user satisfaction, this method enables the development of sustainable and effective content generation solutions.

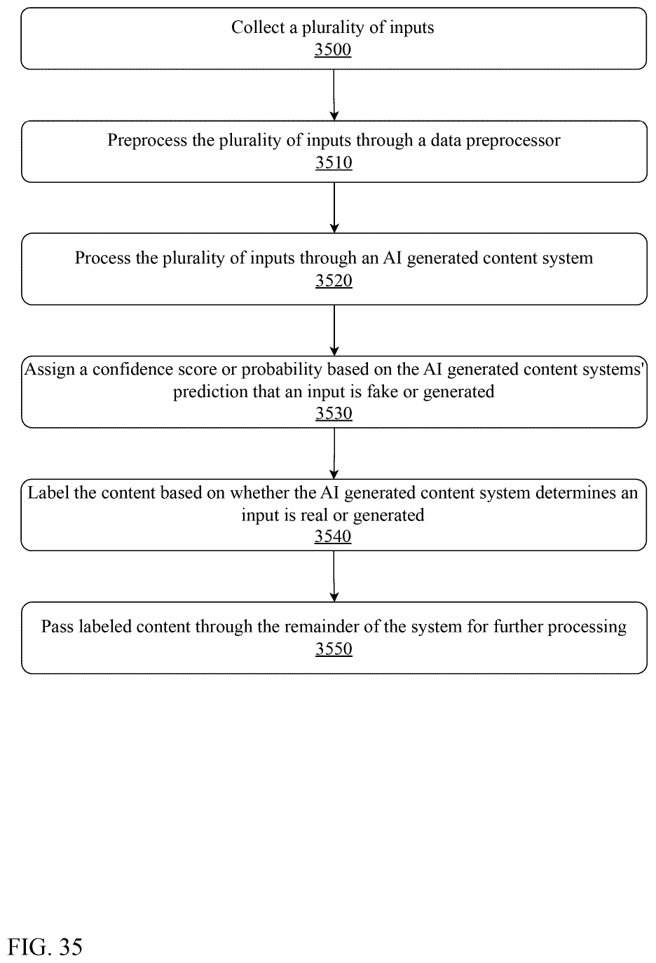

FIG. 35 is a flow diagram illustrating an exemplary method identifying generated or fake content using an AI-powered large scale content generator. This method focuses on preprocessing the inputs, utilizing an AI-generated content detection system, assigning confidence scores, and labeling the content accordingly before passing it through the remainder of the system for further processing. In a first step 3500, collect a plurality of inputs. These inputs can include various types of content, such as text, images, audio, or video, depending on the specific application domain. The collected inputs serve as the raw data that will be analyzed and processed by the AI-generated content detection system.

In a step 3510, preprocess the plurality of inputs through a data preprocessor. The data preprocessor is responsible for cleaning, normalizing, and transforming the raw inputs into a suitable format for the AI-generated content detection system. This preprocessing step may involve techniques such as data cleaning, noise reduction, feature extraction, or data augmentation, depending on the nature of the inputs and the requirements of the detection system. Preprocessing ensures that the inputs are standardized and optimized for accurate analysis and classification.

In a step 3520, the transformed inputs are processed through an AI-generated content detection system. This system employs advanced machine learning algorithms and models specifically trained to distinguish between real and AI-generated content. The detection system analyzes various features and patterns within the input data to determine the likelihood of it being generated by an AI model. The system may utilize techniques such as deep learning, statistical analysis, or anomaly detection to identify characteristics that are indicative of AI-generated content.

In a step 3530, based on the analysis performed by the AI-generated content detection system, a confidence score or probability is assigned to each input. The confidence score represents the system's level of certainty in its prediction of whether the input is real or AI-generated. Higher confidence scores indicate a stronger likelihood that the input is AI-generated, while lower scores suggest that the input is more likely to be real or authentic. The confidence scores provide a quantitative measure of the detection system's assessment and can be used to guide further decision-making processes.

In a step 3540, using the assigned confidence scores, the content is labeled accordingly. The labeling process involves categorizing each input as either real or AI-generated based on a predefined threshold or decision boundary. Inputs with confidence scores above the threshold are labeled as AI-generated, while those below the threshold are labeled as real. The specific threshold can be adjusted based on the desired balance between false positives and false negatives, considering the consequences of misclassification in the given application domain.

In a step 3550, once the content is labeled, it is passed through the remainder of the system for further processing. The labeled content carries the information about its predicted authenticity, which can be utilized by downstream components of the content processing pipeline. For example, the labeled content can be used to filter out AI-generated content, prioritize authentic content, or trigger additional verification steps. The specific actions taken based on the labels depend on the overall objectives and requirements of the system. By following this method, the content processing system can effectively detect and label AI-generated content, providing a valuable tool for content authenticity assessment and management. The preprocessing step ensures that the inputs are standardized and optimized for analysis, while the AI-generated content detection system leverages advanced algorithms to distinguish between real and generated content. The confidence scores and labeling process provide a quantitative measure of the system's assessment, enabling informed decision-making and content handling. Finally, the labeled content is seamlessly integrated into the broader content processing pipeline, allowing for appropriate actions and treatments based on its predicted authenticity.

This method offers a robust and systematic approach to identifying and managing AI-generated content within a content processing system. By accurately detecting and labeling such content, organizations can maintain the integrity and trustworthiness of their content while leveraging the benefits of AI-generated content where appropriate. The method provides a foundation for developing comprehensive content authenticity strategies and ensures that the content processing pipeline remains reliable and effective in the face of evolving AI technologies.

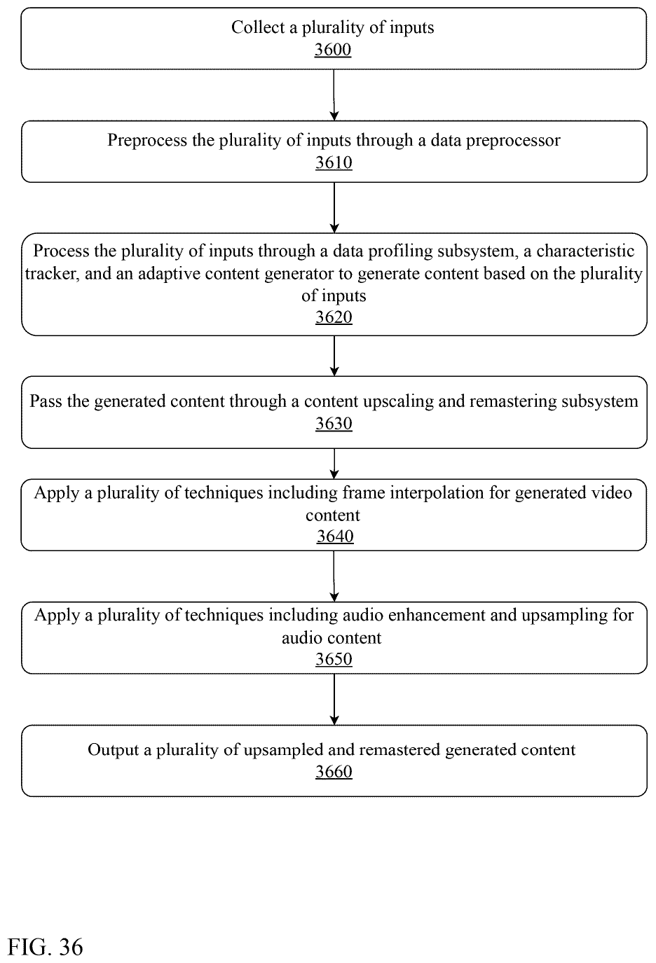

FIG. 36 is a flow diagram illustrating an exemplary method for remastering or upsampling generated content from an AI-powered large scale content generator. This method focuses on enhancing the visual and auditory aspects of the generated content to deliver a superior user experience. In a first step 3600, collect a plurality of inputs. These inputs can include various types of data, such as text, images, audio, or video, depending on the specific content generation task. The collected inputs serve as the foundation for the subsequent content generation and enhancement processes.

In a step 3610, preprocess the plurality of inputs through a data preprocessor. The data preprocessor is responsible for cleaning, normalizing, and transforming the raw inputs into a suitable format for the content generation system. This preprocessing step may involve techniques such as data cleansing, noise reduction, feature extraction, or data augmentation, depending on the nature of the inputs and the requirements of the generation system. Preprocessing ensures that the inputs are standardized and optimized for accurate and efficient content generation.

In a step 3620, the transformed inputs are processed through a data profiling subsystem, a characteristic tracker, and an adaptive content generator to generate content based on the plurality of inputs. The data profiling subsystem analyzes the input data to extract relevant features, patterns, and characteristics that can guide the content generation process. The characteristic tracker keeps a record of important elements and attributes that should be maintained consistently throughout the generated content. The adaptive content generator utilizes advanced AI and machine learning techniques, such as generative models, to create new content that aligns with the input data and the desired characteristics. This step produces an initial version of the generated content.

In a step 3630, generated content is passed through a content upscaling and remastering subsystem. This subsystem employs state-of-the-art techniques to improve the resolution, clarity, and overall fidelity of the generated content. The upscaling and remastering process aims to create content that looks and sounds as close to real-world, high-quality examples as possible.

In a step 3670, for generated video content, the content upscaling and remastering subsystem applies a plurality of techniques, including frame interpolation. Frame interpolation involves generating intermediate frames between the existing frames of the video to increase the frame rate and create smoother motion. This technique helps to reduce jitter, stuttering, or other artifacts that may be present in the generated video. By interpolating new frames, the subsystem can produce video content with improved temporal resolution and visual fluidity.

In a step 3650, for generated audio content, the content upscaling and remastering subsystem employs a plurality of techniques, including audio enhancement and upsampling. Audio enhancement techniques focus on improving the clarity, richness, and dynamic range of the generated audio. This may involve applying filters, equalizers, or other signal processing methods to remove noise, enhance specific frequencies, or optimize the overall audio quality. Audio upsampling, on the other hand, involves increasing the sample rate of the generated audio to achieve higher fidelity and a more immersive auditory experience. By applying these techniques, the subsystem can produce audio content that sounds crisp, clear, and true to life.

In a step 3660, the system outputs a plurality of upsampled and remastered generated content. This final output represents the enhanced version of the generated content, featuring improved visual and auditory quality. The upsampled and remastered content is ready for distribution, sharing, or further use in various applications, such as media production, gaming, or virtual reality experiences.

By following this method, the content generation system can produce high-quality, visually and auditorily appealing content that meets the expectations of modern users. The data preprocessing and profiling steps ensure that the input data is properly prepared and analyzed to guide the content generation process. The adaptive content generator leverages AI and machine learning techniques to create initial versions of the content, while the content upscaling and remastering subsystem applies advanced techniques to enhance the visual and auditory aspects of the generated content. The frame interpolation and audio enhancement techniques help to create smooth, fluid videos and rich, immersive audio experiences. Finally, the upsampled and remastered content is outputted, ready to be enjoyed by end-users.

### Exemplary Computing Environment

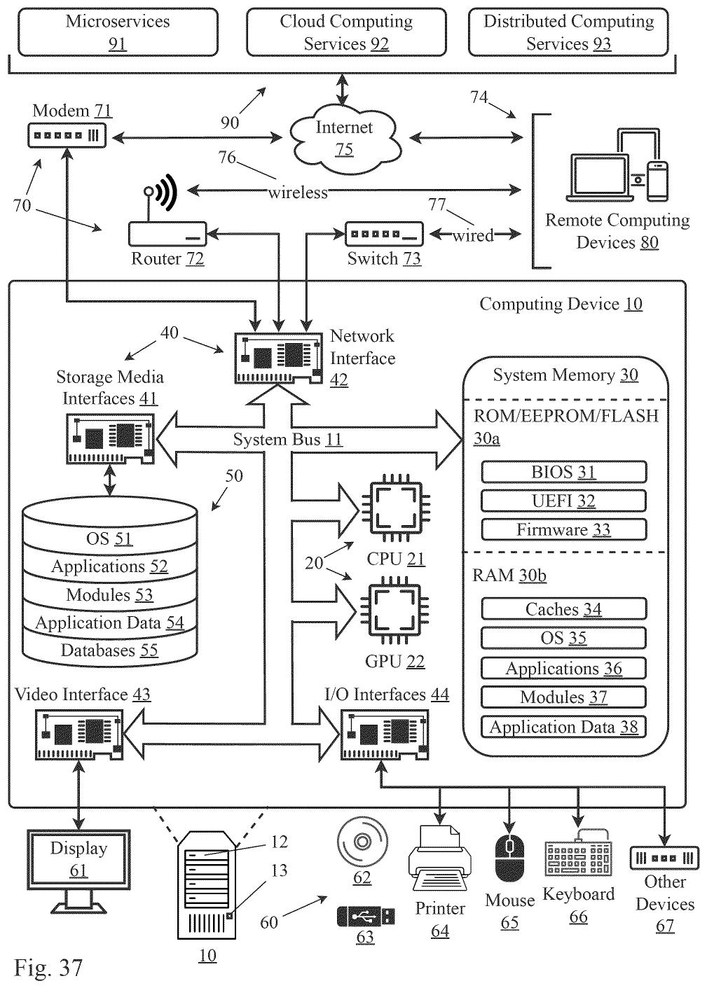

FIG. 37 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computing system for an artificial intelligence-powered large-scale content generator, the computing system comprising:
one or more hardware processors configured for:
receiving a user input from a user interface;
segmenting the user input into a plurality of elements, wherein the elements include plot, setting, descriptors, and characters;
flagging a plurality key elements from the plurality of elements which should remain constant unless the user input indicates otherwise;
processing the plurality of elements and the plurality of key elements through a plurality of generative AI subsystems where each generative AI subsystem is configured to process a certain type of element;
generating a cohesive experience from the plurality of generative AI subsystems where the experience is based on the user input;
displaying the experience to a user device; and
receiving user feedback to which is processed by the plurality of generative AI subsystems to create an updated experience.

2. The computing system of claim 1, wherein the plurality of generative AI subsystems are configured to process and generate text, images, videos, sounds, and environments.

3. The computing system of claim 1, wherein the outputs from the plurality of generative AI subsystems are checked to ensure that the plurality of key elements are consistent in both time and between each generative AI subsystem.

4. The computing system of claim 1, further comprising a generative AI training system which trains each generative AI subsystem on user feedback and a plurality of user inputs.

5. The computing system of claim 1, wherein the plurality of generative AI subsystem may be configured to generate a portion of an experience, such as chapters of a novel, single scenes in a movie, song segments.

6. A computer-implemented method executed on an artificial intelligence-powered large-scale content generator, the computer-implemented method comprising:
receiving a user input from a user interface;
segmenting the user input into a plurality of elements, wherein the elements include plot, setting, descriptors, and characters;
flagging a plurality key elements from the plurality of elements which should remain constant unless the user input indicates otherwise;
processing the plurality of elements and the plurality of key elements through a plurality of generative AI subsystems where each generative AI subsystem is configured to process a certain type of element;
generating an experience from the plurality of generative AI subsystems where the experience is based on the user input;
displaying the experience to a user device; and
receiving user feedback to which is processed by the plurality of generative AI subsystems to create an updated experience.

7. The computer-implemented method of claim 6, wherein the plurality of generative AI subsystems are configured to process and generate text, images, videos, sounds, and environments.

8. The computer-implemented method of claim 6, wherein the outputs from the plurality of generative AI subsystems are checked to ensure that the plurality of key elements are consistent in both time and between each generative AI subsystem.

9. The computer-implemented method of claim 6, further comprising a generative AI training system which trains each generative AI subsystem on user feedback and a plurality of user inputs.

10. The computer-implemented method of claim 6, wherein the plurality of generative AI subsystem may be configured to generate a portion of an experience, such as chapters of a novel, single scenes in a movie, of portions of a song.

11. A system for an artificial intelligence-powered large-scale content generator, comprising one or more computers with executable instruction that, when executed, cause the system to:
receive a user input from a user interface;
segment the user input into a plurality of elements, wherein the elements include plot, setting, descriptors, and characters;
flag a plurality key elements from the plurality of elements which should remain constant unless the user input indicates otherwise;
process the plurality of elements and the plurality of key elements through a plurality of generative AI subsystems where each generative AI subsystem is configured to process a certain type of element;
generate an experience from the plurality of generative AI subsystems where the experience is based on the user input;
display the experience to a user device; and
receive user feedback to which is processed by the plurality of generative AI subsystems to create an updated experience.

12. The system of claim 11, wherein the plurality of generative AI subsystems are configured to process and generate text, images, videos, sounds, and environments.

13. The system of claim 11, wherein the outputs from the plurality of generative AI subsystems are checked to ensure that the plurality of key elements are consistent in both time and between each generative AI subsystem.

14. The system of claim 11, further comprising a generative AI training system which trains each generative AI subsystem on user feedback and a plurality of user inputs.

15. The system of claim 11, wherein the plurality of generative AI subsystem may be configured to generate a portion of an experience, such as chapters of a novel, single scenes in a movie, of portions of a song.

16. Non-transitory, computer-readable storage media having computer executable instruction embodied thereon that, when executed by one or more processors of a computing system employing an artificial intelligence-powered large-scale content generator, cause the computing system to:
receive a user input from a user interface;
segment the user input into a plurality of elements, wherein the elements include plot, setting, descriptors, and characters;
flag a plurality key elements from the plurality of elements which should remain constant unless the user input indicates otherwise;
process the plurality of elements and the plurality of key elements through a plurality of generative AI subsystems where each generative AI subsystem is configured to process a certain type of element;
generate an experience from the plurality of generative AI subsystems where the experience is based on the user input;
display the experience to a user device; and
receive user feedback to which is processed by the plurality of generative AI subsystems to create an updated experience.

17. The media of claim 16, wherein the plurality of generative AI subsystems are configured to process and generate text, images, videos, sounds, and environments.

18. The media of claim 16, wherein the outputs from the plurality of generative AI subsystems are checked to ensure that the plurality of key elements are consistent in both time and between each generative AI subsystem.

19. The media of claim 16, further comprising a generative AI training system which trains each generative AI subsystem on user feedback and a plurality of user inputs.

20. The media of claim 16, wherein the plurality of generative AI subsystem may be configured to generate a portion of an experience, such as chapters of a novel, single scenes in a movie, of portions of a song.
